(19) United States
(12) Patent Application Publication
(10) Pub. No.: US 2023/0189315 A1
(43) Pub. Date: Jun. 15, 2023

(54) INTERFERENCE DETECTION AND HANDLING

(71) Applicant: Fraunhofer-Gesellschaft zur Förderung der angewandten Forschung e.V., München (DE)

(72) Inventors: Thomas HAUSTEIN, Berlin (DE); Jasmina MCMENAMY, Berlin (DE); Mathis SCHMIEDER, Berlin (DE); Paul Simon Holt LEATHER, Berlin-Schlachtensee (DE)

(21) Appl. No.: 18/164,022

(22) Filed: Feb. 3, 2023

Related U.S. Application Data
(63) Continuation of application No. PCT/EP2021/071807, filed on Aug. 4, 2021.

(30) Foreign Application Priority Data
Aug. 5, 2020 (EP) 20189688.3
Jan. 14, 2021 (EP) 21151672.9
May 7, 2021 (EP) 21172907.4

(51) Int. Cl. H04W 72/541; H04W 72/21; H04W 72/542

(52) U.S. Cl. CPC H04W 72/541; H04W 72/21; H04W 72/542

(57) ABSTRACT

A device for operating in a wireless communication system is configured for performing communication in the wireless communication system in accordance with a communications configuration obtained from a base station of the wireless communication system and scheduling communication of the device; using information indicating a set of reference signals [some or all] used in the wireless communication system; and for determining an amount of interference interfering with the communication in the wireless communication system for each of the set of reference signals by measuring to obtain a measurement result indicating the amount of interference perceived by the device through the reference signals of the set of reference signals; and generating a measurement report based on the measurement result and reporting the measurement report to the wireless communication system.

### CROSS-REFERENCE TO RELATED APPLICATIONS

This application is a continuation of copending International Application No. PCT/EP2021/071807, filed Aug. 4, 2021, which is incorporated herein by reference in its entirety, and additionally claims priority from European Applications Nos. 20189688.3, filed Aug. 5, 2020, EP 21151672.9, filed Jan. 14, 2021 and EP 21172907.4, filed May 7, 2021, which are all incorporated herein by reference in their entirety.

The present invention relates to devices and methods for handling interference. The present invention in particular relates to handling inter-cell interference and cross-link interference.

### BACKGROUND OF THE INVENTION

Interference Handling Between a Victim and an Aggressor

In the present disclosure reference is sometimes made to a victim which means a device operating in a wireless communication network or system which is interfered, i.e., an interfered device. Further, the disclosure sometimes makes reference to an aggressor or interferer, which is an interferer of the victim, i.e., an interfering device.

In the following, a short description of certain cellular radio principles is given.

Given that a fixed amount of radio spectrum is available for the prevision of a certain service—for example, enhanced mobile broadband and personal communication services—the system designer has to balance the apparently conflicting requirements of area coverage and system capacity. Cellular schemes, which not only address these constraints but have also become widespread and highly-developed commercial successes, have used the principle of frequency-reuse. In a cellular network, each cell has its own relatively low-power basestation transmitter and is assigned a radio channel such that some distance away from that cell, the same radio channel can be re-assigned to another cell. On the other hand, adjacent cells, which are not separated in distance, are assigned different radio channels. While the advantage of frequency-reuse should now be clear, there is however a disadvantage. Since the total available spectrum is divided into smaller radio channels that are reused, the bandwidth available within any single cell is reduced and so too is its capacity and throughput.

Frequency Re-Use Schemes

The design and development of a cellular radio communication network is largely dependent on whether its performance is either more limited by noise (typically due to thermal effects in both active and passive electronic components) or is more limited by the interference created by other devices operating in the network.

Frequency reuse schemes have been proposed to improve spectral efficiency and signal quality. The different schemes provide different trade-offs between resource utilization and quality of service (QoS). The classical reuse-3 (N=3) scheme proposed for GSM systems offers a protection against intercell interference. However, only a third of the spectral resources are used within each cell. In the reuse-1 scheme in which all the resources are used in every cell (N=1), interference at the cell edge may be critical [2]. The situation is better for N>1 used in 2G networks (such as GSM or AMPS) because the co-channel interferers are physically located farther apart from each other due to the frequency reuse distance. For networks where N=1 and, since every cell is an interferer, the situation is worst. “Pilot pollution” (or “no dominant server”) describes a situation where, at a given location, there is insignificant difference in the power received from many different cells. As a result, the composite signal level is high, but the SINR from any single cell is poor because the total interference is high. The result is poor RF performance even with a high overall signal level [2].

Identifying in which regime a network operates is central to the design of the system, the medium access control (MAC) and the physical-layer procedures. For example, while interference limited networks can benefit from advanced techniques such as inter-cellular interference coordination, coordinated beamforming and dynamic orthogonalization, these techniques have little value in networks where thermal noise, rather than interference, is dominant [1].

Cell-Edge Performance

Vehicles moving at high speed may be subject to much worse cell-edge SINR due to a “handover dragging effect.” Essentially, this is caused by the fact that a fast-moving UE (user equipment) cannot be served by the best server, because handover is not triggered until the UE has moved across the cell border, and there is a time lapse while handover completes [2]. Similar effects can be experienced in satellite-based systems such as those considered in non-terrestrial networks (NTN) which is currently an on-going study item within 3GPP 5G standardization.

A common problem near the cell edge is that the SINR from the best server is already very poor, and the SINR values from the second- and third-best servers are even worse. 3GPP simulations typically only show the SINR distribution from the best server. However, in real-life situations, the UE also has to work with the second- or -third-best server, so the real-life situation is less favourable [2].

A spread-spectrum system (e.g., CDMA or UMTS) can work under largely negative SINR values because of the large processing gain, especially for low data rates; soft handoffs are also useful. However, the LTE interface cannot operate under the same negative SINR conditions, and does not support soft handoff. These cell-edge challenges are combatted by Inter-Cell Interference Coordination (ICIC). Essentially, ICIC reduces the co-channel interference cell-edge users experience from direct neighbour cells by increasing the cell-edge SINR values [2].

In OFDMA-based systems such as LTE and NR, a resource element (RE) is the smallest unit made up of 1-symbol×1-subcarrier. A resource element group (REG) is a group of four (4) consecutive resource elements (resource elements for the reference signal is not included in REG). The control channel element (CCE) is a group of nine (9) consecutive REGs. The aggregation level describes a group of ‘L’ CCEs where L can be 1, 2, 4 or 8.

A scheduler is a functional entity of a cellular network which can be used to implement CCE-based power boosting in the power domain. The CCE aggregation level can be 1, 2, 4 or 8 (CCE-1, CCE-2, CCE-4 or CCE-8) and the higher the aggregation level, the more robust it will be. However, high aggregation levels also use more PDCCH resources. Therefore, cell-centre users will use CCE-1 or CCE-2; users located somewhere in the middle of the cell will use CCE-2 or CCE-4; cell-edge users will use CCE-8. CCE-based power boost can boost up the transmit power level on CCE-8, which can potentially increase the signal level on CCEs for cell-edge users [2].

CCE-Based Power Boost in Cellular Scenarios

Broadly speaking, cells can be categorized in one of the following three scenarios.

In a coverage-limited environment, the cells are spaced very far apart from each other. Examples are rural and highway cells. Typically, the signal levels near the cell edges are already very low and as a result, the out-of-cell interference levels are also very low. For coverage-limited environments, the following approximation can be made:

$$SINR = \frac{S}{n + I} \approx \frac{S}{n} = SNR$$

In this case, boosting the signal power enhances “S,” and thus improves SNR since thermal noise is constant. CCE-based power boost is effective in a coverage-limited environment.

In an interference-limited environment, the cells are tightly packed. Examples include dense suburban, urban or dense urban with small cells. Typically, the cell-edge composite signal level is very high, but the out-of-cell interference level is also very high. As a result, the cell-edge SINR is still poor. For interference-limited environment, one can approximate the situation using:

$$SINR = \frac{S}{n + I} \approx \frac{S}{I} = SIR$$

In this case, CCE-based power boost will not be effective, because when signal power is boosted up, the out-of-cell interference level is also increased, and as a result the SIR is not improved. Generally, when cell-edge power level is already very high, boosting the power further will not help.

This phenomenon is the so-called “cocktail party effect:” in a cocktail party with high noise level in the background, it does not improve audibility if everyone increases their voice level; it just creates a higher level of background noise. Unfortunately, an interference-limited environment is the area where help is most needed. Call drops happen most frequently in small cells, especially calls placed from fast-moving vehicles.

In environments somewhere between interference-limited and coverage-limited, the cells are neither very close nor very far from each other. Examples are typically light suburban cells. As long as both “I” and “n” terms are not negligible in the SINR equation, boosting the signal level will help somewhat, but this is not as effective as the situation for coverage-limited environments. The degree of effectiveness depends on the magnitude of “I” versus the magnitude of “n”; the higher the ratio of I/n, the less effective it will be, and vice versa. In general, I>n, and so the main issue here is that the gain achieved from CCE-based power boost may not be sufficient to handle the worst-case scenario [2].

Reference Signals in LTE and NR

In LTE, cell reference signals (CRS) were designed to be continuously broadcast and distributed in both the time and frequency domains across the whole carrier bandwidth. This was done to help the UE lock its time/frequency raster and to ease the decoding of downlink (DL) data. However, this involves a large number of resource elements (RE) to be transmitting CRS even when there are no users in the cell, thus wasting DL power and causing interference to neighbouring cells [3].

A later LTE development was the introduction of demodulation reference signals (DM-RS) which were used instead of CRS for the decoding of data. To limit CRS broadcasts, features such as lean carrier and pilot breathing were proposed. 5G NR is designed to have an ultra-lean physical layer, replacing continuous reference signals with on-demand ones:

Channel State Information Reference Signal (CSI-RS): Reference signal with main functionalities of CSI acquisition, beam management. CSI-RS resources for a UE is configured by RRC information elements, and can be dynamically activated/deactivated via MAC CE or DCI [3].

Demodulation Reference Signal (DMRS): Reference signals which are UE specific and could be beam formed, will be used for data and control demodulation. They are transmitted only on the PRBs upon which the corresponding PDSCH is mapped [3].

Phase Tracking Reference Signal (PTRS): A new type of reference signals is introduced, called Tracking Reference Signals, and it is used for: Time and Frequency tracking at UE side; and Estimation of delay spread and Doppler spread at UE side. It is transmitted in a confined bandwidth for a configurable period of time, controlled by upper layers parameters [3].

Millimetre-Wave Spectrum and Frequency Range Two

The millimetre-wave (mmWave) spectrum, roughly defined as the frequencies between 10 and 300 GHz, is a new and promising frontier for cellular wireless communications. The mmWave bands offer vast and largely untapped spectrum and, by some estimates, offer up to 200 times the bandwidth of all current cellular operating frequency bands. This enormous potential has identified mmWave networks as being one of the most promising technologies for 5G and Beyond 5G cellular evolution. In connection with 3GPP standardization of new radio (NR), two frequency ranges have been defined: FR1 from 410 MHz to 7,125 MHz and FR2 from 24.25 GHz to 52.6 GHz. In addition to these current definitions, 3GPP is studying additional mmWave frequency ranges: new definitions are likely. The content of the current invention disclosure is applicable to all mmWave frequencies.

Massive MIMO (mMIMO) with beamforming will be used to achieve higher network capacity and higher data throughputs in these new frequency bands. Using these technologies, however, changes the radio access from cell coverage to beam coverage, representing a significant change from 4G Radio Access Networks (RANs) [4].

NR Radio Resource Management Measurements and FR2

Radio resource management (RRM) in NR is based on measurements of the synchronization signal block (SSB) or the CSI-RS, and can be reported with metrics such as reference signal received power (RSRP) and reference signal received quality (RSRQ). Radio link monitoring (RLM) measurement requirements for NR include both SSB based measurements and CSI-RS based measurements [5].

For SSB based measurements, the UE will conduct intra-frequency and/or inter frequency RSRP, RSRQ and RS-SINR measurements, with or without gaps. For CSI-RS based beam measurements, the UE will report the physical layer RSRP. CSI-RS based RSRP, RSRQ and RS-SINR shall also be supported [5].

From a measurement perspective, an FR2 UE can utilize an analogue and/or digital beamforming receiver. Longer measurement times are needed in order for an FR2 UE to sweep spherically [5].

In 3GPP Rel-15, layer 1 (L1) RSRP was introduced as the metric for beam-related measurements as it reflects the absolute received power on the configured reference signal(s). However, when multi-beam transmission and reception techniques are used in practice, beam selection based on L1-RSRP alone may be insufficient [5]. It reported that multiple, spatially-adjacent beams, exhibiting the strong and similar RSRPs, may cause strong mutual interference. Such interference information should be properly evaluated as the input for beam selection [6].

To enable convenient beam-level multi-user paring, mechanisms to evaluate and report inter-beam interference have drawn recent attentions. However, the UE Rx beam information is transparent in Rel-15 beam reporting mechanism where the gNB is not aware of the association between the Tx beam and the corresponding UE Rx beam. A Rel-16 work item description thus includes the definition of L1-RSRQ and L1-SINR for beam measurement and reporting in its scope [6].

Starting from this conventional technology, there is a need to provide a robust communication in wireless communication systems.

### SUMMARY

According to an embodiment, a wireless communication system may have: a base station adapted for scheduling, using a communication configuration, communication of a plurality of devices, the plurality of devices including a reporting device; wherein the reporting device is configured for performing communication in the wireless communication system in accordance with the communications configuration; wherein the reporting device is configured for using information indicating a set of reference signals used in the wireless communication system; and for determining an amount of interference interfering with the communication in the wireless communication system for each of the set of reference signals by measuring, e.g., RSRP, RSSI or any other adopted signal metric, to obtain a measurement result indicating the amount of interference perceived by the reporting device through the reference signals of the set of reference signals; wherein the reporting device is configured for reporting, to the wireless communication system a measurement report being based on the measurement result; and wherein the wireless communication system is configured for using the measurement report and information about other devices communicating in the wireless communication system and information about reference signals used by the other devices for adapting the communications configuration of at least one device of the plurality of devices for mitigating interference.

Another embodiment may have a device for operating in a wireless communication system, the device configured for: performing communication in the wireless communication system in accordance with a communications configuration obtained from a base station of the wireless communication system and scheduling communication of the device; using information indicating a set of reference signals used in the wireless communication system; and for determining an amount of interference interfering with the communication in the wireless communication system for each of the set of reference signals by measuring to obtain a measurement result indicating the amount of interference perceived by the device through the reference signals of the set of reference signals; and generating a measurement report based on the measurement result and reporting the measurement report to the wireless communication system.

Another embodiment may have a base station configured for operating in a wireless communication system, the base station adapted for scheduling, using a communications configuration, communication of a plurality of devices, the plurality of devices including a reporting device; wherein the base station is configured for receiving a report generated by the reporting device, the measurement report indicating an amount of interference perceived by the reporting device through a reference signal of a set of reference signals used in the wireless communication system; and wherein the base station is configured for using the measurement report and information about other devices communicating in the wireless communication system and information about reference signals used by the other devices for adapting the communications configuration of at least one device of the plurality of devices for mitigating interference.

According to another embodiment, a method for operating a wireless communication system may have the steps of: operating a base station for scheduling, using a communications configuration, communication of a plurality of devices, the plurality of devices including a reporting device; operating the reporting device for performing communication in the wireless communication system in accordance with the communications configuration; such that the reporting device uses information indicating a set of reference signals used in the wireless communication system; and determines an amount of interference interfering with the communication in the wireless communication system for each of the set of reference signals by measuring to obtain a measurement result indicating the amount of interference perceived by the reporting device through the reference signals of the set of reference signals; such that the reporting device reports, to the wireless communication system a measurement report being based on the measurement result; and such that the wireless communication system uses the measurement report and information about other devices communicating in the wireless communication system and information about reference signals used by the other devices for adapting the communications configuration of at least one device of the plurality of devices for mitigating interference.

According to another embodiment, a method for operating a device in a wireless communication system may have the steps of: performing communication in the wireless communication system in accordance with a communications configuration obtained from a base station of the wireless communication system and scheduling communication of the device; using information indicating a set of reference signals used in the wireless communication system; and determining an amount of interference interfering with the communication in the wireless communication system for each of the set of reference signals by measuring to obtain a measurement result indicating the amount of interference perceived by the device through the reference signals of the set of reference signals; and generating a measurement report based on the measurement result and reporting the measurement report to the wireless communication system.

According to another embodiment, a method for operating a base station in a wireless communication system, the base station adapted for scheduling, using a communications configuration, communication of a plurality of devices, the plurality of devices including a reporting device, may have the steps of: receiving a report generated by the reporting device, the measurement report indicating an amount of interference perceived by the reporting device through a reference signal of a set of reference signals used in the wireless communication system; and using the measurement report and information about other devices communicating in the wireless communication system and information about reference signals used by the other devices for adapting the communications configuration of at least one device of the plurality of devices for mitigating interference.

The inventors have found that for effectively handling interference, knowledge about a source of interference is beneficial as it allows to mitigate interference, especially in integrated access and backhaul, IAB, networks. The inventors have found that by specifically addressing interference caused by communicating between devices at a location of other devices not involved in the communication, the communication of those other devices may remain undisturbed or may be disturbed at a low level, thereby avoiding degradation and losses in quality of communication, throughput etc. at those other devices. The inventors have found that such considerations are particularly effective at devices that are capable of performing beamforming techniques by controlling sidelobes of an antenna radiation pattern.

Embodiments of the present invention are defined in the independent claims. Advantageous modifications of the embodiments are defined in the dependent claims.

Embodiments relate to methods for operating devices described herein, methods for operating a network and to a computer program product.

Some aspects herein relate to determine, details about an occurring or possible interference in the network using e.g., by measurements. Aspects of the present invention may implement or incorporate aspects that are based on a transmitter avoiding causing interference to another entity and/or on adapting filters used for reception by use of a spatial receive filter so as to point a low sensitivity towards an interferer, which is also referred to herein as aggressor.

According to an embodiment of this aspect, a device configured for operating in a wireless communication network is configured for forming an antenna radiation pattern for communicating with a communication partner. The antenna radiation pattern comprises a main lobe and sidelobes. The device is configured for controlling the main lobe towards a path to the communication partner and to control the sidelobes to address interference at the location of a further device. This allows to maintain the communication with the communication partner whilst addressing the interference at the further device so as to avoid a disturbance at its location.

According to an embodiment, a device configured for operating in a wireless communication network is configured for forming an antenna radiation pattern for communicating with a communication partner. This device may be interfered or disturbed by another device and may be configured for determining a measure of interference associated with this further device not communicating with the device. The device may be configured for reporting, to the further device or a member of a communication network in which the further device operates about the reception of power and/or interference from the further device. This allows to provide for a source of information at the interfering device to enable the interfering device to reduce the interference caused by it at the location of the interfered device.

According to an embodiment, a wireless communication network comprises at least one interfering device being configured to address interference by controlling sidelobes of its antenna radiation pattern and comprising at least one interfered device being configured to report about a received interference. Such a network may be formed as a classical communication network, in which the interfering device and the interfered device are commonly served, e.g., in a common cell of a wireless communication network being operating by an operator or in difference cells of this network. However, the described embodiment is not limited hereto but also refers to a wireless communication network that is formed by individual networks or parts thereof, e.g., cells operated by different operators or networks operating according to different standards.

In view of another aspect, there is a need for a high reliability of wireless communication. Such aspects are related to collecting, for a wireless communication network, data, information and/or measurement data that allows to retrieve, e.g., for the past, determine, e.g., for the present, and/or to predict, e.g., for the future a condition in the network, a part thereof being interference occurring.

It is, thus, also an object of these aspects of the present invention to provide for a reliable communication.

A first recognition of this aspect of the present invention is that in a scenario allowing for bidirectional communication, the device measures a radio link parameter, and that by generating a measurement report from the obtained results, and by transmitting the measurement report to an entity of the wireless communication network, the wireless communication network may be provided with a detailed knowledge about the influences occurring on the wireless communication, thereby allowing it to determine root causes that degrade communication. Thereby, a high reliability of the wireless communication may be obtained.

According to an embodiment of this aspect of the first recognition, a device configured for operating in a bidirectional wireless communication network in a first operating mode in which the device is in a connected mode during a first time interval and in a second operating mode, in which the device at most performs passive communication during a second, different time interval, is implemented such that, in the first operating mode, the device is configured for obtaining a set of measurement results comprising at least one measurement result by measuring or determining a radio link parameter of the wireless communication network. The device is configured for generating a measurement report comprising a set of results having at least one measurement result of the set of measurement results and for transmitting the measurement report to an entity of the wireless communication network. This allows to obtain measurement results that are obtained while the device is in the connected mode and, thus, possibly during a communication/transmission performed with the device.

A second recognition of this aspect of the present invention is that a log or a stored number of measurement results is helpful for evaluating the wireless communication network for a link that is operated by the device itself and/or by generating the measurement report so as to comprise information about at least one instance of a measurement result being obtained prior to a link degrading event causing degrading of the wireless link, wherein the measurement report is transmitting after the link degrading event. That is, the radio link parameter is related to an own link of the device and/or refers to a time prior to a link degrading event or has been permitted thereafter. A link degrading event may be any event that causes a degrading of a link quality and/or even a link failure. This event may be related to the radio link itself, e.g., a device moving out of coverage or being temporarily blocked, or running out of battery or the like but may also have external effects, e.g., a storm that dislocates and/or destroys antennas, newly built buildings or the like.

According to an embodiment, in accordance with the second recognition, a device configured for operating in a bidirectional wireless communication network in at least a first operating mode in which the device is in a connected mode is configured, in the first operating mode, for transmitting and/or receiving wireless signals and for obtaining a plurality of measurement results, obtaining a measurement result comprising measuring or determining a radio link parameter associated with an operation of the wireless communication network. The device is configured for generating a log so as to comprise information derived from the plurality of measurement results and time information associated with the plurality of measurement results. The device is configured for generating a measurement report from the log and for transmitting the measurement report to at least one entity of the wireless communication network. The radio link parameter is associated with a link operated by the device and/or the device is configured for generating the measurement report so as to comprise information about at least one instance of the measurement result being obtained prior to a link degrading event causing degrading of the wireless link and for transmitting the measurement report to the entity of the wireless communication network after the link degrading event. This allows the device to monitor its own link and/or to report measurement results that may allow or support the network to determine information about the link degrading event retrospectively, thereby providing for information that may be used for a learning process for future events.

Further embodiments of this aspect relate to a device that configures, instructs or requests devices for performing measurements which allows to generate and obtain the measurement results on demand.

### BRIEF DESCRIPTION OF THE DRAWINGS

Embodiments of the present invention will be detailed subsequently referring to the appended drawings, in which:

FIG. 1 shows an example of an idealized antenna radiation pattern plotted using perpendicular axes having an azimuth angle in degrees at the abscissa and a directivity at the ordinate;

FIG. 2 shows a schematic diagram of the antenna radiation pattern of FIG. 1 being plotted using a polar coordinate system;

FIG. 3a shows a schematic top view of at least a part of a network according to an embodiment in which an interfering device according to an embodiment is operating;

FIG. 3b shows a schematic block diagram of the part of the wireless communication network according to FIG. 3a in which the interfering device has adapted its antenna radiation pattern in view of a transmission power of sidelobes;

FIG. 3c shows a schematic block diagram of the part of the network according to FIG. 3a in which the interfering device controls a direction of the sidelobes so as to point along a different direction;

FIG. 3d shows a schematic block diagram of the scenario of FIG. 3a in which the interfering device controls the power/sensitivity and the direction of sidelobes;

FIG. 4a shows a schematic block diagram of an interfered device according to an embodiment;

FIG. 4b shows a schematic block diagram of an interaction between the interfered device and an interfering interferer;

FIG. 5 shows a schematic block diagram of an apparatus according to an embodiment of the first recognition of the present invention;

FIG. 6 shows a schematic block diagram of a device being in accordance with the second recognition of the present invention;

FIG. 7 shows a schematic block diagram of a device configured for operating in a wireless communication network to instruct other device for measurements;

FIG. 8 shows a schematic block diagram of a wireless communication network according to an embodiment;

FIG. 9 shows a schematic block diagram of a wireless communication network in accordance with an embodiment, having at least three devices;

FIG. 10 shows a schematic block diagram of a wireless communication network in which a device operating as gNB maintains links with two different devices both being adapted as UE;

FIG. 11 shows a schematic block diagram of a wireless communication network according to an embodiment having at least four devices maintaining wireless or radio links;

FIG. 12 shows a schematic block diagram of a wireless communication network according to an embodiment comprising a number of at least two, at least three or at least four UEs;

FIG. 13 shows a schematic block diagram of a wireless communication network according to an embodiment in which a basestation and a UE are both operated as measurement and logging/reporting device;

FIG. 14 shows a schematic flow chart of a method for operating a device according to the first recognition;

FIG. 15 shows a schematic flow chart of a method for operating a device according to the second recognition;

FIG. 16 shows a schematic flow chart of a method for operating a device in a wireless communication network, for example, device of FIG. C;

FIG. 17 shows a schematic illustration of a known network;

FIG. 18a/b show schematic representations of a wireless communication system in accordance with embodiments to illustrate the cases of inter cell interference;

FIG. 19 shows a schematic representation of the wireless communication system of FIG. 18 in which Cross-link interference occurs;

FIG. 20 shows a schematic block diagram of an occurrence of CLI in an asynchronous network according to an embodiment;

FIG. 21 shows a schematic block diagram of an IAB network according to an embodiment;

FIG. 22 shows a schematic block diagram of an extension of the IAB network of FIG. 21 according to an embodiment;

FIG. 23 shows a schematic representation of different cases of interference in an IAB network handled by embodiments;

FIG. 24a-d show schematic block diagrams of arrangements of devices communicating wirelessly to illustrate the so-called hidden terminal problem in accordance with embodiments;

FIG. 25 shows a schematic block diagram of an arrangements of devices communicating wirelessly to illustrate the so-called exposed terminal problem in accordance with embodiments;

FIG. 26 shows a schematic flow chart of a method according to an embodiment and provides a high-level overview of the enhanced procedure for CLI interference management;

FIG. 27a shows a schematic flow chart of a method according to an embodiment and depicts a more detailed two-step CLI-mitigation approach;

FIG. 27b shows a schematic table indicating possible intervals for reporting detected interference in accordance with embodiments;

FIG. 27c shows schematic representations of different possible configurations 2702₁ to 2702_{N} of an example TDD slot;

FIG. 28 shows a schematic block diagram of a wireless communication system according to an embodiment to implement solutions described herein;

FIG. 29a-b show schematic representation in connection with embodiments related to self-interference; and

FIG. 30a/b show schematic plots in connection with embodiments related to self-interference.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Embodiments described herein relate to antenna radiation patterns or beam patterns that are formed by a device. Such antenna radiation patterns may be transmission radiation patterns and/or reception radiation patterns, i.e., spatial patterns or directions for transmission and/or reception of a signal. Such an antenna radiation pattern may comprise a main lobe (optionally additional main lobes) and one or more sidelobes. Between two adjacent lobes, there may be arranged a so-called null. As described in connection with the millimetre-wave spectrum, the use of millimetre-wave frequencies creates a paradigm change for cellular radio networks as the principle of coverage may move away from that of cell coverage to that of beam coverage instead. Although 3G PP NR defines beam management procedures and beam correspondence requirements [7], embodiments relate to the beam part of the antenna radiation pattern.

Some embodiments described herein relate to slots. However, slots are an illustrative example of a radio resource which comprise, alternatively or in addition, same resource blocks and/or subcarriers and slots/symbol. That is, as a resource, embodiments may incorporate one or more of at least one frequency bandwidth part (BWP), at least one resource block, at least one subcarrier and/or at least one time-domain slots/symbols. Embodiments described herein in connection with a time slot are, thus, not limited to a time slot but may refer, without limitation, to other types of radio resources.

Antenna Directivity

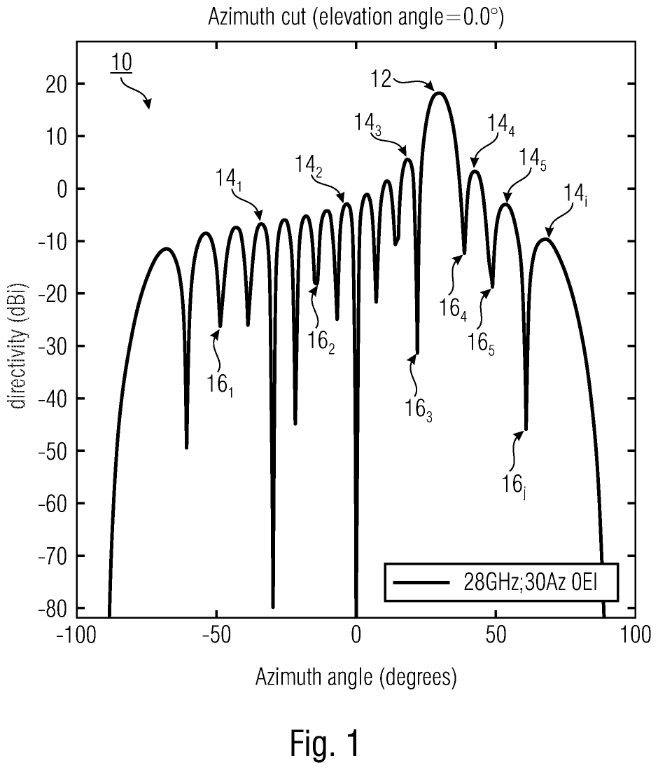

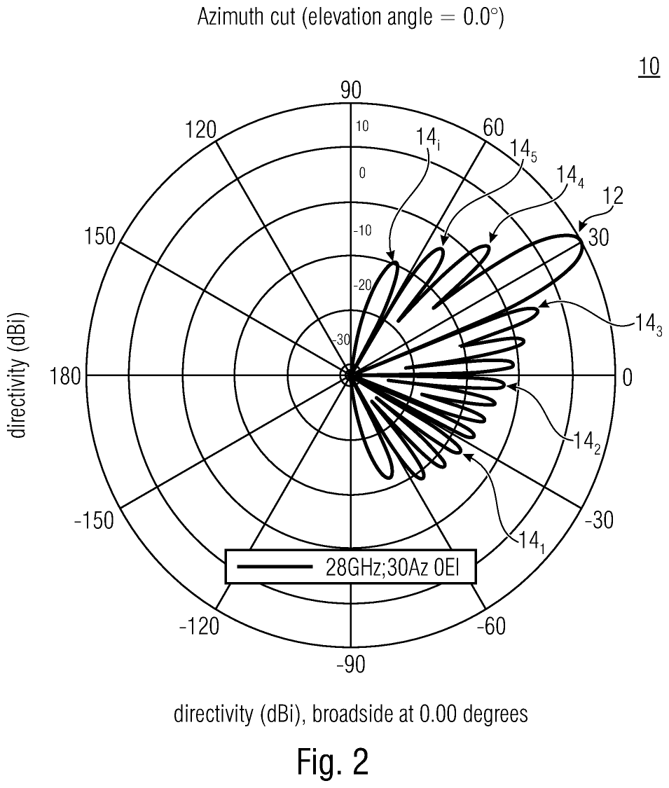

An antenna's directivity is a measure of its ability to concentrate or direct electromagnetic energy in an advantageous or given direction compared to the amount of energy it emits in all other directions. Due to reciprocity, antenna directivity is identical for both transmission and reception. In general, all practical antennas have a directivity greater than unity. Although the directivity of an individual antenna can be influenced through careful design, in order to achieve higher directivity and to control the direction in which the maximum energy is directed, a multitude of antenna elements are often arranged in such a manner that they form an antenna array. Now while the mechanical position of the elements is usually fixed, their electrical excitation can be so arranged to change the characteristics of the radiation pattern of the antenna array. Using such methods, it is possible, amongst other things, to control: the electrical scan angle (the direction in which the main lobe or “beam” is pointed); the overall level of the sidelobes with respect to the main lobe; the level and position of sidelobes; and the depth and position of nulls (which fall in between the main lobe and sidelobe and in between sidelobes). Examples of the two-dimensional antenna radiation produced by an idealized phased array antenna are shown in FIG. 1 and FIG. 2 using rectangular and polar axes respectively.

That is, FIG. 1 shows an example of an idealized antenna radiation pattern 10 plotted using rectangular or perpendicular axes as in a Cartesian coordinate system having an azimuth angle in degrees at the abscissa and a directivity at the ordinate. A main lobe 12 that may also be referred to as (main) beam is illustrated at 30 degrees in azimuth. The antenna radiation pattern may comprise one or more sidelobes 14₁ to 14ᵢ, wherein between two adjacent lobes nulls 16₁ to 16ⱼ may be arranged. A null may be understood as a direction in which less power is transferred (received or transmitted) when compared to adjacent lobes. A reduction of power transfer may be, for example, at least 6 dB, at least 10 dB or the like. A phase distribution may be used to steer the beam or main lobe 12 in the needed direction, e.g., using a uniform power distribution. A sidelobe level may be irregular.

FIG. 2 shows a schematic diagram of the antenna radiation pattern 10 being plotted using a polar coordinate system.

Forming an antenna radiation pattern in connection with the embodiments described herein may relate to a static antenna radiation pattern but may also relate to a dynamic, i.e., sweeping antenna radiation pattern. A sweeping beam pattern or antenna radiation pattern may be understood as a constant or varying pattern that is moved in space or in frequency, for example, rotated or laterally shifted. Such a sweeping may allow to adjust a direction of lobes and/or nulls of the antenna radiation pattern.

Directions that are described in connection with present embodiments do not limit the scope of the embodiments to the narrow meaning of a direction, i.e., a single factor. The term direction is to be understood so as to also include a set of dominant angular components which contribute significantly to the received or transmitted signal at the place/location, area/zone or volume of a communication partner. This may be equivalent to a complex 3D receive antenna radiation pattern which collects and weighs different incoming multi-path components to an effective receive antenna input signal. Therefore, direction is not limited to one line but may cover an aggregation of signals from directions collected by their received pattern. A transmit strategy may select a transmit beam pattern which provides good signal power transfer from the transmitter to the targeted received/communication partner.

Devices described herein that may perform beamforming may comprise an antenna arrangement, the antenna arrangement having one or more antenna panels, wherein each antenna panel may comprise one or more antennas. That is, each antenna panel comprises an arrangement of one or more radiating/receiving antennas such that a panel or a subpanel thereof is able to perform a coherent beamforming. That is, for performing a beamforming, a number of antennas grouped to antenna panels, a number of antenna panels and thus a number of antennas in total may be arbitrary.

Pattern Control

In the context of the preceding discussion, and in order to form the best link between devices (for example a basestation and a piece of user equipment), beam management may be used to ensure that the beams of each device are pointing appropriately. However, known beam management does not consider the effect of interference to other users. In other words, and by way of an example, when a basestation antenna beam is pointed in a given direction—that is, to a device with which it should establish or maintain a connection—the associated sidelobes and nulls of the pattern will follow the beam, arbitrarily. Although the power levels of the sidelobes will normally be lower than the power level of the beam, they could still emit sufficient power towards another device with which the basestation is not connected such that the device experiences interference. In some cases, the power level of the interferer could even exceed the power level of the serving beam.

In other applications of phased array antenna systems pattern nulls are created in such a way that the effects of so-called jammers (sources of strong electromagnetic radiation that are deliberately aimed towards a victim's radar or communication system) can be reduced spatially through adaption of the (victim's) antenna pattern.

Embodiments are thus concerned with the control of the antenna's radiation pattern characteristics in general and not just with the main lobe or beam of the pattern. By controlling, adjusting and adapting the level and the position of the sidelobes and the nulls in transmission, the interference levels to other users can be reduced. Similarly, in reception, pattern control, pattern adjustment and pattern adaption can be used to reduce the interference levels from other users. Embodiments described herein are thus applicable to both transmission and reception.

Antenna arrays may allow to generate transmission radiation patterns and/or reception radiation patterns. A reception pattern may be used, for example, in connection with reception or sensing a signal. An array of sensor elements may offer a means of overcoming the directivity limitations associated with a single sensor (antenna), thus offering higher gain and narrower beamwidth than that experienced with a single element. In addition, an array has the ability to control its response based on changing conditions of the signal environment, such as direction of arrival, polarization, power level and frequency [8].

An array consists of or may comprise two or more sensors in which the signals are coherently combined in a way that increases the antenna's performance. Arrays used in embodiments may have the following advantages over a single sensor:
1. Higher gain. The gain is higher, because the array gain is on the order of the number of elements in the array. Higher resolution or narrower main beam follows from the larger aperture size.
2. Electronic beam scanning. Physically or mechanically moving large antennas to steer the main beam is slow. Arrays with phase shifters at each element are able to steer the beam without mechanical motion, because the signals are made to add in phase at the beam steering angle.
3. Low sidelobes. If the desired signal enters the main beam while interfering signals enter the sidelobes, then lowering the sidelobes relative to the main beam improves the signal to interference ratio.
4. Multiple beams. Certain array feeds allow simultaneous multiple main beams.
5. Adaptive nulling. Adaptive arrays automatically move nulls in the directions of signals over the sidelobe region

In addition to the reception advantages described above, an array also offers considerable benefits when used for transmission purposes, too.

Regardless of whether the array is used for transmission or reception purposes, it is normally needed to provide a means by which the array's antenna radiation pattern can be controlled for the following reasons: to point one or more beams in given directions; to control the direction and relative level of sidelobes; and/or to control the position and relative depth of nulls.

An example for controlling an antenna radiation pattern may be explained in connection with phased antenna arrays. The examples provided relates to measures to be implemented at or between antennas of an antenna array.

It is noted that objections exist about the term phased array antenna for a scanned beam array antenna, based on the fact that a non-scanned array antenna is still in fact a phased array antenna, as its operation relies on relative phases between the elements. Notwithstanding this argument, the term phased in connection with beam-steered, will be used thereby following the historical development [8]. The term beam former will also be used regardless of whether only a single beam or multiple beams are created.

A phased array is typically comprised of a number of antenna elements arranged in two- or three-dimensional space. The position of the elements with respect to one another is generally fixed—in other words, they do not move in their own array space. This does not however necessarily exclude phased array systems from portable and mobile applications. The elements of an array can be arranged geometrically so as to be linear, planar or conformal in either a regular or an irregular manner. Combinations of the aforementioned categories are also possible.

In the case of a fully digital beam forming system, the antenna elements may be individually connected to their own transmitter or receiver or transceiver circuit. Alternatively, in an analogue beam forming system, more than one antenna element may be connected to a common radio circuit via either a series- or corporate-feed network. The number of elements per radio is determined by system requirements and design constraints. A so-called hybrid beam forming system combines both digital and analogue implementations.

Almost regardless of the method used to implement the beam former—digital, analogue or hybrid—it is the excitation of its elements that determines certain radiation characteristics of the array. In order to control such properties, for example the direction in which a beam is directed, the phase of individual element excitation has to be configured appropriately. Similarly, sidelobe levels, as discussed below can be controlled through amplitude tapers.

Realization of Phase Shifting

Having explained the reason for controlling the phase excitation of array antenna elements, this section outlines four example methods that are available for accomplishing a desired phase shift.

Changing Frequency

Phase shifting by changing frequency or frequency scanning is accomplished by series feeding the array antenna elements whereby the elements are equidistantly positioned along the feed line. By changing the frequency, a changing linear phase taper over the array antenna elements is created, since the input signal has to travel over a physical distance and thus electrical length to reach the i^{th} element of the K-element linear array antenna. If the physical lengths of the feeding lines are chosen such that at the centre frequency, the phased array antenna beam is directed perpendicular to the array or to broad-sight, changing the frequency to values lower than and greater than the centre frequency will direct the beam to, respectively, angles smaller than and angles greater than broad-sight [8]. When a phased array is used for communication purposes however, in which a fixed frequency channel assignment is typical, it is impractical to implement phase shifting by changing the frequency of operation.

Changing Length

This type of phase shifting may be applied to series-fed arrays, as well as to corporate-fed arrays, [9]. In the pre-digital era, phase shifters based upon changing physical length were realised by electromechanical means. The line stretcher [9] is an example of an early type of phase shifter. The line stretcher is a (coaxial) transmission line section, bent in the form of a ‘U’. The bottom part of this ‘U’ is attached to the two ‘arms’ that form part of the stationary feeding network. The bottom part of the ‘U’ acts as a telescoping section that may be stretched by electromechanical means, thus lengthening and shortening the transmission line section, without changing the position of the ‘arms’ of the ‘U’ [8].

Nowadays, different lengths of transmission line are selected digitally. The switches in every section are used to either switch a standard length of transmission line into the network or to switch a piece of transmission line of a predetermined length that adds to this standard length. These lengths are chosen such that when the cascade of the standard length is taken as reference (having a phase ψ=0°), 16 phases (corresponding to 4 bits), ranging from ψ=0° to ψ=337.5°, in steps of 22.5° (least significant bit) may be selected. Higher resolution can be achieved by using shorter lengths and more bits. PIN diodes—employed in forward and reverse bias—are often used as switching elements [9, 10]. The switched phase shifters may be realised in microstrip technology, using high dielectric constant substrate material, thus minimising physical phase shifter dimensions [8].

Another way of switching physical line lengths is found in the cascaded hybrid-coupled phase shifter. A 3 dB hybrid is a four-port device that divides the power at input port 1, equally over output ports 2 and 3 and passes no power to output port 4. The reflections of the signals that have left ports 2 and 3 return into the hybrid and combine at output port 4, none of the power being returned to input port 1. The diode switches in every segment (bit) of the cascaded hybrid-coupled phase shifter are either returning the signals leaving ports 2 and 3 directly, or after having travelled the extra line length ΔI/2 twice. As an example, a four-bit phase shifter ΔI/2=λ/32 for the least significant bit, and for the following three bits, respectively, ΔI/2=λ/16, ΔI/2=λ/8 and ΔI/2=λ/4 [8].

Changing Permittivity (Dielectric Constant)

By adjusting the current that flows through a device containing a gaseous discharge or plasma, its dielectric constant and hence phase shift can be controlled [9]. Another way to adjust the permittivity of a device is through the use of so-called ferro electric materials in which the permittivity is a function of the electric field applied over the material [8]. The permittivity may be adjusted between the antennas of the antenna array. While one approach may be to apply this technique in a device that performs the function of changing the phase of the signal associated with an element of the antenna array, it may, according to another approach, be applied to the structure that forms part of the antenna element and/or the array of antenna elements so as to implement the phase shift by use of the structure, material or arrangement by changing a permittivity. Both approaches may be combined with each other.

Changing Permeability

Ferrimagnetic materials, or ferrites, are materials for which the permeability changes as function of the change in an applied magnetic field in which the material is positioned. Ferrite-based phase shifters have been in use for a long time, especially in combination with waveguide transmission line technology. In the case of the Reggia-Spencer phase shifter [9]—which consists of a rod of ferrimagnetic material, centrally positioned inside a waveguide, where a solenoid is wound around the waveguide—the phase can be changed continuously, making the phase shifter analogue in nature. On the other hand, the function of the solenoid can be performed by a current wire through a ferrimagnetic rod. By cascading different lengths of ferrimagnetic rods, different (discrete) phase shifts may be realised, thus making such phase shifter digital in nature [8]. The permeability may be adjusted between the antennas of the antenna array. As described in connection with the change of the permeability, while one approach may be to apply a phase shift for changing the phase of the signal associated with an element of the antenna array, according to another approach, the phase shift may be applied to the structure that forms part of the antenna element and/or the array of antenna elements by changing a permeability in the structure and/or between components thereof, e.g., between antenna elements and/or arrays of antenna elements. Both approaches may be combined with each other. Further, changing the permittivity may be combined with changing the permeability in order to obtain at least a part of the phase shift.

As discussed, also amplitude tapers may be used, e.g., to control sidelobes.

The strength or amplitude of the element excitation—also known as the element weight—controls the directivity and sidelobe level of the array factor. Examples of amplitude tapers include binomial, Dolph-Chebyshev, Tseng-Cheng-Chebyshev, Taylor, Taylor-Woodard, Hansen, Bickmore-Spellmire and Bayliss [11]. Low-sidelobe amplitude tapers have high amplitude weights in the centre of the array and the weights generally decrease from the centre to the edges. In general, as the taper efficiency decreases, the half-power beamwidth increases and the sidelobe levels decrease.

Amplitude Realization

Amplitude excitation adjustment of antenna elements can be realized by controlling the gain of amplifier stages which, depending on the implementation of the system, could include digital gain, intermediate frequency (IF) gain and radio frequency (RF) gain settings for both the transmitter and receiver chains. Where appropriate, active signal amplification can also be implemented in frequency translation stages by, for example, controlling the drive level of local oscillator devices connected to mixer devices. In addition to the aforementioned active devices that introduce signal amplification, passive devices can also be used which, due to their nature, attenuate signals rather than amplify them. Examples of such devices include power dividers or splitters, coupled lines or couplers, transformers, impedance converters, resistive networks and parasitic elements.

Embodiments described herein relate to both, devices that interfere with other devices while communicating and that address the interference they cause by controlling their antenna radiation pattern. For a better understanding such devices may be referred to as interferer or aggressor. Embodiments further relate to devices that detect that they are interfered or disturbed by other devices to which they do possibly not maintain (at least at present) a connection or data exchange. Those devices may be referred to as interfered devices or victim.

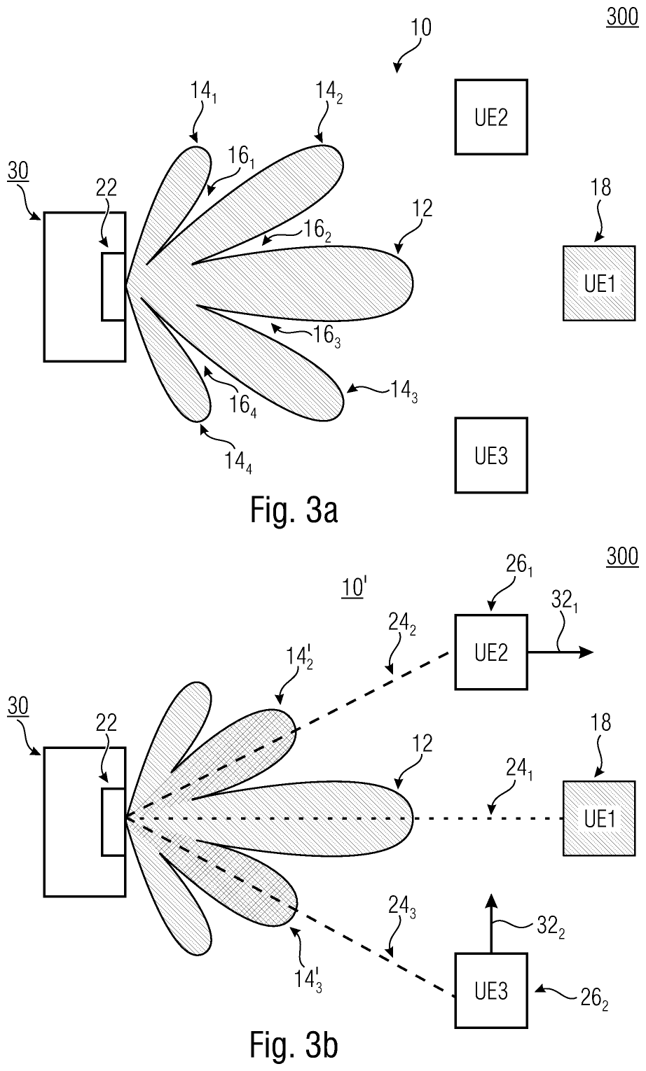

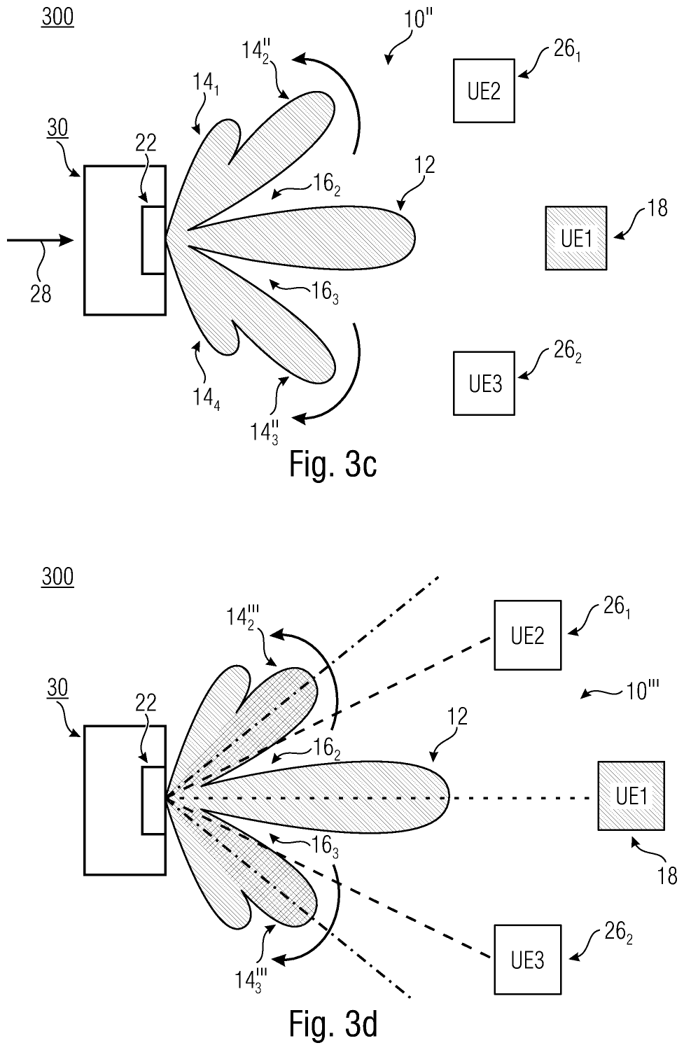

FIG. 3a shows a schematic top view of at least a part of a network 300 in which a device 30 is operating. By way of example, the device 30 may be a basestation such as a gNB or eNB configured for operating a cell of a wireless communication network. Alternatively, the device 30 may also be a UE operating in the cell, for example, when performing a p-2-p communication or when performing communication with a basestation. However, embodiments are not limited hereto but relate to any kind of device being capable of performing beamforming in a way so as to generate an antenna radiation pattern comprising a main lobe and at least one sidelobe. A null 16 may be arranged between two adjacent lobes. The antenna radiation pattern 10 may be a transmission radiation pattern or a reception radiation pattern, i.e., a pattern in which directions of reception are defined.

By way of non-limiting examples, the device 30 will be described in connection with generating the antenna radiation pattern 10 as a pattern to be used for transmitting a signal. The description provided may be transferred without limitation to a sensitivity in a reception (RX) pattern that also allows for an exchange of energy along one or more directions (of the lobes) whilst to allow for a reduced amount along other directions (e.g., nulls).

The device 30 may be configured for communicating with a communication partner 18, for example, a UE being identified as UE1. In connection with the example illustrated in FIG. 3a, the device 30 may transmit a signal to the communication partner 18. For doing so, the device 30 may be configured for controlling the main lobe 12 towards a path 24₁ to the communication partner 18. That is, the main lobe 12 may be directed by the device 30 along a Line of Sight (LoS) path or at least one non-LoS (nLoS) path or combinations thereof. This may allow to transfer energy between the location of the device 30 and the location of the communication partner 18. In the described downlink scenario, the energy may be transmitted from the device 30 to the location of the communication partner 18. In case of an uplink scenario, the energy may be transmitted from the location of the device 18 to the location of the device 30, an antenna arrangement 22 thereof respectively.

For a better understanding, according to the described embodiment, the antenna radiation pattern 10 formed by the device 30 is implemented, adapted or generated such that the main lobe 12 points towards the LoS path towards the location of the communication partner 18. Accidently, the antenna radiation pattern 10 may be in a configuration such that one or more sidelobes 14₁ and/or 14₂ are implemented so as to transfer energy to other devices 26₁ and/or 26₂ in the transmit case, the receive case may be operated accordingly. For example, the devices 26₁ and 26₂ are devices within the same cell and, thus, may suffer from intra-cell interference. In an example, where the devices 26₁ and 26₂ are devices within a different cell or of a communication network operated by a different operator (which may be referred to as a common network however when regarding the shared resources), the devices may suffer from inter-cell interference. Although the sidelobe 14₂ is illustrated so as to point along a LoS path 24₂ towards the device 26₁ and the sidelobe 14₃ is illustrated so as to point along a LoS path 24₃ towards the device 26₂, the sidelobe 14₂ and/or the sidelobe 14₃ may also point along an nLoS path. Alternatively, only one or more than two sidelobes may transfer energy between the location of device 30 and locations of further devices 26, thereby causing interference.

In other words, FIG. 3a shows the antenna pattern of the base station serving UE1. While its main lobe or “beam” is directed towards UE1, its two side lobes inadvertently point towards UE2 and UE3, thus creating interference. Interference reduction may be achieved by adapting the base station antenna pattern as illustrated in FIGS. 3b, 3c and 3d.

FIG. 3b shows a schematic block diagram of the part of the wireless communication network 300 in which a transmission power or sensitivity of the side lobes 14₂ and 14₃ is reduced so as to obtain side lobes 14′₂ and 14′₃ having a reduced power or sensitivity, thereby lowering the amount of energy transferred between the device 30 and the other devices 26₁ and 26₂.

In other words, with reduced power in the side lobes 14₂ and 14₃ interference may be reduced.

FIG. 3c shows a schematic block diagram of the part of the network 300 in which the device 30 controls the sidelobe 14₂ and/or 14₃ (optionally a lower number of at least one or a number larger than 2) so as to point along a different direction, to obtain modified sidelobes 14″₂ and/or 14″₃. FIG. 3c thus provides for redirected side lobes 14₁, and 14₂ so as to obtain redirected side lobes 14″₂ and 14″₃ in an antenna radiation pattern 10″. Alternatively or in addition, the device 30 may control a null 16₂ and/or 16₃ in view of its direction which causes also to an indirect control of the sidelobes. For example, creating a null at a varied orientation (in one example along a direction/path along which in a former instance of time a sidelobe was directed) leads to a changed property of the respective sidelobe and/or other lobes. According to an example, device 30 may direct a null 16₂ and/or 16₃ along a path towards device 26₁, 26₂ respectively.

For example, an adaptive array of a victim device may be controlled to adjust the radiation pattern so as to (still) direct the main beam to the direction of the wanted signal and a null to the interferer. For example, an adaptive array of an aggressor device may be controlled to adjust the radiation pattern so as to (still) direct the main beam to the direction of the communication partner and a null to the victim 26. While such a control may also change the sidelobes, such adaption may be very much null related to directing a null towards the interferer. Thus, controlling a sidelobe may result in a null controlled thereby and controlling a null may result in controlling a sidelobe thereby.

In other words, with the side lobes pointed away from UE2 and UE3, interference may be reduced.

FIG. 3d shows a schematic block diagram of a scenario in which the concepts of FIG. 3b and FIG. 3c are combined so as to obtain redirected and power-reduced side-lobes 14″′₂ and 14″′₃ of an antenna radiation pattern 10″′. Both, redirected and power reduced sidelobes allow to transfer a lower amount of energy or even no energy to the locations of the devices 26₁ and 26₂ whilst a combination may be of particular advantage. Meanwhile, the main lobe 12 may remain unchanged or with changes that have only minor, tolerable or negligible effects on the amount of transferred energy. For example, an amount of power transferred with the main lobe 12 and/or a direction thereof may vary within a tolerance range of at most 30%, at most 15% or at most 5%. By controlling the sidelobe 14₁ and/or 14₂, device 30 may address interference at the location of the device 26₁, 26₂ respectively. In particular, the amount of interference at the other devices being not part of the communication between devices 30 and 18 may be reduced or may be kept low so as to allow for a high communication quality and therefore a high communication throughput of the devices 26₁ and/or 26₂.

In other words, FIG. 3d shows a combination of the concept of FIG. 3b and FIG. 3c, i.e., the side lobe level is reduced and is redirected.

FIGS. 3a-3d present examples of how the antenna pattern of the basestation can be adjusted or adapted in order to control the interference towards other devices. These examples include sidelobe power level control, sidelobe spatial direction and combinations of the two and of further measures. Although the figures illustrate a simplified situation in which the power in two sidelobes is reduced equally, or the direction in which the two sidelobes point is changed similarly, practical realizations may be more complex. FIGS. 3a-3d for convenience show a two-dimensional representation situation whereas a real-world system is comprised of three-dimensions.

Examples of the aspects of pattern adjustments, pattern adaption or pattern control that enable the interference reduction to other users comprise but are not limited to:
main lobe and/or side lobe (power) level control;
main lobe and/or side lobe direction in azimuth or elevation or combinations of the two; and
main lobe and/or side lobe polarization.

Application to Networked Devices

Although FIGS. 3a-3d show the antenna pattern of the basestation only, an antenna pattern may be associated with all of the devices shown—UE1, UE2 and UE3. The situation may be naturally extended to a network comprised of many basestation and user equipment devices. It should thus be noted that the methods of pattern adaption that have been introduced thus far for the basestation can also be applied to user equipment devices comprised of the means to produce a spatially directive antenna radiation pattern. In short, the embodiments disclosed herein are applicable to any device that has some form of beam steering.

Although FIGS. 3a-3d are described in connection with changing a direction of the sidelobe 14₁ and/or 14₂ to address the interference at the location of the device 26₁, 26₂ respectively, the device 30 may alternatively or in addition implement other mechanisms. For example, device 30 may control a direction of the main lobe 12 so as to thereby effect the direction of the sidelobes. When referring again to FIG. 2, a control of the main lobe 12 so as to deviate from the direction of 30 degrees, by, e.g., 1, 2 or 3 degrees may still allow for a high or sufficient transfer of energy to the communication partner 18. At the same time, a direction of the sidelobes may be also shifted, wherein this may allow to avoid illuminating the locations of the devices 26₁ and/or 26₂ (or of other devices) with the sidelobes.

Alternatively or in addition, the device 30 may be configured for controlling a level of power transfer between the device 30 and the device 26₁ and/or 26₂ by way of the sidelobes 14₁, 14₂ respectively and/or by use of the main lobe thereby effecting the level of power transfer at the sidelobes to the location of the device 26₁, 26₂ respectively. A level of power transfer may be controlled, for example, by controlling a transmission power or a sensitivity along the respective lobe.

For example, the device 30 being configured to address the interference by controlling the sidelobe in view of the level of power transfer between the device 30 and the device 26₁ and/or 26, the device may adapt a level of power transmission along one or more paths between the device 30 and the respective device 26₁ or 26₂ in a radio propagation environment. The radio propagation environment may include LoS and nLoS paths, wherein this may relate to single paths or a combination thereof, for example, a set of multi path components that commonly contribute to the interference.

Specific actions may be implemented by device 30 based on a distance between the device 30 and the communication partner 18. For example, the communication partner 18 may be located as a far device. Such a far device may be understood as a device having a distance such that the effective path loss is high resulting in a low Signal to Noise Ratio (SNR) on the desired link. The further device 26₁ or 26₂ (victim) may, in contrast, be located as a near device which may result in a level of received interference at the receive antenna (RX antenna) before the RX beam former which may cause the Automatic Gain Control (AGC) to respond to both signals (desired and interfered) or even to be dominated by a power level from the interferer which may lead to effectively desensitizing the receiver.

Alternatively, the communication partner may be located as a near device and/or the victim may be arranged as a far device.

Alternatively or in addition, the Signal to Interference Ratio (SIR) may be at most a targeted Signal to Interference plus Noise Ratio (SINR) of the desired link (referring to the chosen Modulation Coding Scheme (MCS) level. The device 30 may be configured for reducing the interference level (at the victim) to improve the SINR to improve a link capacity between the device 30 and the communication partner 18.

Alternatively or in addition to the aforementioned mechanisms, the device 30 may be configured for controlling a polarization of the sidelobes 14₁ and/or 14² and/or of the main lobe 12. Alternatively or in addition, the device 30 may be configured for controlling a selection of an antenna port used for forming the antenna radiation pattern 10, of a sub-array of an antenna array used for forming the antenna radiation pattern 10 and/or of at least one antenna panel used for forming the antenna radiation pattern 10. That is, the device 30 may be configured for using another antennas, antenna panels or antenna sub-arrays for generating an antenna radiation pattern that still allows to direct the main lobe to the location of the communication partner 18 whilst providing for a possibly different structure of the sidelobes which may be more suitable to avoid interference at locations of the devices 26₁ and/or 26₂.

Although the embodiments of FIGS. 3a-3d are illustrated so as to generate the antenna radiation pattern 10 and to then adapt the sidelobes whilst maintaining the main lobe, other embodiments may avoid to first generate interference at locations of devices 26₁ and/or 26₂ by generating the antenna radiation pattern 10′, 10″ or 10′″ right from the beginning. For example, the device 30 may have knowledge about a location and/or requirements of the devices 26₁ and/or 26₂ and may consider those requirements already when selecting the antenna radiation pattern to be applied. That is, the device 30 may generate an antenna radiation pattern addressing the interference at non-communicating devices (with respect to the device 30) already at the beginning.

According to an embodiment, the device is configured for selecting the antenna radiation pattern 10′ from a plurality of possible antenna radiation patterns. The possible antenna radiation patterns may be understood as a set of formable or creatable antenna radiation patterns that may be taken from a prepared or preselected set of antenna radiation patterns which may be obtained, for example, from a codebook. The device may be configured for generating the selected antenna radiation pattern and to adapt the generated radiation pattern to reduce the interference between the device 30 and the device 26₁ or 26₂ when compared to the selected antenna radiation pattern. Such a scenario is illustrated in FIGS. 3a-3d. For example, the device may select the most usable or appropriate antenna radiation pattern to communication with the communication partner 18. Alternatively, the device 30 may select the antenna radiation pattern from a plurality of possible antenna radiation patterns so as to lead to an interference below a predefined interference threshold between the device and the further device. The predefined interference threshold may be an absolute value of the interference level, e.g., a value relating to a specific power or the like, or may be a relative value, e.g., a minimum interference level amongst the usable or suitable radiation patterns to communicate with the communication partner 18. The minimum value may be encompassed with a tolerance range and/or weighting values so as to optimize both, the power transfer to the intended communication partner 18 and the power transfer (reduction thereof) to the victims 26₁ and/or 26₂. That is, the device 30 may select the antenna radiation pattern from the plurality of possible antenna radiation patterns so as to lead to a minimum interference between the device 30 and the device 26₁ and/or 26₂ whilst providing for an energy transmission above a predefined transmission threshold between the device 30 and the communication partner 18 or a maximum energy transmission between the device 30 and the communication partner 18.

When referring again to FIGS. 3a-3d, addressing the interference at the victims 26₁ and/or 26₂ may be implemented by controlling at last one of a direction of a load, a level of power transfer, a polarization and a selection of an antenna port. When controlling a direction of a sidelobe, a control parameter to be applied by the device 30 may be the implemented direction of the sidelobe and/or a direction of a null of the antenna radiation pattern. That is, by directing, for example, a null to the location of the victim, thereby implicitly sidelobes are directed or located to other locations. Alternatively or in addition, a direction of the sidelobe may be controlled actively, e.g., far away enough from the location of the device 26₁, 26₂ respectively. Far enough away may be understood such that the interference caused by the device 30 at the location of the device 26₁ or 26₂ is below an interference threshold level.

For addressing the interference, the device 30 may alternatively or in addition be configured for performing a beam sweeping procedure to address the interference at the location of the device 26₁ and/or 26₂. During a beam sweeping procedure, the antenna radiation pattern 10 may at least in parts be moved in space. A beam sweep may be understood as moving the radiation pattern from one side to another or forth and back thereby illuminating different locations with the beams in a time variant manner.

For addressing the interference, alternatively or in addition, the device may be configured for implementing a pattern to the antenna radiation pattern in view of a blanking, puncturing or power boosting pattern. Thereby, punctured, blanked or power boosted resources of the antenna radiation pattern may be made specifically observable at the location of the device 26₁ and/or 26₂ via a multipath propagation environment at least in parts. Interference may be addressed thereby as the punctured, blanked or power boosted resources may form a specific pattern (e.g., of resources having no, low or high power) which may be associated with the identity of the device 30.

This association may be known throughout the network and/or at the device 26₁ or 26₂ but may also be unknown. When being unknown, the pattern may nevertheless be associated with the identity of the device 30 as at least the device 30 knows the pattern it implements. The implemented pattern may allow to assess or identify the interfering source/interference source/interference effect which then allows to reduce interference levels. Whilst a known or predefined beam pattern allows to correlate and detect/identify the interference source or the interference pattern, an unknown pattern may be identified and provided to a network for a source identification. Alternatively or in addition, the unknown pattern may be compared to a data base for a source identification or may be used for successive further signal processing after identification, e.g., successive interference source detection/identification.

The interference addressed by device 30 may comprise a co-channel interference and/or an adjacent channel interference, i.e., interference caused in the same channel/frequency spectrum (of a same or different operator/provider), in adjacent channels (of a same or different operator/provider) respectively. For determining an adjacent channel interference, different mechanisms such as ACLR (Adjacent Channel Leakage Ratio) measurements may be used to determine such interference. It is noted that adjacent channel interference is not only related to channels that are direct neighbours but also relate to other channels that are different from the interference suffering channel e.g., sidelinks or in other networks. Such interference can be caused by transmitter sources which for instance form mixing products like differences, sums or harmonics with a distant (e.g., in frequency) channel that affects the suffering channel. For example, a 1.8 GHz channel may affect a 3.6 GHz channel. Even in such a scenario the aggressor device may operate in a different spectrum or in a different band (of a same or different operator/provider) whilst still affecting the victim, e.g., in view of the SINR obtained at the victim. Multiple ways of recognizing such interference are presented herein, e.g., providing information that allow to identify the aggressor. That is, embodiments are not limited to specific types of interference but relate to actively avoid interference at devices not communicating with the device 30.

When referring again to FIGS. 3a-3d, the device 30 may be configured for obtaining knowledge about a location of the device 26₁ and/or 26₂. Alternatively or in addition, the device 30 may obtain knowledge about at least one direction of a relevant multi path component (MPC) between the device 30 and the device 26₁ or 26₂. Based on at least one of the location and the direction of the MPC the device may control the sidelobe to comprise a low amount of power transfer between the device 30 and the location or along the at least one direction so as to address the interference. That is, the locations as well as the direction where interference has to be avoided may both allow to reduce the interference at the location of the victim.

As shown in FIG. 3c, the device 30 may be configured for obtaining knowledge about a request 28 to reduce interference at the location of the device 26₁ and/or 26₂. The request 28 may be based on a report 32₁ being reported by device 26₁ and/or by a report 32₂ being reported by device 26₂ responsive to being interfered. That is, when receiving relevant signal power from the device 30 or signal power above a threshold, the respective device may report this situation to its network or to a specific node of the network. For example, the devices 30 and 26₁ and/or 26₂ being operated in a same network or same network cell, the devices may exchange the report 32 and/or request 28 directly. When being operated by different providers, the device 26₁ and/or 26₂ may transmit their reports 32₁ or 32₂ to a node of their networks as to allow for an exchange of information between the different networks such that the device 30 receives the request 28 from its own network. That is, the device 30 may be configured for receiving directly (e.g., intra-network) or indirectly (e.g., inter-network) a reporting 28 about a measure of interference at the devices 26₁ and/or 26₂. The report 32₁ and/or 32₂ may be based on a reception of wireless energy transmitted by the device 30. As will be explained in more detail later, the report 32₂ and/or 32₂ may also be based on a prediction. For example, the report may be predictive based on a location or movement of the device 30 relative to the device 26₁, 26₂ respectively. This may include a movement of the device 30 and/or of the device 26₁, 26₂ respectively.

As described, the device 30 may be configured for controlling a single sidelobe of the antenna radiation pattern 10 or may be configured for controlling a plurality of sidelobes of the antenna radiation pattern so as to address interference at a plurality of locations. The device 30 may be configured for addressing the interference at the location of the device 26₁ and at the location of the device 26₂. The device 30 may be configured for controlling at least the sidelobe 14₁ and 14₂ of the antenna radiation pattern 10. This controlling may be based commonly or may be based on a sidelobe-by-sidelobe assessment, i.e., the sidelobes may be controlled individually.

In a direct or indirect way, the device 30 may receive a signal from the device 26₁ or 26₂ indicating an exchange of energy or an observation of received power between the device 30 and its victim.

The device 30 may perform, responsive to having acquired information about a request to reduce interference at the location of the device 26₁ and/or 26₂ one or more of the following steps. Acquiring information about a request to reduce interference may comprise a reception of the report 32₁ or 32₂ and/or of the request 28. The device may perform, for example, a renegotiation between devices forming a link in which the device is one part of that link, by adapting the antenna pattern for the transmitting devices and/or that of the receiving device. That is, the device 30 and/or the communication partner 18 may adapt their antenna patterns. Alternatively or in addition, the device 30 may perform a pattern restriction of the antenna radiation characteristic in view of a direction/coverage/illumination. For example, when the device 30 is a drone flying over a base transceiver station (BTS) or when the device is a vehicle in a tunnel or when the device is a possibly low-earth (or other) orbiting satellite that communicates with a terrestrial device as communication partner or vice versa, temporarily a direction or coverage or illumination area may be adapted. Alternatively or in addition, a goal-based or target-based action may be performed, e.g., to reduce a power effecting the device 26₁ and/or 26₂. This may include a reschedule and/or coordinate of beams of the selected transmit antenna pattern. Alternatively or in addition, the device may perform a command-based action, e.g., to use a specific beam X when a specific condition Y is present. Alternatively or in addition, the command may indicate to not use beam P when condition Q happens. Alternatively or in addition, the device may be adapted to use selective codebook entries (e.g., a Type I single-panel codebook; a Type I multi-panel codebook; a Type II single-panel codebook; and/or a Type II multi-panel codebook or a different codebook) or beam indexes.

In general, addressing interference may be based by implementing devices that perform respective actions, e.g., by controlling an antenna array so as to implement a phase shifting and/or an amplitude control, e.g., as described above. These means may need practical implementation which may lead the performance of the components or devices used to be affected to a greater or lesser extent by operational and environmental conditions. With respect to operational conditions, the typical performance of a device may be altered due to, for example: the frequency of operation; the bandwidth of the signal; the power of the signal; the modulation of the signal; the number of signals; the number of streams contained within a signal; the presence or absence of other signals; the needed scan angle; the polarization; the coupling or mutual-coupling of energy between antenna elements, sub-arrays and antenna panels; ageing effects; and element and component failure. Whereas with respect to environmental conditions, the typical performance of a device can be changed by, for example: temperature; humidity; altitude; solar radiation; electric fields; magnetic fields and/or vibration.

As explained previously, in order to form the phase array antenna radiation pattern appropriately—according to operational criteria—the signal associated with each antenna element of the phased arrays may be suitably adjusted, in phase and/or amplitude, often in both phase and amplitude. According to embodiments, at least one of two examples of methods that may be used to implement this effect; codebooks and adaptive arrays.

Codebooks

According to an embodiment, a device to address interference may us a codebook for forming the antenna radiation pattern. Thereby, the sidelobes and/or nulls may also be controlled directly (e.g., by selecting a suitable codebook-entry) or iteratively (e.g., by adapting the antenna radiation pattern by iteratively selecting codebook entries). A so-called codebook may provide a convenient method of organizing and retrieving the beamforming vectors associated with a phased array antenna. For example, each column of a codebook matrix may specify the phase shift of each antenna element, and a practical beam can be generated with the phases specified in each column of the codebook [11].

According to an example, the device may use a codebook that comprises or is one or more of a so-called
Type I single-panel codebook;
Type I multi-panel codebook;
Type II single-panel codebook; and
Type II multi-panel codebook

which does not exclude to alternatively or additionally use other codebooks.

In the context of systems that enable multiple-input multiple-output (MIMO) operation, for example 5G and beyond 5G systems, the MIMO precoding matrices are also known as codebooks. The design of such codebooks is based on a trade-off between performance and complexity. The following are some desirable properties of the codebooks [13]:
1. Low-complexity codebooks can be designed by choosing the elements of each constituent matrix or vector from a small binary set, for example, a four alphabet (±1, ±j) set, which eliminates the need for matrix or vector multiplication. In addition, the nested property of codebooks can further reduce the complexity of CQI calculation when performing rank adaptation [13].
2. A basestation may perform rank overriding which results in significant CQI mismatch, if the codebook structure cannot adapt to it. A nested property with respect to rank overriding can be exploited to mitigate the mismatch effects [13].
3. Power amplifier balance is taken into consideration when designing codebooks with constant modulus property, which may eliminate unnecessary increases in peak-to-average power ratio (PAPR) [13].
4. Good performance for a wide range of propagation scenarios, for example, uncorrelated, correlated, and dual-polarized channels, is expected from the codebook design algorithms. A DFT-based codebook is optimal for linear arrays with small antenna spacing since the vectors match the structure of the transmit array response. In addition, an optimal selection of the matrices and the entries comprising the codebook (e.g. rotated block diagonal structure), offer significant gains in dual-polarized scenarios [13].
5. Low feedback and signalling overhead are desirable from an operation and performance perspective [13].
6. Low memory requirement is another design consideration for the MIMO codebooks [13].

Adaptive Arrays

An adaptive array may comprise an algorithm which is possibly computer-based and that controls the signal levels at the elements until a measure of the quality of the array performance improves. It may adjust its pattern formed, i.e., the antenna radiation pattern, to form nulls, to modify gain, to lower sidelobes, or to do whatever it takes to improve its performance. An adaptive array offers enhanced reliability compared with that of a conventional array. When a single sensor element/antenna element in a conventional array fails, the sidelobe structure of the array pattern degrades. With an adaptive array, however, the remaining operational sensors in the array automatically adjust so as to restore the pattern. For this reason, adaptive arrays are more reliable than conventional arrays, since they fail gracefully. The reception pattern of an array when installed on a structure such as a tower or a vehicle, or when held in the hand, placed next to the head, or worn on the body, is often quite different from the array pattern measured in isolation (in an anechoic chamber) as a result of signal scattering that occurs from vehicle structures in the vicinity of the antenna or from interaction with the user. An adaptive array may yield successful operation even when antenna patterns are severely distorted by near-field effects. The adaptive capability overcomes a lot of or even any distortions that occur in the near field and merely responds to the signal environment that results from any such distortion. Likewise, in the far field the adaptive antenna is oblivious to the absence of any distortion [11].

An adaptive array may improve the SNR by preserving the main beam that points at the desired signal at the same time that it places nulls in the pattern to suppress interference signals. Very strong interference suppression may be possible by forming pattern nulls over a narrow bandwidth. This exceptional interference suppression capability is a principal advantage of adaptive arrays compared to waveform processing techniques, which generally need a large spectrum-spreading factor to obtain comparable levels of interference suppression. Sensor arrays possessing this key automatic response capability are sometimes referred to as “smart” arrays, since they respond to far more of the signal information available at the sensor outputs than do more conventional array systems [11].

Pattern Control Using Codebooks and Adaptive Antennas

While codebooks and adaptive algorithms each offer their own particular advantages and disadvantages, it is not immediately obvious how the merits of the two can be combined simply and effectively in a practical system. This is further exacerbated when the practical realization of a phased array is considered together with the operational and environmental impairments that were introduced above.

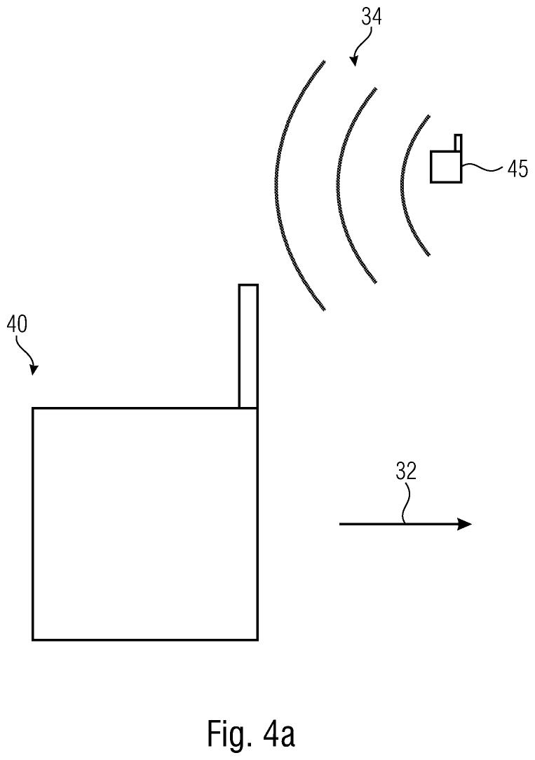

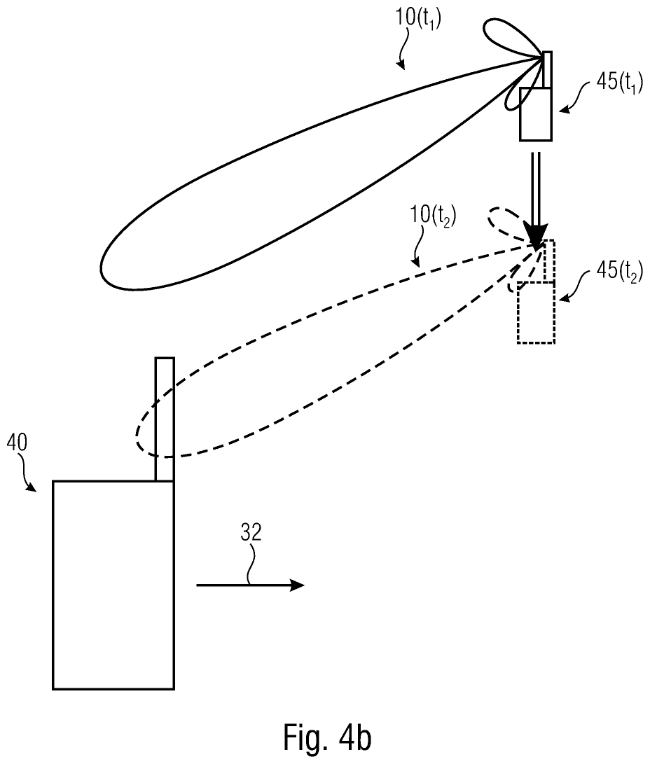

FIG. 4a shows a schematic block diagram of a device 40 according to an embodiment. The device 40 is explained, in the following in view of a victim device, i.e., a device which is interfered by an interfering signal 34, e.g., one of the sidelobes 14 of a device 45 which may be device 30 in an embodiment. The device 40 is configured for operating in a wireless communication network. The device 40 is configured for communicating with a communication partner, e.g., in the wireless communication network. Optionally the device 40 may be configured for forming an antenna radiation pattern, i.e., is able to perform beamforming, whilst in other embodiments device 40 does not perform beamforming.

The device 40 is configured for determining a measure of interference associated with a device not communicating with the device 40. For example, the device 40 may be the device 26₁ of the wireless communication network 300 and does not intend to communicate with the device 30 which may be a source of the interfering signal 34. The device 40 may be configured for determining a measure of interference associated with the device 40 based on a reception and evaluation of the interfering signal 34 or by an expectation about receiving the signal in the future. The device 40 may be configured for reporting to the interfering device 45 or a member of the communication network in which the interfering device 45 operates about the reception of power or the experienced/expected interference from the interfered device 45, the aggressor.

FIG. 4b shows a schematic block diagram of an interaction between the device 40 and the interferer 45. Although, at a time T₁ the device 45 may not interfere with the device 40 or may interfere at a low, possibly tolerable level, the device 40 may have knowledge about a movement of the device 45 and/or of at least parts of the antenna radiation pattern 10 generated by device 45. Based thereon, the device 40 may expect the device 45 to interfere the communication of the device 40 at a later time T₂. Based on this expectation or prediction, the device 40 may provide for the report 32 as a precautionary measure, thereby indicating that it expects to be interfered at time T₂. Such an expectation may be based on a movement of the device 45 and/or based on a movement of a communication partner of the device 45 which may cause the device 45 to adapt its antenna radiation pattern. For example, based on a relative movement between the device 45 and its communication partner, the device 40 may temporarily be arranged along a direction of one or more multipath components of the interfering communication. Alternatively or in addition, the device 40 may move and the prediction may indicate that the device 40 expects itself to travel along or through one or more sidelobes of a communication between the device 45 and its communication partner. That is, the device 40 may be configured for determining the measure of interference based on a reception of wireless energy transmitted by the further device 45 and/or predictive based on a location or movement of at least one of the device 40, the interfering device 45 and the communication partner of the interfering device 45.

The device 40 may be configured for determining at least a part of the antenna radiation characteristic 10 generated by the device 45 and for reporting about the measure of interference so as to report about the at least part of the antenna radiation characteristic 10, e.g., by means of the report 32. Thereby, it is possible to obtain knowledge within the network about the antenna radiation characteristic 10 at least in view of those components that may be measured at the receiving device and/or the interfered devices. In other words, it is possible that the generated antenna radiation characteristic is observed at the victim's position using a particular observation filter, e.g., a receive beam former or other means to receive an effective/resulting interference power superimposed with the intended signal (of the victim) from its own communication partner. If the level thereof is larger than the SNR with its own communication partner, then this may be considered as harmful interference. As an example, in uplink, a BTS may track a UE in its cell and another UE from another cell (aggressor) may interfere on this co-channel resource. At a current chosen RX beam pattern, the interfering UE may not be an issue, but when tracking its own UE, an RX sidelobe point to the interfering UE and degrees of freedom for informing might not allow for change/adaptation of RX pattern, e.g., placing a null towards the interfering aggressor. In such situations, the interfering UE may be requested to not transmit towards the victim BTS. This may allow the aggressor to adapt its radiation pattern as described in connection with FIGS. 3a-d.

The device 40 may be configured for reporting to the device 45 (e.g., device 30) about their reception (happened or expected) via a feedback channel or a control channel of the same network of a different network. The reporting about the past or expected reception may be based on at least one of
a Cell Identification (ID) of a cell of a wireless network;
a beam characteristic/identification;
a localization or geolocation;
a power class;
a sounding reference symbol (SRS);
a synchronization signal block (SSB);
a channel state information reference signal (CSI RS);
a bandwidth part (BWP);
a blanking/puncturing/boosting pattern; and
a reference signal (RS) and/or data transmitted from interfering source to be used as pseudo RS.

The device 40 may be configured for qualifying or quantifying or classifying or categorizing the reception of wireless energy, e.g., when receiving or expecting the interfering signal 34 based on at least one of:
a signal-to-interference-plus-noise ratio (SINR) degradation;
a signal-to-interference (SIR) ratio;
an interference level;
a hybrid automatic repeat request (HARQ) acknowledgement (ACK) or negative ACK (NACK);
an SINR/SIR level analysis, e.g., per (HARQ) retransmission packet or per receive beam pattern;
an SIR/SINR margin with respect to a targeted SINR; and
an SINR margin with adaptive beamforming considering reception (RX) nulling.

For example and in connection with the RX nulling, when the BTS is performing adaptive beam forming for UE tracking, i.e., to follow a relative movement between the UE and the device/BTS, then nulls towards the interferer can be easily placed as long as directions towards to the target UE and the interferer are distinguishably distributed/separated in the angular domain. If an angle between them falls below a threshold (e.g., both directions become indistinguishable or inseparable) the SIR may be reduced which effects the link, therefore the interferer may reduce its interference towards the direction/location of the BTS (victim). This may improve to ask/request for adaptive interference suppression at the aggressor before the victim link suffers. This may be referred to as predictive interference avoidance.

The device 40 may be configured for quantifying and/or qualifying the device 45 as a source of interference based on at least one of
a parameterization of potential aggressor characteristics
a time slot, a resource grid, an assigned channel and/or a BWP;
SRS, SSB, CSI RS;
a direction from which the signal 34 is received or expected;
a polarization of the signal 34;
an operating frequency and/or channel assignment;
a direction of transmission in uplink or downlink; and
an observed blanking/puncturing/power boosting pattern.

That is, one or more of these characteristics may be used by the device 40 so as to identify the device 45 which may allow to precisely report about the ongoing or expected interference so as to allow the device 45 to avoid or reduce this interference.

A parametrization of the potential aggressor may be performed, at least in parts by evaluating and/or associating with the aggressor-device one or more of the following.
Operating frequency/channel
Operating bandwidth
Carrier aggregation details
Transmission power
Transmission polarization
Transmission direction
Type of transmission (constant, scheduled, random, responsive to others)
Number of beams used
Properties of the beam(s) (beamwidth)
Multiplex characteristics—TDD/FDD or full-duplex
Modulation
Spatially static (fixed location) or spatially agile (changing position, i.e., mobile)
Location (fixed, updated, predicted/estimated)

It is to be noted, that additionally information with regard to another device such as location may be used. E.g., from a location one may derive a direction.

The device 40 may be configured for reporting the reception, i.e., to include information into the report 32, based on at least one of:
a full set, a sub-set, a compressed/reduced set of parameters; the reception report parameters may, for example, include one or more of the following:
   Received power (also per beam, per component carrier)
   Received channel
   Received direction
   Received signal-to-noise ratio (SNR)
   Received signal-to-interference ratio (SIR)
   Received signal-to-interference-plus-noise ratio (SINR)
   Determined channel quality information (CQI)
   Observed channel
an incremental, differential, event-based and/or ordered list; as a basis for comparison, such generation-techniques may be considered in view of techniques used for data storage backup:
   an incremental report may include all new parameters and all parameters that have changed since then first report
   a differential report may include all parameter changes that differ when compared to the first report
   upon a certain event (e.g., change of channel/beam/power) an event-based report may be triggered
   when the parameters are arranged in a specified sequence or are otherwise “ordered”—with or without a label that identifies the parameter being reported—the report is said to be an ordered list

The device 40 may provide its report according to one or more of:
trigger/threshold based or event based, e.g., in case of interference or curing, being expected and/or arriving at a certain threshold;
upon request;
timed;
synchronized;
queued; and
trailing/lagging/windowing (e.g., last X minutes, which provide a hint about a masking/interrupts); For example, the use of terms like trailing, lagging and/or windowing may be used to describe the nature of the report and to illustrate that the report is not necessarily immediately available. In this case the report may be provided some time after the occurrence of the events whose results are reported—hence the terms like trailing and/or lagging are used. Windowing explains that observations may be made during a certain time interval or window;
calibrated/authorized/verified/certified/type approved; since other (network) devices (e.g., victims) may be given the opportunity to report the performance of other (network) devices (e.g., aggressor) such that the other devices may have to change their operation, it may be of advantage to assess the quality or value or authority of such reports. To this end, reporting devices may, in order of increasing credibility, comprise:
   the device may be calibrated (e.g., in the factory)
   the device may be authorized (e.g., by the network)
   the device may be verified (e.g., by some other entity, such as inside or outside of the network)
   the device may be certified (e.g., by a test house or other trusted entities)
   the device may be type approved (e.g., by a fully traceable measurement authority)

The device 40 may be configured for reporting about the reception directly to the device 45, e.g., when being operated in a network or part thereof by a same operator or integral network infrastructure. Alternatively, the device may report to a different entity such as to a node of its own wireless communication network, e.g., a coordinating node, a base station or a different device to piggyback its information. This information may then be forwarded to the device 45 in an intra-network manner or an inter-network manner. Thus, the device 45 may be a member of the wireless communication network in which the device 40 operates but may also be not a member of the wireless communication network. In both cases, the reporting to the device 45 may be implemented indirectly by report to an entity of the wireless network to forward the report 32 and/or to an entity of a further network in which the device 45 is a member. The report may allow to trigger counter measures by the device 45, e.g., as described in connection with the device 30. That is, a communication may include a communication path victim→network of the victim→network of the aggressor→aggressor.

Example wireless communication networks to communicate with each other, e.g., the device 40 and the device 45 being operated in different wireless communication networks may include one of:
geographically co-located networks of a same or different Mobile Network Operator (MNO) including fixed wireless access (FWA) networks, private networks, integrated access and backhaul (IAB) networks, e.g., in half-duplex or full-duplex;
non-terrestrial network to terrestrial network;
maritime network to terrestrial network;
maritime network to non-terrestrial network; and
any possible combination thereof.

Pattern Assessment and Verification

An aspect of the embodiments described herein is to assess the antenna pattern characteristics of devices deployed in the field using other deployed devices. For example, user equipment devices can be arranged in such a manner that they provide reports of the signals they receive on the beams created for reception purposes even if those beams are not used directly for communication. By extension of this example, a UE could be appropriately configured to observe the characteristics of other networked devices. Similarly, basestations could also be suitably arranged so as to observe or assess the antenna-related performance of other network devices. An important aspect of this part of the embodiments described herein is that any device in the network could be organized to provide such functionality, examples of which can be taken from the list
Observation methods
Observation parameters
Method of observation
Interval of observation
Prioritization of observation

Feedback Path or Control Channel

In order for pattern assessment and verification information to be transferred from one device to another, embodiments provide for a feedback channel or control channel. This channel, which may operate independently and even in isolation to the communication channel between devices, provides the means for inter-device reporting. This allows the needed information to be conveyed between devices even when those devices are not required to form a communication link. Indeed, it is the notion of (communication) connected devices causing interference to other devices (with which they are not connected) that led to the suggested interference reduction.
Type of information
Structure of the information
Method of connection
Feedback procedure

Networks according to embodiments may comprise at least one interfering device or aggressor, e.g., a device 30. The wireless communication network further comprises at least one interfered device, e.g., a victim, e.g., device 40. For example, the device 26₁ and/or 26₂ being implemented as device 40 may lead to the wires communication network 300 being such a network.

The interfering device may be configured for addressing the interference in a link between at least one of:
a base station and a user equipment;
a base station and a backhaul entity;
a base station and a relay entity;
a first relay entity and a second relay entity;
a relay entity and a further infrastructure;
a first base station and a second base station;
a first UE and a second UE;
a UE and a further infrastructure and
a UE and a relay entity.

According to an embodiment, the interfering device may be configured for addressing the interference affecting a link operated between a device communicating with the interfered device and the interfered device communicating with a communication partner. That is, the aggressor may address the interference it causes to the communication maintained by the victim. That is, the communication to a transmitter and/or receiver/transceiver talking to the victim may be considered. The victim may receive a message from its communication partner. The aggressor may address the interference by at least one of:
applying interference mitigation/avoidance measure, e.g., using an appropriate antenna radiation pattern that allows for a low amount of interference;
always or in a coordinated synchronized manner or at least when the victim is scheduled to receive information from its communication partner, the aggressor may adapt its own communication; and/or
allowing the victim to successfully listen to control channels of the communication partner, e.g., provisions of grants for future messages to and/or from the victim or aggressor.

As described, an aggressor device in accordance with embodiments, e.g., device 30 may be configured for transmitting a signal with the antenna radiation pattern and/or may receive a signal with the antenna radiation pattern. That is, the embodiments described herein relate to both, a transmit case and a reception case, wherein both cases may be combined with each other.

Although embodiments relate to various scenarios, there may be two interference scenarios to be considered in connection with a co-channel interference and/or an adjacent channel interference. Embodiments consider a near/far effect meaning that the own communication partner is far away and the effective pathloss is high resulting in a low SNR on the desired link. At the same time, the interferer is near resulting in a level of received in a level of received interference at the RX antenna (before the RC beam former) causing the AGC to respond to both signals (desired and interferer) or to be dominated by a power level from the interferer, thereby effectively de-sensing the receiver. Although referring to a near and a far distance, such a scenario may be independent from a physical distance but may relate to the transmission power used. A solution for this scenario is to reduce the transmitted power/energy from the interferer towards the receiver/victim antenna, e.g., by requesting or instructing the aggressor to do so.

Another scenario is that the SIR is equal or lower than the targeted SINR of the desired link (at the chosen MCS level). A solution is a reduction of the interference level which allows an improvement of the SINR such that the link capacity may be improved.

If such scenarios are aggregated, i.e., interferences coming from multiple sources, and a value below the targeted SINR level of the desired link is obtained after the receive beamforming and/or signal processing methods, interference control may be omitted.

A further point pertaining to the embodiments disclosed herein—interference reduction through antenna pattern adaption—is applicable to numerous network device links including the following:
Basestation to user equipment
Basestation to backhaul
Basestation to basestation (relaying/repeating—both regenerative and non-regenerative)
Basestation to other infrastructure
User equipment to other infrastructure
User equipment to user equipment (cross-link)

In many applications, the level of the sidelobes and the direction in which they point could be changed on a sidelobe-by-sidelobe basis. That is, providing that there are means to allow it, each sidelobe may be controlled separately or individually. Devices in accordance with embodiments may be configured for a respective sidelobe-by-sidelobe control.

It should be noted however, that any adaption of the antenna pattern will not only affect the sidelobes, but the main lobe too. This means that pattern adaption is likely to reduce the gain of the antenna and hence affect the range of the communication link. An engineering trade-off between the aforementioned antenna and system characteristics is thus needed.

Embodiments relate to a reduction of interference at devices which are not part of the communication causing the interference. This may, under some circumstances, also relate to a sidelink interference. Embodiments are related to reporting about interference and to control the antenna radiation pattern.

Examples of Controllable Characteristics
Applicable to both transmission and reception
Examples of interference include co-channel and adjacent channel
Antenna pattern control→level and direction of: beams; sidelobes; and nulls.
Selection of: polarizations; antenna ports; sub-arrays; and panels

CPE1 (the interference observing network device (IOND)) or victim is observing over a specified time window (define size)

Link affecting interference (e.g. DL from its BTS or side link from another UE relay)
Interference examples
   Multi-access interference (2UEs to same BS)
   DL inter-BS interference (2BSs to one UE)
   Inter-UE interference/Inter-BTS interference (caused by different TDD timing between networks)
   Inter-relay interference in multi-hop networks

Interference Observing Network Device

A device (victim) in the network which by receiving radio signals from surrounding network devices can determine link quality impact on its own existing/repeated/to be established active radio communication link between a transmitter and its receiver.

IOND is monitoring/capturing interference source parameters (e.g., direction, timing, frequency, polarization, physical PRBS, BWPs) associated with receive beams. An IOND may assess the interference impact of other network devices to be (potentially) used for interference management.

Observation Assisting Information and Procedures
Provided by the network or other network elements describing or allowing identification of interference sources
   Cell IDs, beam characteristics/identification, localization, geolocation, power class, SRS, SSB, CSI RS, BWP, blanking/puncturing pattern(s)
Activation of beam sweeping or of specific beams or blanking/puncturing patterns

Quantifying and Qualifying Interference Impact (On Victim from Aggressor)
SINR degradation, SIR level, interference level, HARQ ACK/NACK
SIN R/SIR level analysis per
   (HARQ) retransmission packet
   Receive beam/pattern

Quantifying and Qualifying Interference Source
Parameterization of potential aggressor characteristics
   Time slot, resource grid, assigned channel, BWP
   SRS, SSB, CSI RS
   Direction (polarization?)

Examples of Parameters to be Reported by the Victim or IOND/MLRD
Method of reporting
   Full set, sub-set, compressed/reduced set, incremental, differential, event-based, ordered list, trigger/threshold based, requested, timed, synchronized, queued, trailing/lagging/windowing (last X minutes)—hint about masking/interrupts
   Calibrated/authorized/verified/certified/“type approved”

Interference Mitigation and Negotiation Procedures (Between Devices)
Intra-network operation
   From victim to aggressor
   From network to aggressor
   From victim via network to aggressor
Inter-network operation
   Examples include:
      Geographically co-located MNOs (including FWA networks), private networks, IAB networks (full duplex)
      Non-terrestrial network to terrestrial network
   From victim via network to another network that hosts the aggressor

Interference Mitigation Actions (At Aggressor)
Purpose—to stabilize the link controlling the aggressor
Renegotiation between devices forming a link in which the aggressor is one part of that link specifically by adapting the antenna pattern of the transmitting devices and perhaps that of the receiving device.
Pattern restriction in direction/coverage/illumination (drones over BTSs, vehicles in tunnels)
Goal or target based actions (e.g. reduce power affecting the victim, reschedule, coordinate beams of selected transmit antenna pattern)
Command based actions (e.g. use beam X when condition Y, or do not use beam P when condition Q)
Selective code book entries or beam indices

Embodiments are described herein in view of specific actions that are undertaken by an interfered device and/or an interfering device. Such actions may be autonomously determined. Some embodiments relate to feedback channel or other communication means which offer the opportunity to inform other devices about specific actions being planned, executed or instructed, e.g., by a coordinating node that informs an interferer about information collected from multiple interfered devices. It furthermore allows to evaluate and learn from such data. Embodiments therefore relate to the field of machine-learning and artificial intelligence.

For example, electronic design automation (EDA) tools are used in the design flow of, for example, electronic components, integrated circuits, printed circuit boards, connectors, cables, modules and systems. EDA tools provide the means to design, simulate, analyse and verify designs with a high degree of accuracy that often leads directly to manufacturing preparation. Simulations can be limited to one physical field—for example electricity, electromagnetics, thermo-mechanics—or in the case of so-called Multiphysics, a simultaneous combination of multiple physical fields. This allows complex simulation systems and environments to be developed in which a phased array antenna system, comprised of electromagnetic field solvers and circuit-level solvers, can be developed.

Given the availability of high-performance EDA software and the affordability of high-performance computing facilities it is possible to construct accurate, precise and reliable models of real-world systems that combine hardware devices and software algorithms. A complete phased array antenna system controlled by codebooks and adaptive algorithms can thus be modelled using EDA tools and its performance can be assessed under various conditions including, for example: operation scenarios; component variation; environmental circumstances; and various use cases. In simplistic terms, each input control variable of the simulation translates to a dimension of the result space or, alternatively, the number dimension of the result space is proportional to the number of inputs. The challenge of such simulations is the interpretation of the results produced. To this end, machine learning techniques and artificial intelligence come to hand.

For example, extensive multi-parameter computer simulations of a phased array antenna system may provide a plethora of simulation results. This training data may be used by the appropriate machine learning techniques—for example unsupervised learning, active learning, reinforcement learning, self-learning, feature learning, sparse dictionary learning, meta learning, federated learning, anomaly detection or association rules—to determine suitable rules that describe a means to represent the relationship between given inputs and wanted outputs without being explicitly programmed. That is, a device such as an aggressor, may perform deep-learning or may implement artificial intelligence to derive or determine information relating to an effectivity of its action may. For example, information about interference it causes (e.g., received reports) may be combined, correlated or associated with information about action it undertakes and with effects achieved thereby (e.g., subsequent reports after having adapted the antenna radiation pattern subsequent to the report).

Deep-learning (including artificial intelligence) may be implemented in more than a single way. For example:
Results of the deep-learning may be obtained as a result of simulations completed during the development and design of the system, e.g., alone and thus without further learning;
Deep-learning may be performed so as to combine the described results of simulations with real-word/in-the-field usage experiences (data collected during usage or operation) in order to further improve the system (through additional learning).

That is, a method for calibrating a device capable of forming an antenna radiation pattern according to an embodiment comprises performing a deep-learning process to evaluate a relationship between a control for forming the antenna radiation pattern and/or a control of sidelobes thereof (target value) on the one hand and information related to the antenna radiation pattern generated de facto (actual value/true value) on the other hand.

Optionally, the obtained information may be updated, e.g., based on further deep-learning, based on the operation of the device.

In addition to the above, the device may be equipped with the means to accept and implement updated look-up-tables (LUTs) that are provided to the device after it is deployed (similar to a software/firmware update). Such updates may be managed and/or distributed by the network through various methods (manually, automatically, scheduled, requested).

Alternatively or in addition, the device (together with the network and other (network/networked devices) may comprise or at least have access to means of providing suitable data in order that deep-learning can be performed outside of the device and/or outside of the network. In effect, other resources are tasked with learning duties thus removing this burden from devices and the network.

The device may be configured for updating, i.e., amending or modifying, a lookup-up table having stored thereon a beam-pattern based on results of the deep-learning or machine learning. Alternatively or in addition, algorithms used by the device may be adapted. Alternatively or in addition to the aggressor the network, i.e., any entity or a distributed entity such as a network controller or coordinating node may be configured for performing a machine-learning, e.g., using artificial intelligence to consider, evaluate or learn from an effect of controlling the sidelobes on the antenna radiation pattern and to adapt the control of the sidelobes based on the machine-learning.

A level of refinement of a system model obtained thereby, the fidelity of the simulation, the number of swept variables and/or their range and resolution are all design parameters that may affect the accuracy and precision of the simulation results. Again, machine learning techniques may assist one skilled in the art to select these parameters appropriately and thus balance the trade-off between simulation time and performance.

In an example practical realization, the combination of a needed set of inputs and an appropriate look-up table may enable the needed beamforming vectors to be selected quickly and reliably, thus responding dynamically to changes in operational and environmental conditions without the need for time-consuming and iterative adaptions of the phased array excitation.

Embodiments described above related to aggressors generating interference and victims suffering from such interference, wherein the victim possibly but not necessarily maintains a channel or link with the aggressor or its network. As was described, the victim may be part of the same or a different network or cell when compared to the aggressor.

To determine the interference and/or characteristics thereof, the victim may operate as an interference observing network device, IOND. However, according to embodiments, additional sources of information may be used to obtain knowledge about the interference. Such devices are described in the following and are referred to as Measuring, Logging and Reporting Devices, MLRD. Such devices may be used to observe the behaviour or condition of the network or a part thereof, e.g., in view of interference generated and may provide for such information to other devices. This may allow to provide an aggressor with information about an impact of its behaviour and/or a (potential) victim about information about present or future, expected/possible interference, e.g., a source thereof and/or locations that are suspected to provide a high or low amount of interference. In connection with such an implementation, interference, in particular cross-link interference may be examined in view of a single source of interference but also in view of a set of sources providing for a combined level of interference for a possible victim.

Some embodiments of aspects relating to handling interference between an interferer or aggressor and an interfered device or victim may be expressed by the following formulations:
Embodiment 1. A device configured for operating in a wireless communication network, wherein the device is configured for forming an antenna radiation pattern for communicating with a communication partner;
   wherein the antenna radiation pattern comprises a main lobe, at least one side lobe and a null between the main lobe and the side lobe;
   wherein the device is configured for controlling the main lobe towards a path to the communication partner; and to control the side lobe and/or the null to address interference at the location of a further device.
Embodiment 2. The device of embodiment 1, wherein the device is configured for transmitting a signal with the antenna radiation pattern or is configured for receiving a signal with the antenna radiation pattern.
Embodiment 3. The device of embodiment 1 or 2, wherein the device is configured for controlling the side lobes by controlling at least one of
   a direction of the side lobes and/or of the main lobe thereby affecting the direction of the side lobes;
   a level of power transfer between the device and the further device by way of the side lobes and/or by use of the main lobe thereby affecting the level of power transfer at the side lobes to the location of the further device;
   a polarization of the side lobes and/or of the main lobe;
   a selection of an antenna port used for forming the antenna radiation pattern, of a sub-array of an antenna array used for forming the antenna radiation pattern and/or of at least one antenna panel used for forming the antenna radiation pattern.
Embodiment 4. The device of one of previous embodiments, wherein the device is configured for controlling the side lobes by implementing at least one:
   a phase shift of a signal and between antennas of an antenna array configured for forming the antenna radiation pattern;
   a change of a frequency of the signal and between antennas of the antenna array;
   a lengthening or shortening of a transmission line section of a feeding network of the antenna array;
   a change of a permittivity between the antennas of the antenna array;
   a change of a permeability between the antennas of the antenna array; and
   using a power taper for the antenna array.
Embodiment 5. The device of one of previous embodiments, wherein the device is configured for controlling the side lobes by implementing a phase shift of a signal and between antennas of an antenna array configured for forming the antenna radiation pattern by changing a permittivity between the antennas of the antenna array.
Embodiment 6. The device of one of previous embodiments, wherein the device is configured for controlling the side lobes by implementing a phase shift of a signal and between antennas of an antenna array configured for forming the antenna radiation pattern by changing a permeability between the antennas of the antenna array.
Embodiment 7. The device of one of the previous embodiments, wherein the device is configured, to address the interference, to control the side lobe in view of a level of power transmission between the device and the further device along at least one path between the device and the further device in a radio propagation environment.
Embodiment 8. The device of embodiment 7, wherein the communication partner is located as a far device, wherein the further device is located as a near device.
Embodiment 9. The device of one of previous embodiments, wherein the Signal to Interference Ratio (SIR) is at most a targeted Signal to Interference plus Noise Ratio (SINR) of the link, wherein the device is configured for reducing the interference level to improve the SINR to improve a link capacity between the device and the communication partner.
Embodiment 10. The device of one of the previous embodiments, being configured, to address the interference, to control a direction of the sidelobe and/or a direction of a null of the antenna radiation pattern.
Embodiment 11. The device of one of the previous embodiments, wherein the device is configured for selecting the antenna radiation pattern from a plurality of possible antenna radiation patterns, for generating the antenna radiation pattern and to adapt the generated radiation pattern to reduce the interference between the device and the further device when compared to the selected antenna radiation pattern; or
   selecting the antenna radiation pattern from a plurality of possible antenna radiation patterns so as to lead to an interference below a predefined interference threshold between the device and the further device; or to a minimum interference between the device and the further device whilst providing for an energy transmission above a predefined transmission threshold between the device and the communication partner or a maximum energy transmission between the device and the communication partner.
Embodiment 12. The device of one of the previous embodiments, wherein the device is configured for controlling the sidelobes and/or the antenna radiation pattern based on a codebook and/or based on an adaptive antenna array; wherein the codebook is comprises at least one of a Type I single-panel codebook; a Type I multi-panel codebook; a Type II single-panel codebook; and a Type II multi-panel codebook or a different codebook.
Embodiment 13. The device of one of the previous embodiments, wherein the interference addressed comprises a co-channel interference and/or an adjacent channel interference.
Embodiment 14. The device of one of the previous embodiments, wherein the device is configured for obtaining knowledge about a location of the further device and/or about at least one direction of a relevant multipath component (MPC) between the device and the further device and for controlling the side lobe to comprise a low amount of power transfer between the device and the location or along the at least one direction so as to address interference.
Embodiment 15. The device of one of the previous embodiments, wherein the device is configured for obtaining knowledge about a request to reduce interference at the location of the further device based on a report of the further device or based on instructions received from the wireless communication network.
Embodiment 16. The device of one of the previous embodiments, wherein the device is configured for receiving directly or indirectly a reporting about a measure of interference
Embodiment 17. The device of one of previous embodiments, wherein the report is based on a reception of wireless energy transmitted by the device; and/or predictive based on a location or movement of the device.
Embodiment 18. The device of one of the previous embodiments, wherein the device is configured for controlling a plurality of side lobes of the antenna radiation pattern so as to address interference at a plurality of locations.
Embodiment 19. The device of one of the previous embodiments, wherein the device is configured, for addressing the interference to the further device and another device, for controlling at least a first and a second sidelobe of the antenna radiation pattern based on a sidelobe-by-sidelobe assessment.
Embodiment 20. The device of one of the previous embodiments, wherein the device comprises an antenna arrangement and is configured for performing beamforming with the antenna arrangement.
Embodiment 21. The device of one of the previous embodiments, wherein the device is configured for receiving, from the further device, a signal indicating an exchange of energy or an observation of received power between the device and the further device.
Embodiment 22. The device of one of the previous embodiments, wherein the device is configured for performing a beemsweeping procedure to address the interference in which the antenna radiation pattern is at least in parts moved in space.
Embodiment 23. The device of one of the previous embodiments, wherein the device is configured for implementing a blanking/puncturing/power boosting pattern to the antenna radiation pattern by which punctured/blanked/power boosted resources of the antenna radiation pattern are made specifically observable at the location of the further device via a multipath propagation environment at least partially to address the interference.
Embodiment 24. The device of embodiment 23, wherein the blanking/puncturing/power boosting pattern is associated with an identity of the device.
Embodiment 25. The device of one of the previous embodiments, wherein the further device is not a member of the wireless communication network.
Embodiment 26. The device of one of the previous embodiments, wherein the device performs, responsive to having acquired information about a request to reduce interference at the location of the further device at least one of:
   a renegotiation between devices forming a link in which the device is one part of that link, by adapting the antenna pattern of the transmitting devices and/or that of the receiving device;
   a pattern restriction of the antenna radiation characteristic in direction/coverage/illumination, e.g., when the device is a drone flying over a base transceiver station (BTS) or when the device is a vehicle in a tunnel or when the device is a possibly low-earth orbiting satellite that communicates with a terrestrial device as communication partner or vice versa;
   a goal-based or target-based action, e.g. to reduce power affecting the further device, reschedule and/or coordinate beams of selected transmit antenna pattern;
   a command-based action, e.g. to use beam X when condition Y, or do not use beam P when condition Q;
   to use selective code book entries or beam indices.
Embodiment 27. The device of one of the previous embodiments, wherein the device is a base station configured for operating a cell of the wireless communication network or a UE operating in the cell.
Embodiment 28. The device of embodiment 19 or 20, wherein the device is configured for receiving the report from the further device as a device of the wireless network in which the device operates.
Embodiment 29. The device of one of previous embodiments, wherein the device is configured for performing a machine-learning to consider an effect of controlling the sidelobes on the antenna radiation pattern; and to adapt the control of the sidelobes based on the machine-learning.
Embodiment 30. A device configured for operating in a wireless communication network, wherein the device is configured for communicating with a communication partner;
   wherein the device is configured for determining a measure of interference associated with a further device not communicating with the device and for reporting, to the further device or a member of its communication network about the reception of interference from the further device.
Embodiment 31. The device of embodiment 25, wherein the device is configured for forming an antenna radiation pattern.
Embodiment 32. The device of embodiment 30 or 31, wherein the device is configured for determining the measure of interference based on a reception of wireless energy transmitted by the further device; and/or predictive based on a location or movement of at least one of the further device, a communication partner of the further device and the device.
Embodiment 33. The device of one of embodiments 30 to 32, wherein the device is configured for determining at least a part of an antenna radiation characteristic of the further device and for reporting about the measure of interference so as to report about the at least part of the antenna radiation characteristic.
Embodiment 34. The device of one of embodiments 30 to 33, wherein the device is configured for reporting to the further device about the reception via a feedback channel or a control channel of the same or a different network.
Embodiment 35. The device of one of embodiments 30 to 34, wherein the device is configured for reporting to the further device about the reception based on at least one of
   a Cell Identification (ID) of a cell of a wireless network;
   a beam characteristic/identification;
   a localization or geolocation;
   a power class;
   a sounding reference symbol (SRS);
   a synchronization signal block (SSB);
   a channel state information reference signal (CSI RS);
   a bandwidth part (BWP);
   a blanking/puncturing/boosting pattern; and
   RS and/or data transmitted from interfering source to be used as pseudo RS.
Embodiment 36. The device of one of embodiments 30 to 35, wherein the device is configured for qualifying/quantifying/classifying/categorizing the reception of wireless energy transmitted by the further device based on at least one of:
   a signal-to-interference-plus-noise ratio (SINR) degradation;
   a signal-to-interference (SIR) ratio;
   an interference level;
   a hybrid automatic repeat request (HARQ) acknowledgement (ACK) or negative ACK (NACK);
   an SINR/SIR level analysis, e.g., per (HARQ) retransmission packet or per receive beam pattern;
   an SIR/SINR margin with respect to a targeted SINR; and
   an SINR margin with adaptive beamforming considering reception (RX) nulling.
Embodiment 37. The device of one of embodiments 30 to 36, wherein the device is configured for quantifying and/or qualifying the further device as a source of interference based on at least one of:
   Parameterization of potential aggressor characteristics
   Time slot, resource grid, assigned channel, BWP
   SRS, SSB, CSI RS
   Direction
   Polarization
   Operating frequency, channel assignment
   Direction of transmission being uplink or downlink
   Observed blanking/puncturing/power boosting pattern
Embodiment 38. The device of one of embodiments 25 to 32, wherein the device is configured for reporting the reception based on at least one of:
   A full set, a sub-set, a compressed/reduced set of parameters; and
   an incremental, differential, event-based and/or an ordered list.
Embodiment 39. The device of one of embodiments 30 to 38, wherein the device is configured for reporting the reception based on at least one of:
   trigger/threshold based/event based;
   upon request;
   timed;
   synchronized;
   queued;
   trailing/lagging/windowing (last X minutes); and
   hint about masking/interrupts
   Calibrated/authorized/verified/certified/“type approved”.
Embodiment 40. The device of one of embodiments 30 to 39, wherein the device is configured for reporting about the reception directly to the further device or to the wireless communication network.
Embodiment 41. The device of one of embodiments 30 to 40, wherein the further device is not a member of the wireless communication network.
Embodiment 42. The device of embodiment 41, wherein the device is configured for reporting to the further device about the reception indirectly by reporting to an entity of the wireless network to forward the report and/or to an entity of a further network in which the further device is a member so as to trigger countermeasures.
Embodiment 43. The device of embodiment 42, wherein the wireless communication network and the further wireless communication network communicate with each other as one includes one of:
   geographically co-located networks of a same or different Mobile Network Operator (MNO) including fixed wireless access (FWA) networks, private networks, integrated access and backhaul (IAB) networks, e.g., in half-duplex or full-duplex;
   non-terrestrial network to terrestrial network
   maritime network to terrestrial network;
   maritime network to non-terrestrial networks; and
   any possible combination of the above.
Embodiment 44. A wireless communication network comprising:
   at least one interfering device according to one of embodiments 1 to 29 to cause interference; and
   at least one interfered device according to one of embodiments 30 to 40.
Embodiment 45. The network of embodiment 44, wherein the interfering device is configured for addressing the interference in a link between at least one of:
   a base station and a user equipment, UE;
   a base station and a backhaul entity;
   a base station and a relay entity;
   a first relay entity and a second relay entity;
   a relay entity and further infrastructure;
   a first base station and a second base station;
   a first UE and a second UE;
   a UE and a further infrastructure; and
   a UE and a relay entity.
Embodiment 46. The network of embodiment 44 or 45, wherein the interfering device is configured for addressing the interference affecting a link operated between a device communicating with the interfered device and the interfered device communicating with a communication partner by at least one of:
   applying interference mitigation/avoidance measure e.g. using of appropriate antenna radiation pattern;
   always or in a coordinated/synchronized manner at least when the victim is scheduled to receive information from its communication partner; and/or
   allowing the victim to successfully listen to control channels of the communication partner e.g. provision of grants for future messages to/from the victim.
Embodiment 47. The network of one of embodiments 44 to 46, wherein the network or an entity thereof is configured for performing a machine-learning to consider an effect of controlling the sidelobes on the antenna radiation pattern; and to adapt the control of the sidelobes based on the machine-learning.
Embodiment 48. Method for operating a device in a wireless communication network, the method comprising:
   forming an antenna radiation pattern for communicating with a communication partner, such that the antenna radiation pattern comprises a main lobe and, at least one side lobe and a null between the main lobe and the side lobe;
   controlling the main lobe towards a path to the communication partner;
   controlling the side lobe and/or the null to address interference at the location of a further device.
Embodiment 49. Method for operating a device in a wireless communication network, wherein the device is configured for communicating with a communication partner, the method comprising:
   determining a measure of interference associated with a further device not communicating with the device;
   reporting, to the further device or a member of its communication network about the reception of power or interference from the further device.
Embodiment 50. Method for calibrating a device capable of forming an antenna radiation pattern, the method comprising:
   performing a deep-learning process to evaluate a relationship between a control for forming the antenna radiation pattern and/or a control of sidelobes thereof on the one hand and information related to the antenna radiation pattern generated de facto; and
   storing information obtained based on the deep-learning in a non-volatile data storage of an entity wireless communication network or of the device.
Embodiment 51. The method of embodiment 50, further comprising:
   updating the stored information based on an operation of the device.
Embodiment 52. A computer readable digital storage medium having stored thereon a computer program having a program code for performing, when running on a computer, a method according to embodiment 48 to 51.

Such aspects, e.g., relating to aggressors and/or victims may be incorporated into embodiments of the present invention. For example, for the solutions provided below, the actions of an aggressor may be incorporated there, without limitation. Alternatively or in addition, an aggressor may obtain its information when operating, at least in parts, as MLRD described below and/or by receiving signals from such a device.

Alternatively or in addition, actions of an victim may be incorporated there, without limitation. Alternatively or in addition, a victim may obtain its information when operating, at least in parts, as MLRD described below and/or by receiving signals from such a device.

### Measuring and/or Reporting Devices

In the following, aspects of the present invention are described in view of devices for measuring and reporting, possibly logging radio link parameters associated with an operation of a wireless communication network or system. Such a device may be referred to as measuring, logging and reporting device, MLRD, wherein especially the logging is not to be considered as obligatory.

As a background, Wireless communication links are used to connect the entities that comprise a wireless network. Although these links can, by definition, be unidirectional, they are typically bidirectional. Due to a variety of physical effects, these links are prone to varying levels of service quality.

It is known that wireless links are prone to varying levels of connection quality and that the reasons for such variations are numerous and include: small- and large-scale fading; blockage; interference; the effects of background noise; a loss of time, frequency and phase synchronization.

It is also known that in a communication link comprised of uplink and downlink directions, for example, from a user equipment (UE) to a basestation transceiver (BTS) and vice versa, respectively, the quality of service (QoS) is often direction dependent and can vary significantly over time. To provide and maintain links with the needed or demanded QoS, link adaptation mechanisms that employ various techniques including feedback or close-loop control mechanisms are often used. However, QoS is typically assessed at the receiving end of the link, an efficient and successful link needs adequate link performance in both link directions not least to ensure that the QoS information determined at the receiving end of the link is returned to the transmitting end of the link. Upon receipt of same, the transmitter can then make the needed adjustments in order to fulfil QoS requirements at the receiver. However, when the transmitter is not furnished with such information, it may incorrectly conclude that a link performance has degraded below a certain threshold or the connection has been broken even though its link with the receiver is adequate.

New services that need more stringent QoS parameters, for example high data rate; increased throughput; faster connection times; fewer lost packets, reduced packet delays; lower delay jitter, may degrade substantially at the service level if the end-to-end connectivity that comprises multiple wireless link elements cannot be guaranteed or maintained.

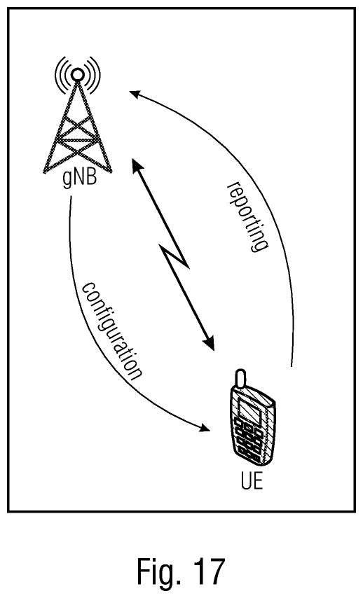

In July 2019, 3GPP published the study titled “Study on RAN—Centric Data Collection and Utilization for LTE and NR” [14] and agreed New Work Item on support of SON and MDT for NR. The study and work items are aimed at developing standardised data collection solutions that help operators deploy and optimise 5G networks and deal with the increase in complexity, support for different verticals and use cases, split architecture of gNBs and many other new features of 5G. 3GPP Minimization of drive test (MDT) has been standardised since Release 10, providing network operators with optimisation tools in a cost-efficient manner. MDT supports two different modes: immediate and logged. Logged MDT is the procedure whereby the UE performs logging of measurement results and subsequently reports the logged measurement results. This is shown in FIG. 17 in which a basestation (labelled as “gNB”) sends a set or sequence of configuration instructions or commands to a specific device in the network (labelled “UE”). According to the configuration sent by the basestation, the device subsequently performs, records and reports certain measurements back to the basestation. It should be noted that in the current SOTA MDT, the network via the serving basestation is configuring a single given device. It should be further noted that whereas the process of configuration is performed when the two network entities (e.g. “gNB” and “UE”) are in the RRC_CONNECTED state, the “UE” measures and logs when it is in either the RRC_INACTIVE or RRC_IDLE state and reports once it is again in the RRC_CONNECTED state.

In FIG. 17 an example of a known minimization of drive tests is shown in which a basestation sends configuration commands to a UE which subsequently performs, records and report certain measurements.

Immediate MDT refers to the measurements performed by the UE in CONNECTED state and reporting of the measurements is available at the time of reporting. For immediate MDT, the following measurements, marked by M, are supported according to [15].
M1: DL signal quantities measurement results for the serving cell and for intra-frequency/Inter-frequency/inter-RAT neighbour cells, including cell/beam level measurement for NR cells only [16]
M2: Power Headroom measurement by UE [17]
M3: Received Interference Power measurement
M4: Data Volume measurement separately for DL and UL, per DRB per UE [18]
M5: Average UE throughout measurement separately for DL and UL, per DRB per UE and per UE for the DL, per DRB per UE and per UE for the UL, by gNB [18]
M6: Packet Delay measurement separately for DL and UL, per DRB per UE [18] and [19]
M7: Packet loss rate measurement separately for DL and UL, per DRB per UE [18] and [19]
M8: RSSI measurement by UE (for WLAN/Bluetooth measurement) [20].
M9: RTT Measurement by UE (for WLAN measurement) [20].

Measurement collection triggers can be event-triggered (e.g. M1) or they can be the end of the measurement collection period (e.g. M3-M9) [15].

In addition, in case of a radio link failure (RLF), NR RLF report content needed for MDT includes:
Latest radio measurement results of the serving and neighbouring cells, including SSB/CSI-RS index and associated measurements in the serving and neighbouring cells;

The measure quantities are sorted through the same RS type depending on the availability, according to the following priority: RSRP, RSRQ, and SINR.
WLAN and Bluetooth measurement results, if were configured prior RLF and are available for reporting;
   “No suitable cell is found” flag when T311 expires;
   Indication per SSB/CSI-RS beams reporting whether it is configured to RLM purpose;
   Available sensor information;
   Available detailed location information;
RACH failure report (in case, the cause for RLF is random access problem or Beam Failure Recovery failure):
   Tried SSB index and number of Random Access Preambles transmitted for each tried SSB in chronological order of attempts;
      Contention detected as per RACH attempt;
   Indication whether the selected SSB is above or below the RSRP-Threshold SSB threshold, as per RACH attempt;
   TAC of the cell in which the UE performs the RA procedure;
   Frequency location related information of the RA resources used by the UE as per [TS 37.820].

For logged MDT, the network sends logged measurement configuration to the UE in connected mode, and then the UE collects measurements in RRC_IDLE/INACTIVE. Upon UE restarting the RRC connection, the UE firstly sends available indicator(s) to the network, and then the network can command the UE to send the measurements as indicated in [TR 37.816].

Logged MDT procedures deal with measurement configuration, measurement collection, reporting and context handling. Measurement configuration specifies periodic and event-based trigger (e.g. measurement quantity-based event L1, out-of-coverage detection trigger for logged MDT procedure for which logging interval is configurable and determines periodical logging of available data such as time stamp, location information) as well as logging duration. Optionally, the periodic measurement trigger is accompanied with a configuration of logging frequencies and cell IDs (i.e. PCI) for neighbour cell measurement. UE only need to log and report measurement results for the configured frequencies, if the results are available.

The logging configuration for event-based and periodic DL pilot strength logged measurements can be configured independently. Only one type of event can be configured to the UE.

When a logging area is configured, logged MDT measurements are performed as long as the UE is within this logging area. If a logging area is configured, logged MDT measurements are performed as long as the RPLMN is part of the MDT PLMN list. When the UE is not in the logging area or RPLMN is not part of the MDT PLMN list, the logging is suspended, i.e. the logged measurement configuration and the log are kept but measurement results are not logged.

For downlink pilot strength measurements, the logged measurement report consists of measurement results for the serving cell (the measurement quantity), available UE measurements performed in idle or inactive for intra-frequency/inter-frequency/inter-RAT, time stamp and location information.

In NR, in addition to the logged measurement quantities of the camped cell, the best beam index (SSB Index) as well as best beam RSRP/RSRQ is logged as well as the ‘number of good beams’ associated to the cells within the R value range (which is configured by network for cell reselection) of the highest ranked cell as part of the beam level measurements. Sensor measurements are logged if available.

For WLAN and Bluetooth measurement logging, the logged measurement reports consist of WLAN and Bluetooth measurement results, respectively.

The number of neighbouring cells to be logged is limited by a fixed upper limit per frequency for each category below. The UE should log the measurement results for the neighbouring cells, if available, up to (examples):
6 for intra-frequency neighbouring cells;
3 for inter-frequency neighbouring cells;
3 for NR (if non-serving) neighbouring cells;
32 for WLAN APs;
32 for Bluetooth Beacons.

For NR, EUTRA, WLAN and Bluetooth, the measurement reports for neighbour cells consist of:
Physical cell identity of the logged cell;
Carrier frequency;
RSRP and RSRQ for EUTRA and NR;
RSSI and RTT for WLAN APs;
RSSI for Bluetooth Beacons.

For each MDT measurement the UE includes a relative time stamp. The base unit for time information in the Logged MDT reports is the second. In the log, the time stamp indicates the point in time when periodic logging timer expires. The time stamp is counted in seconds from the moment the logged measurement configuration is received at the UE, relative to the absolute time stamp received within the configuration. The absolute time stamp is the current network time at the point when Logged MDT is configured to the UE.

Location information is based on available location information in the UE. Thus, the Logged MDT measurements are tagged by the UE with location data in the following manner:
ECGI, Cell-Id or NCGI of the serving cell when the measurement was taken is included in E-UTRAN, UTRAN or NR respectively;
Detailed location information (e.g. GNSS location information) is included if available in the UE when the measurement was taken. If detailed location information is available the reporting shall consist of latitude and longitude. Depending on availability, altitude, uncertainty and confidence may be also additionally included. UE tags available detailed location information only once with upcoming measurement sample, and then the detailed location information is discarded, i.e. the validity of detailed location information is implicitly assumed to be one logging interval;
For NR, sensor information (i.e. uncompensated barometric pressure measurement, UE speed and UE orientation) can be included, if available in the UE when the measurement was taken.

The neighbour cell measurement information that is provided by the UE may be used to determine the UE location (RF fingerprint).

Depending on location information availability, measurement log/report consists of:
time information, RF measurements, RF fingerprints; or
time information, RF measurements, detailed location information (e.g. GNSS location information);
time information, RF measurements, detailed location information, sensor information.

In addition to MDT, the SON Study Item TR 37.816 identifies specific areas that will be target for developing new features that will further help operators, targeting:
Capacity and Coverage Optimization
PCI Selection
Mobility Optimization
Load Sharing and Load Balancing Optimization
RACH Optimization
Energy Saving

Thus, there is a need for a high reliability of wireless communication.

It is, thus, an object of these aspects of the present invention to provide for a reliable communication.

A first recognition of the present invention is that in a scenario allowing for bidirectional communication, the device measures a radio link parameter and that by generating a measurement report from the obtained results, and by transmitting the measurement report to an entity of the wireless communication network, the wireless communication network may be provided with a detailed knowledge about the influences occurring on the wireless communication, thereby allowing to determine root causes that degrade communication. Thereby, a high reliability of the wireless communication may be obtained.

According to an embodiment of the first recognition, a device configured for operating in a bidirectional wireless communication network in a first operating mode in which the device is in a connected mode during a first time interval and in a second operating mode, in which the device at most performs passive communication during a second, different time interval, is implemented such that, in the first operating mode, the device is configured for obtaining a set of measurement results comprising at least one measurement result by measuring or determining a radio link parameter of the wireless communication network. The device is configured for generating a measurement report comprising a set of results having at least one measurement result of the set of measurement results and for transmitting the measurement report to an entity of the wireless communication network. This allows to obtain measurement results that are obtained while the device is in the connected mode and, thus, possibly during a communication/transmission performed with the device.

A second recognition of the present invention is that a log or a stored number of measurement results is helpful for evaluating the wireless communication network for a link that is operated by the device itself and/or by generating the measurement report so as to comprise information about at least one instance of a measurement result being obtained prior to a link degrading event causing degrading of the wireless link, wherein the measurement report is transmitting after the link degrading event. That is, the radio link parameter is related to an own link of the device and/or refers to a time prior to a link degrading event or has been permitted thereafter. A link degrading event may be any event that causes a degrading of a link quality and/or even a link failure. This event may be related to the radio link itself, e.g., a device moving out of coverage or being temporarily blocked, or running out of battery or the like but may also have external effects, e.g., a storm that dislocates and/or destroys antennas, added buildings or the like.

According to an embodiment, in accordance with the second recognition, a device configured for operating in a bidirectional wireless communication network in at least a first operating mode in which the device is in a connected mode is configured, in the first operating mode, for transmitting and/or receiving wireless signals and for obtaining a plurality of measurement results, obtaining a measurement result comprising measuring or determining a radio link parameter associated with an operation of the wireless communication network. The device is configured for generating a log so as to comprise information derived from the plurality of measurement results and time information associated with the plurality of measurement results. The device is configured for generating a measurement report from the log and for transmitting the measurement report to at least one entity of the wireless communication network. The radio link parameter is associated with a link operated by the device and/or the device is configured for generating the measurement report so as to comprise information about at least one instance of the measurement result being obtained prior to a link degrading event causing degrading of the wireless link and for transmitting the measurement report to the entity of the wireless communication network after the link degrading event. This allows the device to monitor its own link and/or to report measurement results that may allow or support the network to determine information about the link degrading event retrospectively, thereby providing for information that may be used for a learning process for future events.

Further embodiments relate to a device that configures, instructs or requests devices for performing measurements which allows to generate and obtain the measurement results on demand.

Further embodiments relate to a wireless communication network, to methods for operating an apparatus described herein and to a computer program product.

Further embodiments are defined in the depending claims.

Embodiments of the present invention will be described in the following, whist making reference to the accompanying figures, in which:

The following embodiments relate to measuring or determining details of a wireless communication network. Some of those details may be referred to as a radio link parameter. The radio link parameter may be understood as a parameter relating or referring to the radio link. For example, the device in accordance with embodiments described herein may be configured for measuring or determining the radio link parameter as at least one of a within-link parameter, e.g., information related to a packet error rate, a throughput, an automatic repeat request count (ARQ) and/or a hybrid automatic repeat request count (HARQ). Alternatively or in addition, the device may be configured for measuring or determining the radio link parameter as an opposing-link parameter, e.g., information related to a cross-link interference (CLI), a signal-to-interference-noise ratio (SINR), an adjacent channel leakage ratio (ACLR) and/or a saturation. Alternatively or in addition, the device may be configured for measuring or determining the radio link parameter as a signal power, a signal quality such as a reference signal received power (RSRP), a reference signal received quality (RSRQ) or a signal-to-noise ratio (SNR). Alternatively or in addition, the device may be configured for measuring or determining the radio link parameter as an outside-of-the-link parameter, e.g., information indicating a signal power of a signal, e.g., as a function of frequency (including bandwidth), a time, a resource block, a beam, a cell identification, a direction information such as an angle of departure (AoD) and/or an angle of arrival (AoA), e.g., with respect to a particular TX beam and/or RX beam. That is, the radio link parameter may refer to a parameter of a link of which the device is a part, a different link and/or a parameter of a link that is deemed to not affect the device.

For example, the device may be configured for measuring or determining at least one of a PHY-layer parameter such as a bit error rate (BER), a block error rate (BLER), one or more modulation coding scheme levels (MCS levels), RSRP, RSRQ, SNR, SINR of a beam that is measured, for example, on a synchronization signal block (SSB), a channel state information (CSI)-reference signals (RS), a sounding reference signal (SRS) or the like, bam numbers on SSB, CSI-RS and/or SRS. Alternatively or in addition to the PHI-layer parameter, a higher layer parameter such as a number or ID of a serving or connected cell, information indicating cells observed by the device, a latency of communication, a jitter and/or a throughput of data may be measured as a radio link parameter. Alternatively, or in addition, as a radio link parameter may incorporate information suitable for optimising or assisting bidirectional communication in a way that supplementary information is provided, useful at either end of a link, i.e., the transmitter and/or the receiver. The radio link parameter may, for example, relate to receiver related signals or parameters such as the ones explained.

Alternatively, or in addition, the radio link parameter may relate to transmitter related signals or parameters. Whilst receiver related parameters may be obtained, for example, by measurements performed at a receiver, transmitter related parameters may be obtained by signalling, e.g., performed by the transmitter or an entity that has knowledge about the parameter used at the transmitter. Examples for such Transmitter/transmission related signals or parameters and configurations may be
Signals: e.g. embedded reference signals (RS), control signals, user plane signals, and/or other reference signals;
Transmission related signals may include but are not limited to:
   digital signals to go through digital transmit processing prior to being converted from digital into analogue signal domain;
   Digital or analogue control signals applied for beamforming, e.g. phase shifters, delay lines, attenuators and the like;
   Measured or captured signals, parameters from the transmitter chain, e.g. feedback signals for a digital pre-distortion (DPD), circuit/control of Self-interference-compensation (SIC) used for self- and/or adjacent channel interference cancelation/suppression or spurious emissions or out-of-band (OOB) radiation and/or adjacent channel leakage (ACLR) and the like.
Transmit parameters such as a Cell-ID, a carrier frequency, beamforming weights, antenna parameters or the like
Radio configuration parameters such as a minimum, maximum or actual number of retransmissions, one or more selected antenna panels, used or scheduled time and frequency resources, transmit scheduling information, transmission grants, uplink (UL)-downlink (DL) time and frequency relations, e.g., for closed loop control messages, CFO-pre-compensation (CFO: centre/carrier frequency offset)
a velocity, a geo-location, an orientation of the entity/device or antenna panel and/or even non-radio link parameters described below.

Whilst receiver related parameters or signals may be obtained by measuring, transmitter related parameters, signals or configurations may also be accessed or reported, i.e., a measurement itself is possibly not required. Some embodiments make reference to a measuring device and/or to measure a radio link parameter or other parameters. In view of reporting transmitter related signals, parameters and/or configurations, those embodiments directly relate to a determining device, to determining a radio link parameter, respectively.

Transmission related signals may be forwarded and stored, e.g., prior or during but also after the transmission process and/or separate or together with further information, parameters beneficial for post event analysis.

Beyond pure digital available data, parameters and settings, the transmission signal can be tapped, measured and logged at any stage of the transmission chain. The suitable measurement capability can be provided by a separate receiver/sensing apparatus or by using/sharing the embedded receive chain or some parts of it for signal detection, capturing and further processing including logging, analysing and/or reporting.

In view of the mentioned radio configuration parameters, and more particularly the UL/DL relations, such relations and/or relations between consecutively receive/transmitted signals may be measured/indicated/logged/reported/retransmitted, e.g., for a later post-event analysis or during the ongoing self-healing/optimization process before a critical event stage is entered.

The relation between UL-DL or between messages or settings within one direction (relative pointers/reference to messages, events, settings for unidirectional transmission/communication) and two directions (relative pointers/reference to messages, events, settings for bi-directional transmission/communication) may, alternatively or in addition, be part of such a relation to be analysed. A wireless communication system in accordance with embodiments may, thus, be configured for analysing the relation between messages or settings within one direction, e.g., relative pointers/reference to messages, events, settings for unidirectional transmission/communication) and/or two directions, e.g., relative pointers/reference to messages, events, settings for bi-directional transmission/communication.

Furthermore, such a cross-referencing can be extended with multi-hop communication protocols, where the cross-referencing may reach from one part of the concatenated links to another one. A wireless communication system in accordance with embodiments may, thus, be configured for analysing the relationship so as to comprise a cross-referencing between at least a first hop and a second hop of a multi-hop link

A wireless communication system in accordance with embodiments may, thus, analyse a radio communication link associated with the radio link parameter at a single end of the communication link; a first end and a second end of the communication link; and/or at least three ends of the communication link being a multi-hop link.

A wireless communication system in accordance with embodiments may, thus, be configured for analysing, e.g., after a link-degrading event and/or during a self-healing/optimization process before the link degrading event a relation referring to one or more of: an uplink (UL)-downlink (DL) relation; a relation between consecutively received signals; and a relation between consecutively transmitted signals.

Embodiments described herein relate to measuring, logging and/or reporting. Description provided in connection with described embodiments relates to MLRD standing for measuring, logging and reporting devices. In view of this, the logging is a possible implementation which is, however, not mandatory, in particular, when transmitting the measurements made directly or immediately. However, an implementation that, alternatively or in addition, allows for generating a log which serves as a basis for a measurement report is not precluded.

Embodiments provide for a link, a system and/or a network improvement which is achieved by allowing for accurate historical knowledge about the causes of the link degradation. Embodiments allow to make such knowledge available, accessible and obtainable. In known wireless networks, the data which would be needed to determine the cause of link degradation is neither available, accessible nor obtainable. Embodiments provide for mechanism and procedures through which parameters, events, commands and instructions are observed, recorded and reported. These observations or measurements and their logging and reporting can be made in one or both link directions and at one or both ends of a link. Furthermore, the link measurement, logging and reporting can be made before a link is established, during an active link connection and after a link has degraded to a certain threshold and/or when a connection is lost, such information providing for high advantages when reconstructing the reasons for degrading. The provision of such reports is made available to not only improve the quality of service of a given link but also to improve overall network performance.

As an example, a number of network devices or entities may be used to provide an end-to-end connection, wherein the quality of service between link elements may vary. The observation, logging and reporting of the inter-link service quality thus allows the root cause of the end-to-end performance degradation to be assessed. Devices can be suitably equipped to report or exchange information during a link or, following link failure, after a link is re-established. Such insights into potential root cause effects enable the inter-device performance and interaction to be improved in future connections. In addition, both coverage and capacity optimization (CCO) and energy saving improvements may be obtained. Thereby, the insufficiency of known concepts to enhance the performance of multi-beam communication network systems in 5G and beyond is addressed.

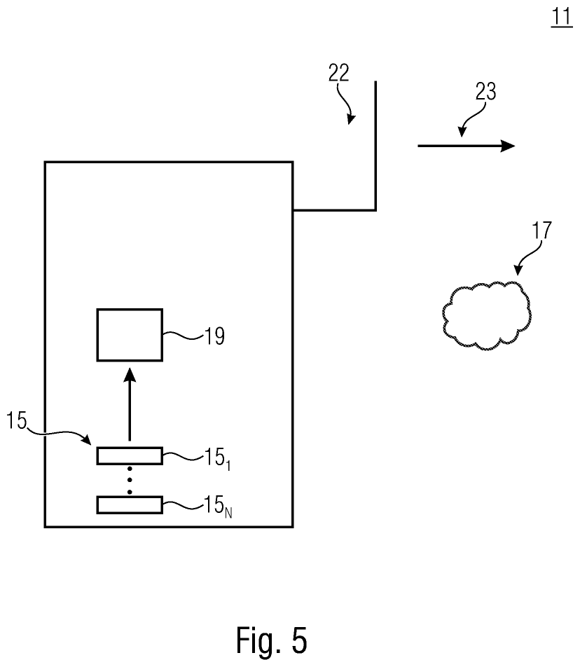

FIG. 5 shows a schematic block diagram of an apparatus 11 according to an embodiment. Apparatus 11 may be implemented, for example, in accordance with the first recognition of the present invention. Apparatus 11 is configured for operating in a bidirectional wireless communication network in a first operating mode during a first time interval and in a second operating mode during a second, different time interval. The second time interval may be prior or after the first time interval. In the first time interval, device 11 may be in a connected mode in which the device performance active communication. For example, such a mode may be referred to as RRC_CONNECTED (RRC=Radio Resource Control). In this operating mode, the device may be scheduled with resources of the wireless communication network which allows the device to transmit information, e.g., for transmitting a downlink signal if the device is implemented as a basestation or to transmit an uplink signal if the device is a participant of the network, a user equipment (UE) for example. In the first operating mode, the device is able to participate in a bidirectional communication. However, it is not necessary that the device being a UE transmits a signal or receives a signal, the device being a basestation or the like. That is, when compared to a broadcast or groupcast scenario in which a device is solely listening (receiver) or solely transmitting (transmitter) and the first operating mode allows for bidirectional communication.

In contrast to the first operating mode, in the second operating mode, the device may be implemented to perform, at most, passive communication, e.g., RRC_INACTIVE AND/OR RRC_IDLE MODE. In such a mode, the device may be part of the network but possibly does not perform active communication or transmit information.

In the first operating mode, the device is configured for obtaining a set 15 of measurement results 15ᵢ. For obtaining a measurement result, device 11 may measure a radio link parameter 17 of the wireless communication network. Measuring the radio link parameter 17 may incorporate a use of one or more sensors of the device 11 and/or an evaluation of wireless signals received and/or transmitted, for example, by use of the wireless interface or antenna arrangement 22.

The device is thus configured for obtaining the set 15 of measurement results in a connected mode. Device 11 is further configured for generating a measurement report 19, i.e., information comprising a set of results having at least one measurement result of the set 15 of measurement results. The measurement report 19 may contain, at least in parts, similar information when compared to the report 32. The device 11 is configured for transmitting the measurement report 19, e.g., using a wireless signal 23. The measurement report 19 may be transmitted to an entity of the wireless communication network.

Whilst the set 15 may be obtained by measuring the radio link parameter 17 such that at least one of the results 15₁ with i=1, . . . , N; N≥1 represents the measured radio link parameter, the measurement report may incorporate results that do not necessarily represent the radio link parameter. For example, additional measurements may be performed by the device 11 and those additional measurements or at least one result thereof may be incorporated into the measurement report 19. For example, the content of the measurement report 19 is based on a request received with the wireless device 11 prior to generating the measurement report 19. The device 11 may be configured for collecting measurement results and/or the set 15 based on the request such that, although capable of measuring the radio link parameter 17, device 11 reports different information. That is, device 11 may be configured for obtaining the set 15 of measurement results by measuring at least one non-radio link parameter associated with the operation of the wireless communication network. The measurement report 19 may be generated by the device 11 so as to comprise information indicating the non-radio link parameter. Examples for such non-radio link parameters of which device 11 may measure one or more include, amongst other things:
an acoustic parameter such as sound, ultrasonic, sound pressure level or the like
a vibration parameter such as amplitude and/or acceleration
a seismic parameter
a chemical parameter, e.g., material, substances or compounds as well as molecules being present, an electric parameter such as an electric voltage, current and/or electric potential being sensed
an electromagnetic parameter such as an electric field and/or a magnetic field
a dielectric parameter
a radio parameter relating to a parameter that is measured at radio frequency, e.g., at least 3 hertz to higher frequencies of, for example, at most 300 gigahertz. Such a radio parameter may include, for example, a measurement of the power spectral density in a given frequency range. The radio parameter may thus relate to different parameters in the mentioned radio frequencies even if the parameter does not form a part of the radio link
a radar parameter
an environmental parameter such as a weather parameter, moisture, humidity and/or visibility
a flow related parameter such as fluid velocity, gas flow or the like
an ionizing radiation parameter
a parameter related to subatomic particles
a location-related parameter such as position, angle, displacement, distance, speed and/or acceleration
an optical parameter such as colour, wavelength and/or magnitude of light
an imaging parameter
a LIDAR parameter
a photon parameter
a pressure parameter
a force parameter
a density parameter
a level parameter, wherein level may be understood as a parameter in connection with a hydrological property such as sea level, river level or the like but may also relate to a level as in the meaning of straight (horizontal, vertical, at a given angle or inclination) which may be used to determine if a mast or antenna structure or the like has shifted due to an environmental effect, and/or in the meaning of a level related to an altitude in connection with a network device that is, for example, airborne (or a self-powered device that has slid down the side of a tree, mountain or other mounting structures)
a thermal parameter such as heat and/or temperature
a proximity parameter such as a presence or absence of bodies or objects
information indicating a potential, a suspected or known aggressor in view of wireless communication, e.g., an interferer.

That is, device 11 may be configured for measuring the radio link parameter and a non-radio link parameter. As indicated, the measurement report may contain information related to the non-radio link parameter whilst, optionally, forming the measurement report 19 in absence of the radio link parameter. Such information may provide for knowledge to the network by including information that is not necessarily directly related to the radio link parameter. For example, a storm may have dislocated an antenna of a basestation. Information indicating or related to such an event may form at least a part of the measurement report, thereby allowing the network or a higher level entity to determine a root cause for bad links or link failures or reconfiguration of the network as not the network itself faces a bad condition but external effects have led to other effects, e.g., the dislocated antenna.

In a scenario in which the device 11 is configured for generating the measurement reports so as to comprise the information indicating the non-radio link parameter and so as to not comprise the radio link parameter, the device can be configured for not measuring the radio link parameter, e.g., for this specific measurement report, and when generating the measurement report. This may allow to save computational resources and/or battery power.

Device 11 may be configured for measuring the radio link parameter and/or the non-radio link parameter and for generating the measurement report so as to report the measured information. For example, the measurement report may contain a single instance of one or more parameters. For example, the device may be configured for measuring a plurality of parameters comprising the radio link parameter so as to obtain a plurality of measurement results, i.e., the set 15 may comprise a plurality of results 15ᵢ related to different measured parameters. The device 11 may be configured for generating the measurement report by selecting for the set of measurement results to be included into the measurement report a subset of the plurality of measurement results being available or being recorded. In different terms, the device may perform measurements but may report only a part thereof, e.g., based on requested results or based on own decisions at the device. However, according to embodiments, the device performs measurements in accordance (at least in parts) with a received request which may reduce measurement overhead.

The device 11 may be configured for selecting a subset of measurement results to be included into the measurement report from the set 15 based on a selection signal received. The selection signal may indicate the parameters that are requested to be measured and/or reported by the device. For example, the selection signal may be a request and/or a configuration signal received from a further network entity.

The device 11 may be configured for generating the measurement report 19 as an immediate report but may, alternatively or in addition, be configured for generating the measurement report as a report of a logged measurement. That is, device 11 may store one or more measurement results and may recall those results, e.g., from an internal memory or the like, so as to generate the measurement report 19, for example, when a triggering event is occurring. Whilst the immediate report allows for a low latency between the measurements being made and the time the information is available at the network, logging may allow for a low network load by accumulating information and/or by transmitting information when the triggering event has occurred. Device 11 may be configured for generating the measurement report 19 so as to comprise information indicating the radio link parameter and a time information associated with the radio link parameter was measured. This may allow for comparing the measurement result with measurement results received from different entities which may comprise a common clock and/or for associating the measurement results with external or additional information received.

The time may relate to a time reference of the device, a different time reference in the wireless communication network and/or a combination of multiple time references.

The information associated with the time may relate to an absolute and/or relative time measurement and may include information indicating a coherence time, e.g., of time reference grids, a variance in time, a fluctuation and/or a time drift.

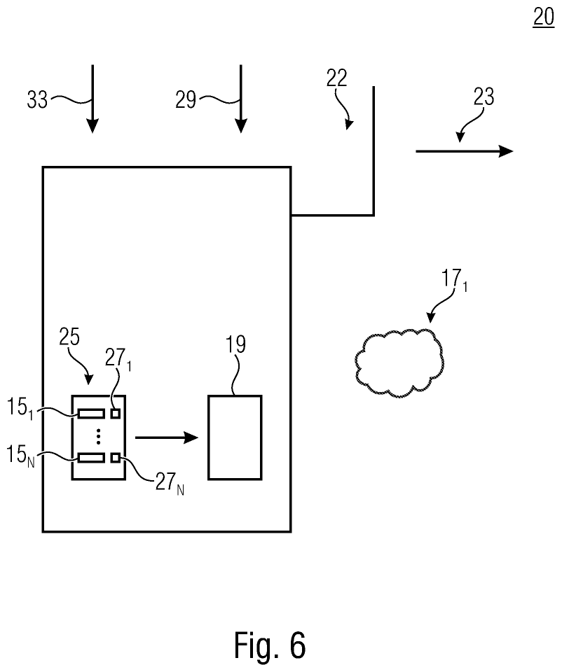

FIG. 6 shows a schematic block diagram of a device 20 being in accordance with the second recognition of the present invention. The device 20 may, as the device 11, be referred to as an MLRD. Device 20 may be configured for operating in a bidirectional wireless communication network in at least the first operating mode being described in connection with FIG. 5. In the first operating mode, the device 20 is configured for transmitting and/or receiving wireless signals and for obtaining a plurality of measurement results 15₁ to 15_{N}. Obtaining a measurement result may comprise a measuring of a radio link parameter, e.g., the radio link parameter 17₁. The device 20 is configured for generating a log 25 so as to comprise information derived from the plurality of measurement results and time information 27ᵢ associated with the plurality of measurement results 15ᵢ.

Optionally, further information may be included, e.g., information indicating a sensor type, the category of the parameter or the like. The device 20 may be configured for generating a measurement report, e.g., the measurement report 19 from the log and for transmitting the measurement report 19 to at least one entity of the wireless communication network, e.g., using the signal 23. The radio link parameter 17₁ may be associated with a link operated by the device, wherein the link may be a unidirectional link or a bidirectional link. Alternatively or in addition, device 20 is configured for generating the measurement report 19 so as to comprise information about at least one time instance of the measurement result being obtained prior to a link degrading event causing degrading of the wireless link operated by the device.

The device 20 may log the measurement result or the measurement results. The device 20 may report, to the entity of the wireless communication network, the measurement result after the link degrading event. For example, the link degrading event may incorporate a link failure or may lead to a link failure. The device 20 may transmit the measurement report 19 after re-establishing the link. When evaluating the past, the wireless network may still benefit from such information as it may associate the information contained in the measurement report with knowledge about failures in the network. For example, the device 20 may be configured for generating the measurement report 19 so as to comprise information about at least one instance of the measurement result being obtained prior to a link degrading event causing the degrading of the wireless link and for transmitting the measurement report to the entity of the wireless communication network after the link degrading event. For example, in a case where the link degrading event is an event causing a wireless link, i.e., the link of the device 20 or of a different device, facing a wireless link failure or at least temporary link interruption leading, at least for some time or a time interval, for an interruption of the wireless link, the device may report according to its capabilities. For example, if the own link is interrupted it may report after having re-established the link or after having established a side-link. If a link of a different device is affected, it may report without own disturbances. The device 20 may be configured for generating the log 25 and for reporting the log only in case a predefined triggering event occurs. The triggering event may comprise a received request, a link degradation or any other trigger, e.g., a lapsed time interval or other situations.

Embodiments particularly relate to a combination of events and/or multiple events to be the source for generating the measurement report or different versions of the measurement report. For example, different parameters arriving, exceeding or falling below a threshold may arrive at different measurement reports to be reported. Any other combinations are possible. That is, the device may be configured for transmitting the measurement report after a link degradation automatically or upon request. However, the request is not limited to be received after the link degradation but also may be received any time.

The device 20 may be configured for logging the measurements, i.e., to generate the log 25, in a state of being active (first operating mode), inactive or idle (e.g., a state being at least comparable to the second operating mode of device 11) in the wireless communication network.

Device 20 may be configured for including, to the measurement indicated in the measurement report 19, at least of an action in the wireless network determined by the device as such an action may be associated by the network to the link degrading event
an instruction recognized by the device
a request recognized by the device
a command recognized by the device and/or
a configuration of the device and/or other devices.

Such information may provide the network with a more global or globalized overview of the parameters effecting the network, directly or indirectly. Although being described in connection with device 20, device 11 may be adapted accordingly.

Device 11 and/or device 20 may be configured for logging the measurements in at least one of a continuous manner, a timed manner, e.g., in low-speed, high-speed or dynamic-speed, probably configurable, a sequence manner, an ordered manner, a requested manner, a windowed manner, an instructed manner, an event-based manner, a trigger-based manner, a threshold-based manner, e.g., a parameter is logged when falling below, arriving or exceeding a threshold value, and/or or a programmed or scripted manner.

That is, although logging is described in connection with device 20, device 11 may be implemented to generate a log accordingly. Vice versa, performing the measurements as described for device 11 may also be implemented at the device 20 such that one or more features described in connection with the device 11, device 20 respectively may be incorporated into device 20, device 11 respectively.

In connection with logging measurements, device 11 and/or device 20 may be configured for logging measurements for the measurement report together with a header, identifier, marker or stamp, i.e., additional information, containing one or more of:
an absolute time
a relative time
a time relative to a slot
a frame or the start of service (uptime)
a speed over ground
a location such as global positioning system (GPS) or other global navigation satellite system (GNNS) coordinates
an altitude
a cell-ID of the wireless communication network
a beam ID of a beam in the wireless communication network
an antenna pattern related to the beam and/or beam ID
a cell sector
a service set identifier (SSID)
an internet service provider (ISP)
a pathloss model (PLM)
a mobile network operator (MNO)
a radio access technology (RAT) connection type such as 5G, 4G, 3G, 2G, Y-5®, Bluetooth®, a long-range navigation (loran) and/or
a service type such as voice over IP (VoIP), video on demand, augmented reality, virtual reality or the like.

Each of those parameters may be related to the device itself and/or may be related to a different device but detectable by device 11 and/or 20 and, thus, log-able and/or reportable.

Device 11 and/or device 20 may include or incorporate or comprise sensor elements and/or calculation units such as processors or the like that allow to determine the respective parameter. Alternatively or in addition, device 11 and/or device 20 may be configured for receiving information indicating a measurement result from another device, e.g., using a wired or wireless interface. Device 11 and/or 20 may be configured for generating the log and/or measurement report so as to comprise the received measurement results. For example, the received measurement result may be stored in the log 25 which may be stored in a memory to which device 20 has access. Optionally, the received information, e.g., the measurement result itself and a time information, may be updated by an own time information or the like.

As described, providing the network with information that extends beyond the single wireless link and/or which is obtained during a time period in which the device is in the first operating mode in a bidirectional network, the ability of the network is increased to detect, correct and/or avoid disturbances in the network. In the following, examples for such a procedure are given. In a first example, a VoIP call is started in 4G and is handed over to 3G 2G and can, thus, experience QoS degradation (for example in voice quality). If link parameters related to such QoS degradation events were to be recorded at either both ends of the link and subsequently post-processed for root cause analysis, it is possible to reconfigure the network or the UE or the service so that the QoS is improved (in future). This may be facilitated through the optimization, correction and/or adjustment of the needed parameters.

In another example, an integrated access and backhaul network (IAB) backhaul link comprised of MM Wave components in which beam forming systems are employed and, due to wind effects, may experience beam misalignment and, thus, a degradation in QoS or link failure. By deploying MLRDs, e.g., device 11 and/or 20, at one or both ends of the link, the relevant parameters can be measured and logged for subsequent analysis and examination, thus leading to the determination of the root cause and thereafter the appropriate optimization, correction or adjustment of the needed parameters.

MLRD measurement, logging and reporting may be implemented, adapted and optimized individually and may be referred to as three separate topics. However, embodiments combine two or more thereof, e.g., the combination of measurement and logging and/or the combination of all three.

Measurement

The MLRD can measure (QoS) parameters on different layer of the protocol stack. For example:
PHY-layer
   BER, BLER, MCS levels
   RSRP/RSRQ/SNR/SINR of beams measured on SSB, CSI-RS, SRS
   Beam numbers on SSB, CSI-RS, SRS;
L3/Higher layer reporting
   Serving/connected cells
   Observed cells
   Latency
   Jitter
   Throughput

Parameters are selectable individually or in groups and groups can be pre-defined or defined dynamically. Measurement setting can include validity area and validity period. Measurement values can be flagged or described by a quality indicator (e.g. precision, accuracy, reliability, resolution). The QoS measurement is dependent on the equipment capability (super UE included).

An MLRD of certain capability may be configured to establish and maintain a link associated with a defined QoS over a configured period of time in order to probe/test/enable/investigate link behaviour/performance at particular time instances/locations/conditions which is different to known MDT-Minimization of Drive Testing.

The MLRD is capable of measuring parameters either within the link with which it has with another (network) entity, from other entities that may affect or oppose its link or outside of any link. Examples of within-link or inside-link monitoring include performances metrics such as packet error rate (PER), throughput, automatic repeat request (ARQ) counts and hybrid ARQ (HARQ) counts. Examples of opposing-link monitoring include performance metrics such as cross-link interference (CLI), signal-to-interference-noise ratio (SINR), adjacent channel leakage ratio (ACLR) and saturation. Finally, when an MLRD is measuring parameters that relate to the link between two other entities and the MLRD is not itself either of those entities and hence not part of the link, the MLRD can be said to be eavesdropping or overhearing the active link. In this case the MLRD, which is said to be outside-of-link, can measure signal power as a function of frequency (including bandwidth), time, resource block, beam, cell identification, direction information, AoD, AoA and so on.

Further MLRD measurement capabilities may include the following categories: acoustic, sound, ultrasonic, vibration, seismic; chemical; electric current, electric potential, electromagnetic, dielectric, radio, radar; environment, weather, moisture, humidity, visibility; flow, fluid velocity; gas; ionizing radiation, subatomic particles; position, angle, displacement, distance, speed, acceleration; optical, light, imaging, lidar, photon; pressure; force, density, level; thermal, heat, temperature; proximity, presence. These can be helpful in concluding the root cause of link degradation within the link.

To illustrate some of the above measurement categories, the following examples are given:

Terrestrial networks are typically comprised of basestation and antenna installations that are arranged to provide the needed coverage and capacity for a given geographical region. Basestation antennas can be deployed on antenna masts or towers or on existing structures such as buildings, pylons and water towers. As a result of the effects of severe weather conditions (e.g. storms), earth tremors or natural disasters (e.g. avalanche, blizzard, earthquake, fire (wild), flood, freezing rain, heatwave, hurricane, landslide, lightning strike, tornado, tsunami, volcanic eruption), the position and orientation of basestation antennas can be changed or the antennas can otherwise be damaged such that coverage is affected. Measurement data collected from sensors (e.g. acoustic, ultrasonic, vibration, seismic, chemical, electrical, electromagnetic, wind, moisture, humidity, visibility, gas, position, angle, displacement, thermal) can be used to both forewarn a network or basestation of an approaching disturbance or otherwise be analysed after a performance degradation has been detected. As further example: data obtained from chemical sensors designed to measure gas levels (e.g. carbon dioxide) can be used to assess volcanic eruption and forest fires; data obtained from vibration, acoustic or seismic sensors can be used to assess earth tremors, storms, earthquakes, avalanches and landslides; and data obtained from electrical and electromagnetic sensors can be used to determine lightning strikes.

MLRD measurements of time can be relative to the MLRD's own time reference or another time reference (for example from another BTS, UE, MLRD or non-network entity) or as a combination of multiple time references. MLRD absolute and relative time measurements may include coherence time (of time reference grids), variances, fluctuations and drifts.

One or more MLRD(s) can be used for spectrum scanning and to observe beyond the channel or link of interest. Similarly, MLRDs can be used to locate the direction of radiating sources, including interference.

Logging

MLRD logging can be configured in active, inactive and idle mode. For example, measure on blank pilots of neighbouring and serving cells for CLI.

The MLRD is also capable of recording actions, instructions, requests and commands and configuration in all three of the use cases described above (namely, within-link, opposing-link and outside-of-link).

The MLRD records or logs measurement in a continuous, timed (low-speed, high-speed, dynamic-speed), sequenced, ordered, requested, windowed, instructed, event-based/trigger-based/threshold-based or programmed/scripted manner. In the case of event triggering, the MLRD can perform actions in either a semi-autonomous or completely autonomous manner. The measurement data can be recorded as-is or “raw”, uncompressed, compressed, averaged (running average/windowing), statistically processed or reduced (1^{st} order, 2^{nd} order statistics) or otherwise filtered. Furthermore, the measurement data can be recorded individually or as part of a defined group.

An MLRD can record a selection of measured (QoS) parameters together with a header, identifier, marker, stamp containing one or more of: absolute time; relative time; time relative to a slot, a frame or the start of service (uptime); the speed over ground; location (GPS/GNSS coordinates); altitude; cell ID; cell sector; SSID; ISP; PLM; MNO; RAT connection type (5G, 4G, 3G, 2G, Wi-Fi, Bluetooth, LORAN); service type (VoIP, Video On Demand, augmented reality, virtual reality).

MLRD data can be open, locked or otherwise protected for example by using block chain principles to limit unauthorised access, tampering or other forms of falsification.

The MLRD measurement depth (sampling interval, granularity) may be set according to parameter or a KPI requirement.

Additional MLRD parameter measurements and observations are not limited to include: potential, suspected or known aggressors and predators; and environmental conditions, disturbances or changes (e.g. being close to an electric/dielectric object).

Moreover, when an MLRD works in an autonomous or semi-autonomous manner, it can record or log measurements that another MLRD is making, thus acting as proxy-logger. The measurement and logging may need a handshake procedure, providing confirmation for logging, considering, for example, sample set or filtered-sample set (log on confirmation procedure).

MLRD could identify an event and send a COMMAND/NOTIFICATION to other MLRD to trigger measurement and/or logging and/or reporting. This COMMAND/NOTIFICATION may contain explicit instructions e.g. what and how to measure, the time(moment) of the event and/or the kind/classification of event. Furthermore, activation period, validity of requested measurements/logging/reporting could be further content of the COMMAND/NOTIFICATION. The signalling procedure of the COMMAND/NOTIFICATION should include a confirmation of execution etc., and fallback options, if COMMAND/NOTIFICATION was not received and/or certain actions requested could not be successfully executed.

Reporting

MLRD reports can be sent regularly, continuously, on demand, repeatedly, according to a schedule, at certain times, proactively, autonomously, automatically. MLRD reporting can be orchestrated by higher network entities, events or situation, or be triggered by parameter threshold or certain events (e.g. a drone should send connection and flight related report to the network after an accident).

When a link failure is detected by MLRDS at both ends of a link, one or both ends should provide a “before and while” link failure report to the other end automatically or on request after link/connection re-establishment.

Where and if available, the MLRD reports via an auxiliary measurement/reporting channel, a dedicated physical/logical reporting channel or a dedicated inter-MNO/inter-PLMN physical/logical reporting channel. In accordance with the channel being used, the MLRD uses the appropriate signalling structure and format including all needed encryption, compression, encoding and security measures. The transmission of the MLRD report can be timed, sequenced, ordered, requested, instructed, event-based/trigger-based/threshold-based (e.g. upon returning home) or programmed. The MLRD sends its report to at least one of a network entity, a communication partner, a next member of a defined group, a basestation, a mobile network operator (MNO), a server running over-the-top (see below), a higher authority (for example, a regulator), an original equipment manufacturer (OEM) or a service provider.

An MLRD can report all of the recorded data sets containing selected parameters or KPI dimensions, information or conclusions during a given period (time window) or a subset of the data set thereof.

MLRD reporting can be into one direction (e.g. UE to network or network to UE) or in both directions. Furthermore, a third entity or further devices or entities in the network can be the source and/or the destination of such reports. If the report destination is not defined, the report can be sent in any direction away from the reporting MLRD. The number of “away-from-me” hops can be counted and limited according to configuration including the avoidance of loops or “home returns”.

As an example, reporting from the network to the UE may enable the UE to detect certain conditions which are prone to degradation or failure and thus lead it to adapt or reconfigure its transmit and/or receive strategies such that it will better adapt to such circumstances. This may lead to software updates from the device OEM. A reporting from the UE to the network side may enable the network to correlate parameters and conditions such that useful insights and performance improvement configurations/strategies can be obtained.

The MLRD does not necessarily report to all the devices that request a report from it. A level of selection, priority, authority or hierarchy is thus observed by the MLRD wherein examples of requests from public safety, law enforcement, lawful interception or regulatory investigation may not be denied. Alternatively, incentive driven requests may be optionally addressed.

MLRD reporting should be accompanied by a traceable certification of validity. In this context, validity is used to mean the quality of the measured data for example with traceability to a measurement laboratory, test house, certification authority and so on.

Multiple MLRD operation may need orchestration wherein a central entity distributes or allocates measurement commands and tasks to a plurality of MLRDs. The central entity can be thought of as a conductor of an orchestra and is thus a node or a device in the active link—this could also include the core network “behind” the radio link. The node or device does not necessarily have to be a network entity nor an entity of a similar radio access technology (RAT). Inter-RAT MLRDs are thus considered including examples of Wi-Fi, Bluetooth, DECT and 3GPP LTE/NR and systems beyond the current 5G technology. Further examples include test and measurement (T&M) equipment that connect to one or more MLRD without necessarily being connected to the network.

Multiple MRLDs may operate without orchestration through virtue of their autonomous or semi-autonomous functions (educated behaviour) and, by using suitable markers, enable post-mortem analysis of measurement reports. In this context, educated behaviour is not limited to include: swarm intelligence algorithms; embedded incentive functions based on game theory; and post-training pattern observation classification (e.g. using a “DNA print” obtained from a manufacturer).

Example: Mimic or support behaviour of other MLRDs, partial or complete knowledge of what they are doing, on request or autonomously and/or inter-MLRD communication and/or with or without the orchestrator.

As described, the measurement report may be generated based on instructions or requests received, such that the device 11 and/or the device 20 may be configured for generating the measurement report based on a report instruction signal 29 received with the device. The report instruction signal 29 may comprise information indicating a request to generate the measurement report and/or details with regard to the parameters to be measured and/or reported.

The device 11 and/or 20 may be configured for logging measurement results, i.e., to generate the log 25. The device may be configured for receiving a logging instruction signal 33 and for logging the measurement result based on the logging instruction. As discussed for the report instruction signal 29, the logging instruction signal 33 may comprise information about measurements to be taken and logged, i.e., a time interval, an accuracy and/or a type of measurement.

The logging instruction signal 33 may comprise instructions relating to at least one of a parameter to be logged, a parameter to be not logged, a time interval for which logging is performed, a number of measurements to be logged and fallback options for one or more thereof. For example, the device 11, 20 respectively, may comprise for a certain capability of performing measurements and/or logging being known to the network, for example, by explicitly transmitting a signal from the device to the network and/or by having knowledge in the network about the capability, e.g., knowing sensor capabilities based on a particular type of the device. From those capabilities, the network may select the measurements it needs or requests.

In connection with measuring parameters, e.g., related to receiver related signals, the MLRD may accordingly be instructed to provide for transmitter related signals, parameters and/or configurations, information that is known or at least accessible to the transmitter itself. Alternatively, or in addition such information may be requested from a central entity managing those parameters, e.g., a scheduling node such as a basestation or the like.

The device 11 and/or 20 may be configured for measuring parameters based on parameters indicated in the report instruction signal 29 and/or indicated in the logging instruction signal 33. Alternatively or in addition, the device may be configured for not measuring parameters for which the device comprises measurement capability based on the report instruction signal and/or the logging instruction signal. That is, with the report instruction signal 29 and/or the logging signal 33, a part of the capability of the device may be unselected or removed from the report and/or log.

The device 11 and/or 20 may operate in accordance with the received instructions. However, in case signal 29 and/or 33 requests for measurement reports exceeding the capability or willingness of the device, the device may skip the request or may operate in accordance with the request at least in parts. For example, the device may exclude requested measurements for which no sufficient capabilities (or energy or the like) are implemented or available but may provide for the rest of the requested information instead of refusing to follow the instructions.

The device 11 and/or the device 20 may be configured for determining an event related to the operation of the wireless communication network and for logging the measurement result based on the determined event. As discussed, the network may associate a plurality and variety of parameters to be related to the operation of the wireless communication network, i.e., the radio link parameter and the non-radio link parameter. A specific determined event, i.e., a trigger event, may be predefined by the network. In case such an event occurs, the device may operate accordingly for logging the measurement result and/or for transmitting a measurement report. The device 11 and/or the device 20 may be configured for including, into the measurement report 19, and associated with the radio link parameter, a non-radio link parameter as described. The device 11 and/or the device 20 may be configured for at least one of generating and sending a report instruction signal to a further device of the wireless communication network so as to indicate a request to measure and report at least one parameter, and/or generating and sending a logging instruction signal to a further device of the wireless communication network so as to indicate a request to log at least one parameter. That is, device 11 and/or device 20 may be configured for not only receiving the report instruction signal 29 and/or the logging instruction signal 33 but also for transmitting a respective signal. For example, device 11 and/or device 20 may determine, based on internal and/or external evaluation, that additional information and/or measurement is needed for generating the report and/or that other devices have to assist device 11, 20, respectively. Accordingly, device 11 and/or 20 may request or instruct other devices to assist.

Although embodiments allow for just sending the measurement report, e.g., in plain text or the like, additional mechanisms may be implemented so as to allow for a high security of network operation. For example, devices described herein may be configured for including validity information into the measurement report 19. The validity information may indicate a validity of the measurement. The validity information may comprise the traceable certification of validity as described above. Alternatively or in addition, the validity may include information indicating a permission to transmit the report, information indicating the precision or accuracy obtained with the measurements that are reported or the like. Alternatively or in addition, the validity information may indicate at least one of a time instance or time period the measurement was made, a resolution or accuracy of the measurement, a hardware used for the measurement, a distance to the source of the parameter to be measured and/or a certificate indicating a trust worthiness of the device.

Including the validity information may provide for a measure of reliability of the measurement report and the information contained therein. This may allow, for example, to select information amongst different measurement reports for evaluation of the network status and/or measures to be taken. For example, when receiving reports that are generated with different distances to a disturbing source, the network may decide to select the closer one (e.g., facing a comparatively low amount of additional sources on the sensor) or the farer one (e.g., allowing for a far field scenario when compared to a near field scenario).

However, embodiments relate to a device that is configured for protecting a content of the measurement report. This may allow to avoid unallowed evaluation of the measurement report and/or unallowed generation of a measurement report. For example, block chain principles may be used to limit unauthorized access, tampering or other forms of falsification.

Embodiments relate to providing the measurement report to an entity of the wireless communication network. A device in accordance with embodiments may be configured for transmitting the measurement report to at least one of a network entity, a communication partner, a next member of a defined group, a basestation, a mobile network operator (MNO), a server running over-the-top, e.g. a supervising entity, a higher authority such as a regulator, an original equipment manufacturer (OEM) and/or a service provider. According to an embodiment, a device is configured for including, to the measurement report, an information indicating a number of hops the measurement report is requested to be forwarded at a maximum. This may allow to limit a network load caused by the measurement report on the one hand and/or to arrive as an outdated measurement report at the facilitated receipt.

Alternatively or in addition, device 11 and/or device 20 may be configured for transmitting the measurement report based on a respective request. Such a request may be evaluated by the device for a priority information contained in the request. The device may be configured for transmitting the measurement report when the priority information indicates a priority of at least a predefined priority level and for not transmitting the measurement report when the priority information indicates a priority of less than the predefined priority level. As described, the level of selection, priority, authority or hierarchy may be observed. For example, an MLRD that has low battery charge may decide to report only on very important (high priority) requests whilst to allow itself to not report on standard requests or the like. Any other priority or hierarchy or selection mechanisms may be employed, for example, different device classes. For example, devices having access to a power network or that are operated by low-priority users (e.g., when compared to emergency services or the like) may provide for a higher amount of reports than other devices.

According to an embodiment, device 11 and/or device 20 may be configured for measuring the radio link parameter for a plurality of cells of the wireless communication network, e.g., at least 46, at least 256 or at least 512 cells. Such a number of the plurality of cells may be adjustable, e.g., by a network authority.

According to an embodiment, device 11 and/or device 20 may be configured for selecting, from a plurality of measurement results, a subset of measurement results to be included. That is, the set 15 may be evaluated for a subset based on one or more criteria. The device may be configured to include a predefined number of measurement results being ranked according to a ranking criterion such as distance, time lapse, signal strength and reliability. That is, the predefined number of results that may be referred to as best results or best-fitting results may be selected. Alternatively or in addition, the device may select measurement results to be included into the measurement report that are in accordance with a predefined selection criteria such as a best result quality. For example, only results that are at least of a predefined quality threshold, e.g., accuracy, age or the like, are included. Both criteria may be combined, e.g., select the best measurement results but at most a number of 5, 10, 20 or the like.

The device 11 and/or the device 20 may be configured for measuring at least one parameter, the radio link parameter and/or the non-radio link parameter during a time interval with a first accuracy and during a different second time interval with a second accuracy. For example, the device may monitor a specific parameter and in case the parameter is lower than a predefined minimum value or higher than a predefined maximum value and/or vice versa, and/or if a different parameter implements a trigger event, the parameter may be measured with a higher accuracy. This allows to obtain a course information about the measured parameter in absence of the trigger event and, in case of the trigger event, a higher accuracy. Omitting some of the measurements for a lower accuracy may allow for executing different tasks and/or for saving computational effort and/or electric power.

Alternatively or in addition, the second time interval leading to the increased accuracy may be started upon request being associated with the wireless communication network. In connection with associating a parameter with the operation of the wireless communication network, embodiments enlarge the known scheme by allowing the network, e.g., a centralized node or the like, to associate parameters, a non-link parameter with the operation of the wireless network.

In other words, embodiments allow for measurement and logging in combination.

In known concepts, the number of neighbouring cells to be logged is limited by a fixed upper limit per frequency for each category below. The UE should log the measurement results for the neighbouring cells, if available, up to (examples):
6 for intra-frequency neighbouring cells;
3 for inter-frequency neighbouring cells;
3 for NR (if non-serving) neighbouring cells;
32 for WLAN APs;
32 for Bluetooth Beacons.

Embodiments allow to record the “unexpected” for post mortem (e.g., with regards to degrading of the link) processing or analysis and allow or prepare for configurable recording. Configurable can include standardized or implementation specific.

The numbers 3 and 6 listed above seem to be too small for future deployments and the specification is therefore inflexible regarding configuration.

Furthermore, e.g. in a factory environment with UDN many cells are visible, as well in macro scenarios where even without MMIMO 10 or more cells are visible. Beamforming can substantially extend interference range and therefore more cells should be monitored. Furthermore, we should consider UEs on drones which can observe potentially hundreds of gNBs at the same time.

Embodiments relate to
A value being adjustable and beyond around 64+ to 256/512 cells.
If number is limited, measurement can be performed on the k strongest cells (strongest can be with the meaning of total band (average), subband, particular beams SSB, CSI-RS etc.)
   An MLRD could measure and log specific values with “adjustable sampling density (temporal/frequency/spatial))” or “maximum hold” depending on, for example, a ranked order of neighbouring cells.
Furthermore, selection of values to be logged and their combination can be a function of reasoning of “unusual” events, anomaly detection.
Let us consider a clever way of formulating a causal phrase which may go into a standard

Embodiments provide for an MLRD having a temporal resolution for observation and logging that includes sub-second scale of frame/slot/symbol, FFT-sampling and guard time (e.g. TDD switching interval).

Embodiments also allow for obtaining measurement, logging and reporting in combination.

In known concepts, the logging configuration for event-based and periodic DL pilot strength logged measurements can be configured independently. But only one type of event can be configured to the UE, embodiments allow for a combination of events.

The configuration and triggering of measurement, logging and reporting can be extended to an event or a combination of events in a causal or non-causal sequence. For example, due to an excessive jitter of packet delivery, the throughput is varying or reduced below a given threshold and the DL RSRP, DL RSRQ and the SINR of the DL pilot are degraded below a needed performance level (operational window etc.).

When a logging area is configured according to a known concept, logged MDT measurements are performed as long as the UE is within this logging area. If a logging area is configured, logged MDT measurements are performed as long as the RPLMN is part of the MDT PLMN list. When the UE is not in the logging area or RPLMN is not part of the MDT PLMN list, the logging is suspended, i.e. the logged measurement configuration and the log are kept but measurement results are not logged.

According to embodiments, measurements could be logged but are not automatically reported. Alternatively, measurements are logged with a different sampling density (time/frequency/space).

A roaming PLMN according to an embodiment can restrict an MLRD's configuration of measurement logging and reporting.

Devices 11 and 20 have been described in connection with an MLRD. As discussed, such measurement may be performed autonomously or by a decision made by the respective device and/or responsive to a trigger event. Optionally, the trigger even may be configured by a different device and/or a so-called orchestrated measurement may be performed. In such a measurement, a network node or a distributed collection of nodes may decide about parameters and/or information to be collected within the network. Such a device may instruct or request other devices such as MLRDs to assist with measurements and to report their measurements. Such a requesting device may select which device is requested for performing which kind of measurements. Alternatively or in addition, such a selection may be performed groupwise, e.g., based on a device type being requested, an operator operating the device and/or capability information provided by the device to the network implicitly or explicitly. Alternatively or in addition to an individual or groupwise request, a global request may be transmitted.

Wherein some embodiments are described so as to provide information to any node or entity in the network to optimise operation of the same, embodiments are not limited hereto but also allow to enhance a point-to-point communication in which a link between a transmitter/transceiver is used to transmit a signal to a receiver/transceiver providing for a kind of feedback about the link to allow closed loop communication. E.g., the receiver reports, directly or indirectly back to the transmitter. For such communication, embodiments according to the first recognition and/or the second recognition may relate to monitoring and/or logging to happen at the two ends of the link, i.e., double-ended or two-ended monitoring and logging.

That is, receiver related signals or parameters and/or transmitter related signal, parameters and/or configurations may be logged and/or provided to enhance also an end-to-end communication or at least a hop thereof, e.g., when using relays which is described below. For example, a receiving node may inform a transmitting node to enhance its communication and/or a transmitting node may inform a receiving node to enhance its reception. Such information may be measured, reported and/or logged as described, e.g., using timestamps, locations and/or other suitable associated information.

In view of the mentioned option to use a multi-hop communication as well as a single-hop communication, it is noted that as a such link one may understand a direct communication between two nodes, such as a transmitter and a receiver and/or between two transceivers. However, it is possible to use a kind of relay for such a link which may use one or more mechanisms for relaying such as amplify and forward (AF) and/or decode and forward (DF). That is, it is possible that a relay changes, e.g., a polarisation, a frequency range, a centre frequency, a coding or the like between a first part of the link and a second part of the link whilst it may also keep one or more properties unchanged. In such a case, especially when changing one or more parameters, a link incorporating a relay such as transmitter/transceiver→relay; relay→relay; and/or relay→receiver/transceiver may be considered as an own link having own parameters and/or conditions; wherein in view of the presented embodiments such multiple hops may also be aggregated to a single or at least a reduced number of links. That is, if an end to end link is comprised of several partial links, then two-ended monitoring and logging can be performed between any link which makes up a complete chain i.e. an end-to-end communication link. Relays may, thus, also report their radio link parameters and/or other parameters described herein and/or may make use thereof.

Whilst measuring or determining the radio link parameter may, in principle and in accordance with embodiments be performed at different locations in the network, e.g., at a node taking part in the communication (link) or not, some of the embodiments described herein relate to measuring or determining a radio link parameter at an end of the communication link. Such an end of a radio communication link may be implemented, for example, by a transmitter/transceiver, a relay implementing, e.g., both a receiver and a transmitter, and/or by a receiver/transceiver. Measurements, determinations of the radio link parameter(s) may, in accordance with embodiments be provided at one end only or at more than one end. For example, at two (of at least two) ends, e.g., at a transmitting node and a receiving node. That is, the related measurements/logging can be between a transmitter and a receiver at the one end of the wireless communication link between the two nodes, e.g. gNB and UE, or between the first transmitter and/or the first receiver on the one end of the wireless communication link and the second transmitter and/or the second receiver on the other end of the wireless communication link. In particular, when considering a possible multi-hop strategy, more than two ends may be used, providing for a multi-ended communication and according to embodiments a multi-ended monitoring logging and/or reporting. Alternatively, or in addition, the “two ends” referred to beforehand maybe at any position of such a multi-hop communication chain. Such a network may analyse a radio communication link associated with the radio link parameter at at least two ends of the radio communication link.

Some wireless communication networks in accordance with embodiments may be operated in a coordinated or predetermined manner in view of multi-hop chains to organised when connecting to devices with each other via a multi-hop connection. However, some wireless communication networks may operate according to a self-organising manner such that the network itself or controlling entities might be unaware of a specific chain or route until the link is established. In both cases one or more multi-hop links may comprise zero, one or more than one parts, hops that might be considered as weak, i.e., they may provide for low quality, reliability, availability or other wanted behaviours, i.e., they are deemed or considered to show a low amount of performance or a performance below a certain performance threshold which may be equivalent to show deviations or errors above s corresponding threshold. However, the wireless communication network may have knowledge or some kind of suspicion or hints about weak links or parts of a weak link and may consider those parts as more relevant than others, e.g., strong links.

For example, a weak part may be arranged between Relay Node R and Relay Node S. In view of this example, due to the self-organizing nature of the network, the internal route between the two ends of an end-to-end communication (incorporating the part via Relay Node R and Relay Node S) is not known until after the link has been made. In some connections, such a weak (partial) link (e.g., between Relay Node R and Relay Node S) might be used while in other connections/links, it might not. Also, even when the two ends of the end-to-end connection are the same, due to the self-organization or a variation in the organisation of the network, the “weak link” might not be used, i.e., be used only in some cases.

Embodiments allow to avoid unnecessary or less relevant measuring, recording and reporting of all (potentially useless or less relevant) network data, e.g., data that might not include the “weak link”. For example, such a network may provide signalling means to indicate that measuring, logging and reporting is requested to be activated for a specific link (portion). Such an example may be transferred to other reasons leading to interest to measure a specific link or portion thereof without limitation. Such a signalling may be included, for example, in a header of a signal to be transported, in other parts of the signal or in a signal to be transmitted over different channels. It may allow to indicate, that there is a request to measure the indicated portion of the link, e.g., having a meaning similar to “If the signal is routed along a route involving the link between Relay Node R and Relay Node S, then activate measurement, determination, logging and/or reporting, wherein any number and/or any details about the link may be signalled. Whilst this may allow to avoid measurement in case such an indicated portion is not used, it may also allow to obtain information of interest. Whilst the description has been made to use a positive list indicating links of interest, alternatively or in addition a negative list may be signalled, e.g., indicating links or portions thereof for which measurements may be skipped when usually performing measurements.

That is, a link or a part thereof may be subject to measurement or evaluation upon request, e.g., when considering the part as being weak or when aiming to check or evaluate the part based on other reasons. To support this, log files for the “weak link” part of the chain may be transferred/relayed/forwarded/returned to the respective analysing network entity. That is, embodiments provide for a wireless communication network being configured for signalling that at least a portion of a link is of interest, e.g., the portion being considered to be weak, and to selectively provide for measurement or determining of the radio link parameter and/or other parameters based on the signalling, e.g., when the indicated portion is actually used or enabled. The network may be adapted to provide and evaluate a respective log or measurement report to an analysing unit. The report or associated data may be measured or obtained by a node forming an end or intermediate end of the link or a node being outside the link as described.

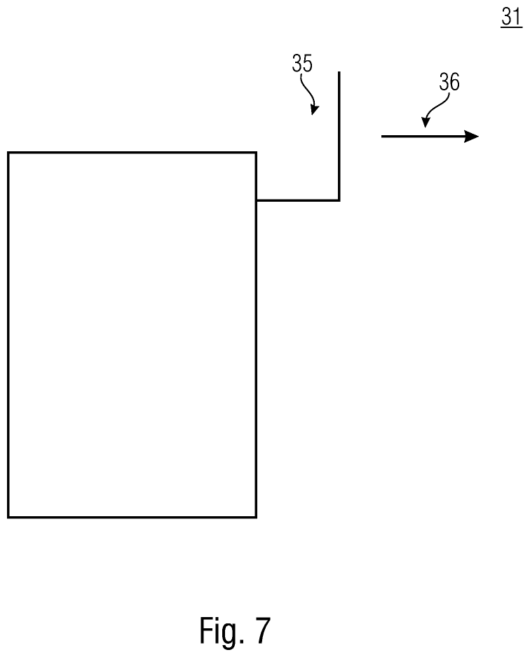

FIG. 7 shows a schematic block diagram of a device configured for operating in a wireless communication network. The device 31 is configured for instructing a measuring device such as device 11 and/or 20 of the wireless communication network. Device 31 may instruct device 11 and/or 20 for transmitting a measurement report comprising a measurement result comprising information indicating a radio link parameter associated with the operation of the wireless communication network. For example, the device 31 may comprise a wired, advantageously wireless, interface 35 such as antenna arrangement 22 and may be configured for transmitting a request signal 36, e.g., the report instruction signal 29 and/or the logging instruction 33. The request signal 36 may be a wired or wireless signal. For example, a wireless signal may directly be transmitted as the report instruction signal 29 and/or the logging instruction signal 33. Alternatively, the request signal 36 may be indirectly transmitted to a node that converts or re-transmits the request signal 36. Alternatively, the request signal 36 may be transmitted via wired interface towards a node that causes a wireless report instruction signal or logging instruction signal to be transmitted in the network. According to an embodiment, the wireless link to be monitored with the measurement result is a link of the device 31. Alternatively or in addition, the wireless link to be monitored is a link of the measuring device.

As described, device 11 and/or 20 may be configured for requesting a measurement report from another device. Such an implementation may arrive at the device 31 such that device 31 may also be considered as an embodiment of device 11 and/or 20. The device 31 may also be adapted to preform measurements as described in connection with the device 11 and/or the device 20 such that device 31 may also be an MLRD.

As discussed, the link to be monitored may be, in view of the measuring device, within-link, opposing-link and/or outside-of-link.

According to an embodiment, device 31 is configured for evaluating the measurement report for the radio link parameter being reported and for a non-link parameter associated with the radio link parameter and/or the operation of the wireless communication network. Device 31 may be configured to determine a reason being related to the non-link parameter that caused a degrading of the wireless link being indicated by the radio link parameter. That is, device 31 and/or a device connected hereto may be configured for determining a root cause for degrading operation of the wireless communication network.

According to an embodiment, the device 31 is configured for instructing a plurality of measurement devices to the four measurements and for transmitting measurement reports, so as to orchestrate distributed measurements. As discussed, at different locations and/or based on different capabilities different devices may be instructed differently.

According to an embodiment, the device 31 is a basestation of the wireless communication network. The MLRD 11 and/or 20 may be of a same or different type, i.e., a basestation, a UE, e.g., a flying UE such as a drone and/or a different entity.

Device 31 may be configured for instructing the measuring device of the wireless communication network to measure, from a plurality of parameters, a set of parameters, e.g., a selection from the parameters to be monitored in the network and/or of the capabilities of the device. The set of parameters may comprise at least one parameter, the plurality of parameters including the radio link parameter, wherein the set of parameters is at least one of predefined, defined dynamically and/or selected individually. As described, the measurement report may be requested so as to comprise a parameter different from the radio link parameter and, optionally, being generated without the radio link parameter.

According to an embodiment, a wireless communication network comprises at least one of the devices 11 and/or 20, wherein a plurality of devices 11 and/or 20 or a device 11 and a device 20 may be present. Further, the wireless communication network comprises at least a device 31. The wireless communication network may be configured to perform a root cause analysis using the measurement report to analyse a cause for a link degrading event and/or to reconfigure the network to avoid or at least partly compensate for a link degrading event.

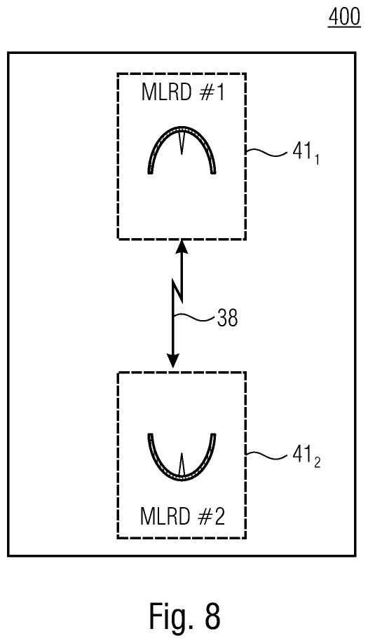

FIG. 8 shows a schematic block diagram of a wireless communication network 400 according to an embodiment. The wireless communication network 400 comprises two MLRDs 41₁ and 41₂ each of which may be in accordance with the description provided for device 11, 20 and/or 31, whilst devices 41₁ and 41₂ are adapted to measure, as described in connection with the devices 11 and 20.

In other words, FIG. 8 shows a generic example of two measurement-logging-and-reporting devices being used in a synchronized and orchestrated manner. Devices 41₁ and 41₂ maintain a radio link 38. The devices 41₁ and 41₂ both may observe, determine and/or evaluate the link 38 and report about a respective radio link parameter.

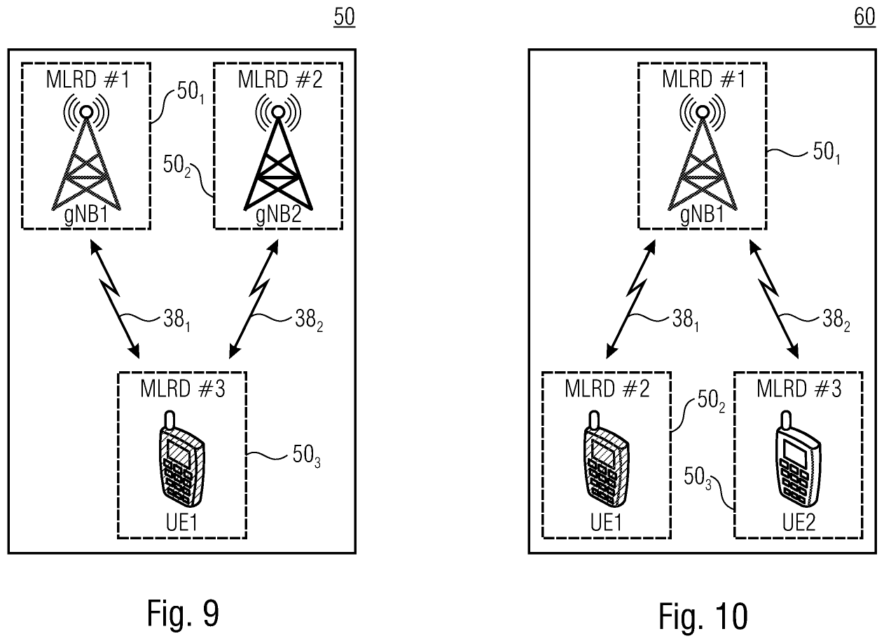

FIG. 9 shows a schematic block diagram of a wireless communication network 50 in accordance with an embodiment. At least three devices 50₁ and 50₂ and 50₃ are present in the wireless communication network 50. For example, each of the devices 50₁ and 50₂ and 50₃ may be implemented as device 11, device 20 and/or device 31 as described, for example, in connection with FIG. 8. That is, a device 50 may correspond to a device 41. By way of example, devices 50₁ to 50₂ are implemented as gNB but also perform the functionality of an MLRD. Device 50₃ may be implemented as a mobile device and/or a UE and operates as a third MLRD in the wireless communication network 50. This does not preclude additional devices in the network and/or cell. Device 50₃ may evaluate and report about two links 38₁ and 38₂ it maintains with devices 50₁ and 50₂, respectively.

In other words, FIG. 9 shows an example of communication between two basestations and a single UE in which each network entity is an MLRD. The active communication links 38₁ and 38₂ are observed by the MLRDs. Optionally, a link may be maintained or operated between devices 50₁ and 50₂. Such a link may be monitored with device 50₁, 50₂ and/or 50₃.

FIG. 10 shows a schematic block diagram of a wireless communication network 60 in which a device 50₁ operating as gNB maintains the links 38₁ and 38₂ with two different devices 50₂ and 50₃ both being adapted as UE.

That is, FIG. 10 shows an example of communication between a single basestation and two UEs in which each network entity is an MLRD. The active communication links are observed by the MLRDs.

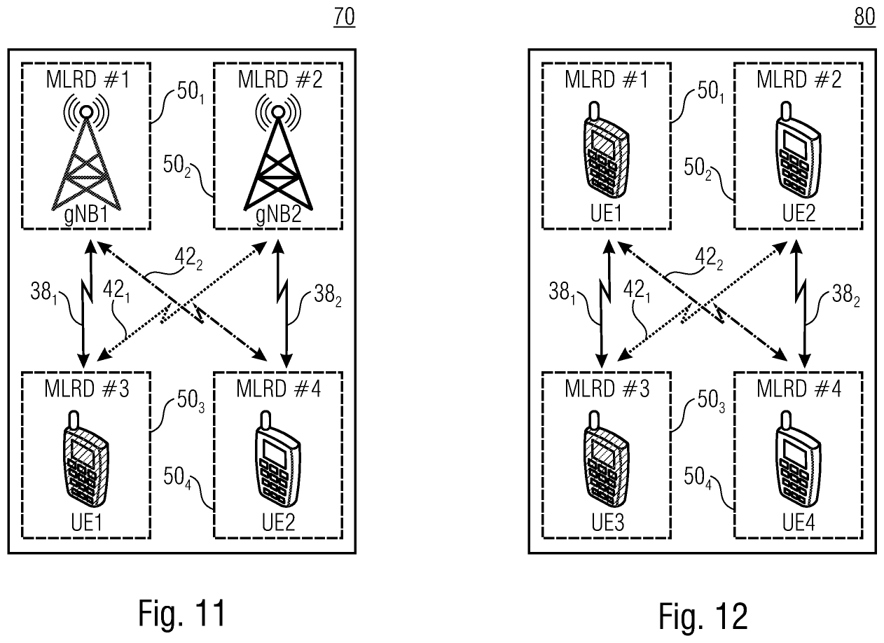

FIG. 11 shows a schematic block diagram of a wireless communication network 70 according to an embodiment. For example, at least four devices 50₁, 50₂, 50₃ and 50₄ are present in which devices 50₁ and 50₃ maintain a wireless or radio link 38₁ and devices 50₂ and 50₄ communicate via link 38₂. Devices 50₁ and 50₂ may be adapted as gNBs whilst devices 50₃ and 50₄ may be adapted as UEs, all devices operating as MLRD. The links 38₁ and 38₂ may interfere with one another as indicated by interference 50₁ and 42₂. Such interference may also be evaluated by the MLRDs. For example, device 50₃ may perform at least a part of an analysis of the link 38₂ although being not involved in this link.

In other words, FIG. 11 shows an example of two communication links, each comprising one basestation and one UE. The communication links between these entities are shown as well as interference 42 between links, the so-called cross-link interference. Each network entity is an MLRD. Both active communication links and the cross-link interference may be observed by the MLRDs. As discussed, the MLRDs may observe or measure same or different parameters.

FIG. 12 shows a schematic block diagram of a wireless communication network 80 according to an embodiment. When compared to the wireless communication network 70, the wireless communication network comprises a number of at least two, at least three or at least four UEs. When compared to the wireless communication network 70, the devices 50₁ and 50₂ are implemented as UEs as well as UEs 50₃ and 50₄.

In other words, FIG. 12 shows an example of four UEs in which UE1 (50₁) and UE3 (50₃) and in which UE 2 (50₂) and UE 4 (50₄) form side link pairs. The communication between links between these entities may cause so-called cross-link interference. Each network entity is an MLRD. Both the active communication link and the cross-link interference may be observed by the MLRDs.

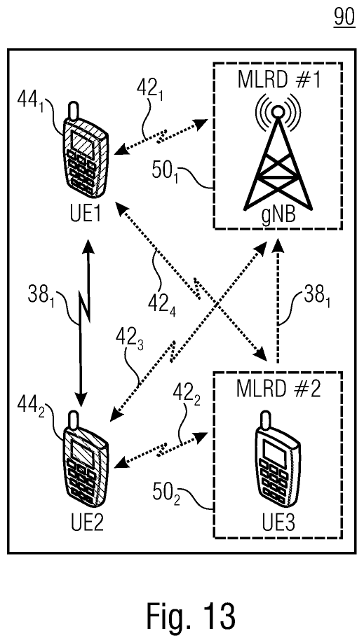

FIG. 13 shows a schematic block diagram of a wireless communication network 90 according to an embodiment. In the wireless communication network 90, device 50₁ being a basestation and device 50₂ being a UE are both operated as MLRD. Beside an exemplary uplink 38₁ from device 50₂ to device 50₁ a bidirectional sidelink 38₂ between mobile devices 44₁ and 44₂ is maintained in the wireless communication network. Interference 42₁, 42₂, 42₃ and 42₄ may be caused by any communication in the wireless communication network between any entity. For example, devices 42₁, and 42₂ may be implemented as a device 50. However, an orchestrating entity decides to only use device 50₂ as an MLRD which may also be referred to as extended sensor or external sensor. A device of network 90 may the device be configured for receiving information indicating a measurement result from another device and for generating a log so as to comprise the received measurement result. That is, another device may be used as external sensor.

In other words, FIG. 13 shows an example in which UE1, UE2 and UE3 (devices 44₁, 44₂ and 50₂) may be used as extended sensors or antennas of a network. For example, device 50₂ provides for an MLR functionality to the network via the gNB. A side-link connection between UE1 and UE2, link 38₁ may be present. Potential interference paths are indicated by interference 44₁ to 44₄. This interference may be measured, logged and reported by the MLRD 1 and MLRD 2, device 50₁ and 50₁.

Both, the first recognition and the second recognition may relate to obtain information associated with a link. The embodiments described relate to measure a radio link parameter.

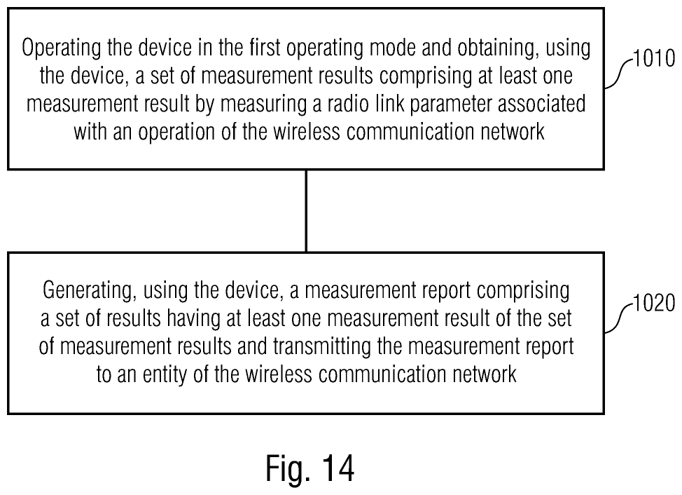

FIG. 14 shows a schematic flow chart of a method for operating a device in a bidirectional wireless communication network in a first operating mode in which the device is in a connected mode during a first time interval and in a second operating mode, in which the device at most performs passive communication during a second, different time interval. For example, method 1000 being illustrated may be used to operate device 11. Method 1000 comprises a step 1010 for operating the device in the first operating mode and obtaining, using the device, a set of measurement results comprising at least one measurement result by measuring or determining a radio link parameter associated with an operation of the wireless communication network. A step 1020 comprises generating, using the device, a measurement report comprising a set of results having at least one measurement result of the set of measurement results and transmitting the measurement report to an entity of the wireless communication network.

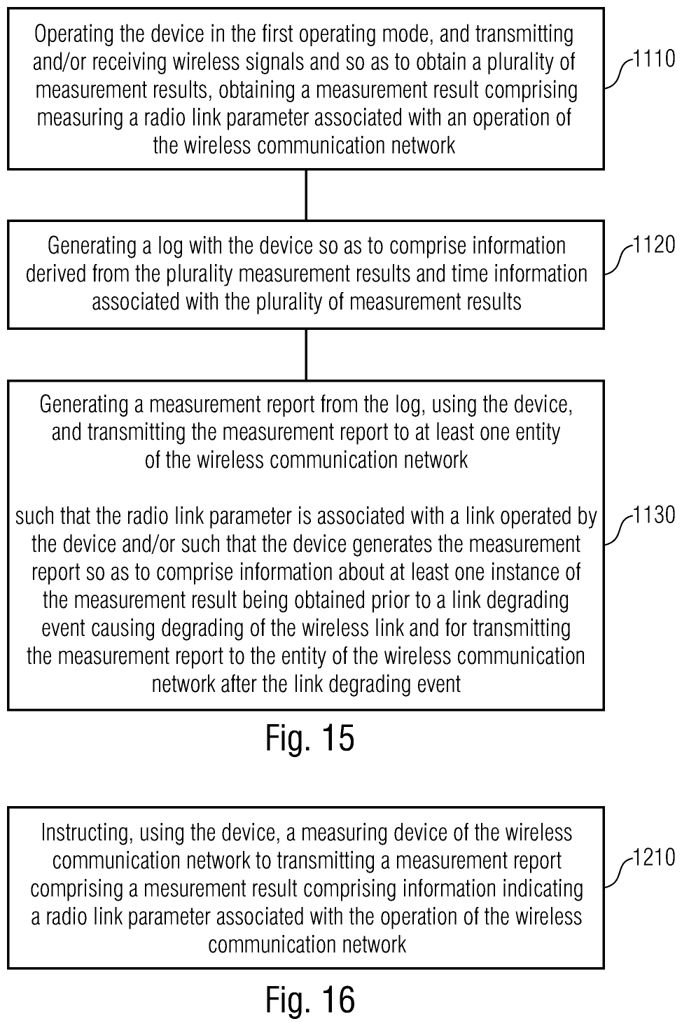

FIG. 15 shows a schematic flow chart of a method 1100 according to an embodiment. Method 1100 may be used for operating a device in a bidirectional wireless communication network in at least as first operating mode in which the device is in a connected mode, e.g., device 20. The method comprises a step 1110 comprising operating the device in the first operating mode, and transmitting and/or receiving a wireless signal and so as to obtain a plurality of measurement results, obtaining a measurement result comprising measuring or determining a radio link parameter associated with an operation of the wireless communication network.

A step 1120 comprises generating a log with the device so as to comprise information derived from the plurality of measurement results and time information associated with the plurality of measurement results. A step 1130 comprises generating a measurement report from the log, using the device, and transmitting the measurement report to at least one entity of the wireless communication network. Method 1100 is executed such that the radio link parameter is associated with a link operated by the device, association being performed by the wireless communication network and/or the operated device. Method 1100 is further executed such that the device generates the measurement report so as to comprise information about at least one instance of the measurement result being obtained prior to a link degrading event causing degrading of the wireless link and for transmitting the measurement report to the entity of the wireless communication network after the link degrading event as an alternative or an additional feature to the radio link parameter being associated with a link operated by the device.

FIG. 16 shows a schematic flow chart of a method 1200 for operating a device in a wireless communication network, for example, device 31. Method 1200 comprises a step 1210 comprising instructing, using the device, a measuring or determining device of the wireless communication network to transmitting a measurement report comprising a measurement result comprising information indicating a radio link parameter associated with the operation of the wireless communication network.

Embodiments allow for a plurality of advantages. For example, measurements are logged during active mode (currently they can be logged only in IDLE and INACTIVE state, or they can be collected and reported immediately in CONNECTED STATE). Embodiments allow to configure MLRDs to observe other communication links. Alternatively or in addition, multiple MLRDs can be used in an orchestrated, non-orchestrated, cooperative or collaborative manner. Alternatively or in addition, logging may be extended from observations from measurements of signals to logging instructions/requests/commands related to transmission and/or reception. Alternatively or in addition, logging may be extended from “being a response to a configuration” to “pseudo-permanent measurement and logging” towards keeping logs with higher sampling, density or precision on an “EVENT” and/or on an “COMMAND”. Alternatively or in addition, embodiments provide for solutions that will track and measure the appropriate parameters which will help to determine the root cause of link or beam failure.

Embodiments of this aspect may be formulated as:
Embodiment 1. A device (10) configured for operating in a bidirectional wireless communication network in a first operating mode in which the device is in a connected mode during a first time interval and in a second operating mode, in which the device at most performs passive communication during a second, different time interval;
   wherein, in the first operating mode, the device (11) is configured for obtaining a set of measurement results (15) comprising at least one measurement result by measuring or determining a radio link parameter (17) associated with an operation of the wireless communication network;
   wherein the device (10) (11) is configured for generating a measurement report (19) comprising a set of results having at least one measurement result of the set of measurement results and for transmitting the measurement report (18) to an entity of the wireless communication network.
Embodiment 2. The device (11) of embodiment 1, wherein the device (11) is configured for obtaining the set of measurement results (15) by measuring or determining at least one non-radio link parameter associated with the operation of the wireless communication network and for generating the measurement report so as to comprise information indicating the non-radio link parameter.
Embodiment 3. The device (11) of embodiment 2, wherein the device (11) is configured for generating the measurement report (18) so as to comprise the information indicating the non-radio link parameter and so as to not comprise the radio link parameter (17).
Embodiment 4. The device (11) of embodiment 3, wherein the device (11) is configured for not measuring or determining the radio link parameter (17) when generating the measurement report (18) so as to not comprise the radio link parameter (17).
Embodiment 5. The device of one of previous embodiments, wherein the device (11) is configured for measuring or determining a plurality of parameters comprising the radio link parameter (17) so as to obtain a plurality of measurement results; wherein the device (11) is configured for generating the measurement report (19) (18) by selecting for the set of measurement results (15) a subset of the plurality of measurement results.
Embodiment 6. The device (11) of embodiment 5, wherein the device (11) is configured for selecting the subset based on a selection signal received, the selection signal indicating the parameters that are requested to be measured and/or reported by the device.
Embodiment 7. The device (11) of one of previous embodiments, wherein the device (11) is configured for generating the measurement report as an immediate report.
Embodiment 8. The device (11) of one of previous embodiments, wherein the device (11) is configured for generating the measurement report as a report of a logged measurement.
Embodiment 9. The device of one of previous embodiments, wherein the device is configured for generating the measurement report so as to comprise information indicating the radio link parameter (17) and a time information (26) associated with a time the radio link parameter (17) was measured.
Embodiment 10. The device of embodiment 9, wherein the time relates to:
   a time reference of the device;
   a different time reference in the wireless communication network;
   a combination of multiple time references
Embodiment 11. The device of embodiment 9 or 10, wherein the time information (26) relates to an absolute and/or relative time measurement and includes information indicating a coherence time, e.g., of time reference grids, a variance, a fluctuation and/or a time drift.
Embodiment 12. The device of one of previous embodiments, being configured for obtaining a plurality of measurement results, wherein the radio link parameter(17) associated with the operation of the wireless communication network;
   wherein the device is configured for generating a log (24) so as to comprise information derived from the plurality of measurement results and time information (26) associated with the plurality of measurement results;
   wherein the device is configured for generating a measurement report (19) from the log (24) and for transmitting the measurement report (19) to at least one entity of the wireless communication network;
   wherein the radio link parameter (17) is associated with a link (38) operated by the device and/or
   wherein the device is configured for generating the measurement report (19) so as to comprise information about at least one instance of the measurement result being obtained prior to a link degrading event causing degrading of the wireless link and for transmitting the measurement report (19) to the entity of the wireless communication network after the link degrading event.
Embodiment 13. A device (20) configured for operating in a bidirectional wireless communication network in at least a first operating mode in which the device is in a connected mode;
   wherein, in the first operating mode, the device is configured for transmitting and/or receiving wireless signals and for obtaining a plurality of measurement results, obtaining a measurement result comprising measuring or determining a radio link parameter (17) associated with an operation of the wireless communication network;
   wherein the device is configured for generating a log (25) so as to comprise information derived from the plurality measurement results and time information associated with the plurality of measurement results;
   wherein the device is configured for generating a measurement report (19) from the log (24) and for transmitting the measurement report to at least one entity of the wireless communication network;
   wherein the radio link parameter (17) is associated with a link operated by the device and/or
   wherein the device is configured for generating the measurement report (19) so as to comprise information about at least one instance of the measurement result being obtained prior to a link degrading event causing degrading of the wireless link and for transmitting the measurement report to the entity of the wireless communication network after the link degrading event.
Embodiment 14. The device of embodiment 13, wherein the device is configured for generating the measurement report (19) so as to comprise information about at least one instance of the measurement result being obtained prior to a link degrading event causing degrading of the wireless link and for transmitting the measurement report (19) to the entity of the wireless communication network after the link degrading event; and wherein the link degrading event is an event causing a wireless link failure.
Embodiment 15. The device of one of previous embodiments, wherein the device is configured for generating a log (25) and for reporting the log (25) only in case a predefined triggering event occurs, e.g., a request or a link degradation.
Embodiment 16. The device of one of embodiments 13 to 15, wherein the device is configured to log measurements in a state of being active, inactive or idle in the wireless communication network.
Embodiment 17. The device of one of embodiments 13 to 16, wherein the device is configured for including, to the measurement indicated in the measurement report at least one of:
   an action in the wireless network determined by the device,
   an instruction recognized by the device,
   a request recognized by the device
   a command recognized by the device, and/or
   a configuration of the device and/or other devices
Embodiment 18. The device of one of embodiments 13 to 17, wherein the device is configured for logging the measurements in at least one of:
   a continuous manner;
   a timed manner (low-speed, high-speed, dynamic-speed),
   a sequenced manner,
   an ordered manner,
   a requested manner,
   a windowed manner,
   an instructed manner,
   an event-based manner,
   a trigger-based manner,
   a threshold-based manner and/or
   a programmed or scripted manner.
Embodiment 19. The device of one of embodiments 13 to 18, wherein the device is configured for logging measurements for the measurement report together with a header, identifier, marker or stamp containing one or more of:
   an absolute time;
   a relative time;
   a time relative to a slot,
   a frame or the start of service (uptime);
   a speed over ground;
   a location such as GPS/GNSS coordinates;
   an altitude;
   a cell ID;
   a beam ID;
   an antenna pattern;
   a cell sector;
   a service set identifier (SSID);
   an internet service provider (ISP);
   a pathloss model (PLM);
   a mobile network operator (MNO);
   a radio access technology (RAT) connection type such as 5G, 4G, 3G, 2G, Wi-Fi, Bluetooth, LORAN; and/or
   a service type such as VoIP, Video On Demand, augmented reality, virtual reality.
Embodiment 20. The device of one of embodiments 13 to 19, wherein the device is configured for receiving information indicating a measurement result from another device and for generating the log (25) so as to comprise the received measurement result.
Embodiment 21. The device of one of embodiments 13 to 20, wherein the device is configured for operating in the wireless communication network in the first operating mode in which the device is in a connected mode during a first time interval and in a second operating mode, in which the device at most performs passive communication during a second, different time interval;
   wherein, in the first operating mode, the device is configured for obtaining a set (15) of measurement results comprising at least one measurement result by measuring or determining the radio link parameter (17);
   wherein the device is configured for generating the measurement report (19) comprising a set of results having at least one measurement result of the set of measurement results.
Embodiment 22. The device of one of previous embodiments, wherein the device is configured for generating the measurement report (19) based on an report instruction signal (29) received with the device, the report instruction signal comprising information indicating a request to generate the measurement report.
Embodiment 23. The device of one of previous embodiments, wherein the device is configured for logging measurement results, wherein the device is configured for receiving a logging instruction signal (33) and for logging the measurement results based on the logging instruction signal.
Embodiment 24. The device of embodiment 23, wherein the logging instruction signal (33) comprises instructions relating to at least one of:
   a parameter to be logged;
   a parameter to be not logged;
   a time interval for which logging is performed;
   a number of measurements to be logged; and
   fallback options for one or more thereof.
Embodiment 25. The device of one of embodiments 22 to 24, wherein the device is configured for measuring parameters or determining based on parameters indicated in the report instruction signal (29) and/or indicated in the logging instruction signal (33); and/or
   wherein the device is configured for not measuring or determining parameters for which that device comprises measurement capability based on the report instruction signal (29) and/or the logging instruction signal (33).
Embodiment 26. The device of one of previous embodiments, wherein the device is configured for determining an event related to the operation of the wireless communication network and for logging the measurement result based on the determined event.
Embodiment 27. The device of one of previous embodiments, wherein the device is adapted to include, into the measurement report and associated with the radio link parameter (17) a non-link parameter.
Embodiment 28. The device of one of previous embodiments, wherein the device is configured for at least one of:
   generating and sending a report instruction signal (29) to a further device of the wireless communication network so as to indicate a request to measure and report at least one parameter;
   generating and sending a logging instruction signal (33) to a further device of the wireless communication network so as to indicate a request to log at least one parameter;
Embodiment 29. The device of one of previous embodiments, wherein the device is configured for including validity information into the measurement report, the validity information indicating a validity of the measurement.
Embodiment 30. The device of embodiment 29, wherein the validity information indicates at least one of:
   a time instance or time period the measurement was made;
   a resolution or accuracy of the measurement;
   a hardware used for the measurement;
   a distance to the source of the parameter to be measured;
   a certificate indicating a trustworthiness of the device (11).
Embodiment 31. The device of one of previous embodiments, wherein the device is configured for measuring a receiver related parameter as the radio link parameter; and/or to determining a transmitter related parameter as the radio link parameter.
Embodiment 32. The device of embodiment 31, wherein the device is configured for determining the transmitter related parameter as one or more of:
   Signals: e.g. embedded reference signals (RS), control signals, user plane signals, and/or other reference signals;
   Transmission related signals, e.g.,:
      digital signals to go through digital transmit processing prior to being converted from digital into analogue signal domain;
      Digital or analogue control signals applied for beamforming, e.g. phase shifters, delay lines, attenuators and the like
      Measured or captured signals, parameters from the transmitter chain, e.g. feedback signals for a digital pre-distortion (DPD) circuit/control of Self-interference-compensation (SIC) used for self- and/or adjacent channel interference cancelation/suppression or spurious emissions or out-of-band (OOB) radiation and/or adjacent channel leakage (ACLR) and the like.
   Transmit parameters such as a Cell-ID, a carrier frequency, beamforming weights, antenna parameters or the like
   Radio configuration parameters such as a minimum, maximum or actual number of retransmissions, one or more selected antenna panels, used or scheduled time and frequency resources, transmit scheduling information, transmission grants, uplink (UL)-downlink (DL) relations such as in time and/or frequency, e.g., for closed loop control messages, CFO-pre-compensation (CFO: centre/carrier frequency offset), a relationship between messages or settings within one or two directions;
   a velocity, a geo-location, an orientation of the entity/device or antenna panel and/or even non-radio link parameters described below.
Embodiment 33. The device of one of previous embodiments, wherein the device is to measure or determine the radio link parameter for at least one hop of a radio link in the wireless communication network.
Embodiment 34. The device of one of previous embodiments, being part of a link associated with the radio link parameter (17) as a transmitter, a transceiver, a receiver and a relay or being outside-of-the-link.
Embodiment 35. The device of one of previous embodiments, wherein the device is configured for measuring or determining the radio link parameter as at least one of
   a within-link parameter, e.g., information related to a packet error rate, a throughput, an automatic repeat request count (ARQ); and/or an hybrid automatic repeat request count (HARQ);
   an opposing-link parameter, e.g., information related to a cross-link interference (CLI); a signal-to-interference-noise ratio (SINR), an adjacent channel leakage ratio (ACLR) and/or a saturation;
   a signal power;
   a signal quality, e.g., a RSRP/RSRQ/SNR/SINR
   an outside-of-the-link parameter, e.g., information indicating a signal power of a signal, e.g., as a function of frequency (including bandwidth), a time, a resource block, a beam, a cell identification, a direction information such as an Angle of Departure (AoD) and/or an Angle of Arrival (AoA), e.g., with respect to a particular TX beam and/or RX beam.
Embodiment 36. The device of one of previous embodiments, wherein the device is configured to measure at least one of
   a PHY-layer parameter, e.g.,
      BER, BLER, MCS levels
      RSRP/RSRQ/SNR/SINR of beams measured on SSB, CSI-RS, SRS
      Beam numbers on SSB, CSI-RS, SRS;
   a higher layer parameter, e.g.,
      a number or ID of a serving or connected cell
      information indicating cells observed by the device
      a latency of communication
      a jitter
      a throughput of data
   as a radio link parameter.
Embodiment 37. The device of one of previous embodiments being configured for measuring or determining the radio link parameter and at least one of:
   an acoustic parameter such as sound, ultrasonic,
   a vibration parameter,
   a seismic parameter,
   a chemical parameter;
   an electric parameter such as electric voltage or current, electric potential,
   an electromagnetic parameter,
   a dielectric parameter,
   a radio parameter,
   a radar parameter,
   an environmental parameter, such as a weather parameter, moisture, humidity, visibility,
   a flow related parameter such as fluid velocity; gas flow;
   an ionizing radiation parameter,
   a parameter related to subatomic particles;
   a location-related parameter such as position, angle, displacement, distance, speed and/or acceleration,
   an optical parameter such as a colour/wavelength and/or magnitude of light,
   an imaging parameter,
   a lidar parameter,
   a photon parameter,
   a pressure parameter;
   a force parameter,
   a density parameter,
   a level parameter;
   a thermal parameter such as heat and/or temperature;
   a proximity parameter such as a presence or absence of bodies or objects
   information indicating a potential, a suspected or a known aggressor in view of the wireless communication.
Embodiment 38. The device of one of previous embodiments, wherein the device is configured for protecting a content of the measurement report (19).
Embodiment 39. The device of one of previous embodiments, wherein the device is configured for transmitting the measurement report (19) after a link degradation automatically or upon request.
Embodiment 40. The device of one of previous embodiments, wherein the device is configured for transmitting the measurement report (19) to at least one of a network entity, a communication partner, a next member of a defined group, a basestation, a mobile network operator (MNO), a server running over-the-top, a higher authority such as a regulator, an original equipment manufacturer (OEM) and/or a service provider.
Embodiment 41. The device according to one of previous embodiments, wherein the device is configured for including, to the measurement report (19) an information indicating a number of hops the measurement report is requested to be forwarded at maximum.
Embodiment 42. The device according to one of previous embodiments, wherein the device is configured for transmitting the measurement report (19) based on a respective request and for evaluating the request for a priority information; wherein the device is configured for transmitting the measurement report when the priority information indicates a priority of at least a predefined priority level and for not transmitting the measurement report when the priority information indicates a priority of less than the predefined priority level.
Embodiment 43. The device according to one of previous embodiments, being configured for measuring or determining the radio link parameter (17) for a plurality of cells of the wireless communication network, e.g., at least 64, at least 256 or at least 512 cells, the number of the plurality being adjustable.
Embodiment 44. The device according to one of previous embodiments, being at least a component of an apparatus implemented for flying, e.g., a drone.
Embodiment 45. The device according to one of previous embodiments, being configured for selecting, from a plurality of measurement results a subset of measurement results to be included based on at least one of:
   to include a predefined number of measurement results being ranked according to a ranking criterion such as distance, time lapsed, signal strength and reliability; and/or
   to select measurement results to be included that are in accordance with a predefined selection criterion such as a best result quality.
Embodiment 46. The device according to one of previous embodiments, being configured for measuring or determining at least one parameter during a time interval with a first accuracy and for measuring or determining the parameter during a second time interval with a second, higher accuracy.
Embodiment 47. The device of embodiment 46, wherein the device is configured to start the second time interval upon request or by determining a relevant event associated with the wireless communication network.
Embodiment 48. A device (31) configured for operating in a wireless communication network, wherein the device is configured for instructing a measuring or determining device of the wireless communication network to:
   transmitting a measurement report (19) comprising a measurement result comprising information indicating a radio link parameter associated with the operation of the wireless communication network.
Embodiment 49. The device of embodiment 48, wherein the operation of the wireless communication network relates to a wireless link of the device.
Embodiment 50. The device of embodiment 48 or 49, wherein the wireless link is a link of the measuring or determining device.
Embodiment 51. The device of one of embodiments 48 to 50, wherein the device is configured for evaluate the measurement report (19) for the radio link parameter (17) and for a non-link parameter associated with the radio link parameter; and to determine a reason being related to the non-link parameter that caused a degrading of the wireless link being indicated by the radio link parameter.
Embodiment 52. The device of one of embodiments 48 to 51, wherein the device is configured for instructing a plurality of measurement devices to perform measurements and for transmitting measurement reports (19), so as to orchestrate distributed measurements.
Embodiment 53. The device of one of embodiments 48 to 52, being a basestation of the wireless communication network.
Embodiment 54. The device of one of embodiments 48 to 53, wherein the device is configured for instructing the measuring or determining device of the wireless communication network to measure, from a plurality of parameters, a set of parameters comprising at least one parameter, the plurality of parameters including the radio link parameter; wherein the set of parameters is at least one of:
   predefined;
   defined dynamically; and/or
   selected individually.
Embodiment 55. A wireless communication network comprising:
   at least a first device according to one of embodiments 1 to 47 or a device according to one of embodiments 48 to 54; and
   at least a second device being a device according to one of embodiments 1 to 47 or a device according to one of embodiments 48 to 54.
Embodiment 56. The wireless communication network of embodiment 55, wherein the network is configured to perform a root cause analysis using the measurement report to analyse a cause for a link degrading event and/or to reconfigure the network to avoid or at least partly compensate for a link degrading event.
Embodiment 57. The wireless communication system of embodiment 55 or 56, wherein the network is to analyse a radio communication link associated with the radio link parameter (17) at
   a single end of the communication link;
   a first end and a second end of the communication link; and/or
   at least three ends of the communication link being a multi-hop link.
Embodiment 58. The wireless communication system of one of embodiments 55 to 57, wherein the wireless communication network is configured for analysing, e.g., after a link-degrading event and/or during a self-healing/optimization process before the link degrading event a relationship referring to one or more of:
   an uplink (UL)-downlink (DL) relation;
   a relationship between consecutively received signals; and
   a relationship between consecutively transmitted signals
Embodiment 59. The wireless communication system of embodiment 58, being configured for analysing the relationship between messages or settings within one direction, e.g., relative pointers/reference to messages, events, settings for uni-directional transmission/communication) and/or two directions, e.g., relative pointers/reference to messages, events, settings for bi-directional transmission/communication.
Embodiment 59. The wireless communication system of embodiment 57 or 58, being configured for analysing the relationship so as to comprise a cross-referencing between at least a first hop and a second hop of a multi-hop link.
Embodiment 60. The wireless communication system of one of embodiments 55 to 59, being configured for signalling that at least a portion of a link is of interest, e.g., the portion being considered to be weak, and to selectively provide for measurement or determining of the radio link parameter (17) and/or other parameters based on the signalling; wherein the network is adapted to provide and evaluate a respective log or measurement report to an analysing unit.
Embodiment 60a The wireless communication system of one of embodiments described herein, especially with in connection with IOND/MLRD devices, wherein the MLRD is measuring/monitoring and/or logging/capturing at least one interference source parameter associated with a receive beam pattern. An interference source parameter may relate to or may indicate one or more of a direction of interference, a timing of the interference, a polarization of an interfering signal, a frequency of an interfering signal, information related to physical PRBs and/or bandwidth parts. The network may assess the interference impact of other network devices to be (potentially) used for interference management, i.e., an estimation of the impact a change in the behaviour of the other device may have on the interference. This may allow for selecting appropriate steps to be done by assuming the impact a different behaviour, schedule, transmit power or the like will have, if applied so as to select an action for this device that provides for the desired effect. For example, a root cause analysis may support such evaluation. Such a network may be configured for measuring an interference source parameter related to a receive beam pattern of a device, e.g., an MLRD, and for assessing, with the MLRD and/or other entities of the network, an interference impact of at least one other device on interference management for the receive beam pattern, e.g., to decide about a control of the other device for the interference management, e.g., yes/no, an amount of adaptation or the like.
Embodiment 61. A method (1000) for operating a device in a bidirectional wireless communication network in a first operating mode in which the device is in a connected mode during a first time interval and in a second operating mode, in which the device at most performs passive communication during a second, different time interval, the method comprising:
   operating (1010) the device in the first operating mode and obtaining, using the device, a set of measurement results comprising at least one measurement result by measuring or determining a radio link parameter associated with an operation of the wireless communication network; and
   generating (1020), using the device, a measurement report comprising a set of results having at least one measurement result of the set of measurement results and transmitting the measurement report to an entity of the wireless communication network.
Embodiment 62. A method (1100) for operating a device in a bidirectional wireless communication network in at least a first operating mode in which the device is in a connected mode, the method comprising:
   operating (1110) the device in the first operating mode, and transmitting and/or receiving wireless signals and so as to obtain a plurality of measurement results, obtaining a measurement result comprising measuring or determining a radio link parameter associated with an operation of the wireless communication network;
   generating (1120) a log with the device so as to comprise information derived from the plurality measurement results and time information associated with the plurality of measurement results;
   generating (1130) a measurement report from the log, using the device, and transmitting the measurement report to at least one entity of the wireless communication network;
   such that the radio link parameter is associated with a link operated by the device and/or
   such that the device generates the measurement report so as to comprise information about at least one instance of the measurement result being obtained prior to a link degrading event causing degrading of the wireless link and for transmitting the measurement report to the entity of the wireless communication network after the link degrading event.
Embodiment 63. A method (1200) for operating a device in a wireless communication network, comprising:
   Instructing (1210), using the device, a measuring or determining device of the wireless communication network to:
   transmitting a measurement report comprising a measurement result comprising information indicating a radio link parameter associated with the operation of the wireless communication network.
Embodiment 64. A computer readable digital storage medium having stored thereon a computer program having a program code for performing, when running on a computer, a method according to one of embodiments 61 to 63.

Such information provided by an MLRD and/or requested from an MLRD may be incorporated, without limitation to the embodiments described below. For example, for handling or mitigating interference in accordance with embodiments, information received from and/or provided by a device operating, at least in parts, as an MLRD may be used. In different scenarios or operating modes of such an MLRD different kinds of information may be obtained. Further, for different solutions described below different types of information may be useful, some or all of them may be obtained from an MLRD.

### Evaluating the Interference

After having described the MLRD as a possible IOND, in the following, there is provided a description on how to use a combination thereof, i.e., of adapting the beam pattern and measuring the network activity or condition, e.g., for controlling, estimating or reducing cross-link interference.

Embodiments are related to identifying, characterising or otherwise quantifying the interference so as to allow mechanism for mitigating interference to work precisely.

The present invention concerns the measurement and more importantly, the reporting of two forms of interference that affect the performance of wireless communication systems; inter-cell interference (ICI) and cross-link interference (CLI).

ICI is an inherent problem of cellular communication. It occurs when the adjacent cells use the same frequency resources, which affects signal quality of active users, especially at a cell-edge. This deterioration of UEs' SINR leads to a significant degradation in throughput and user experience. ICI affects both—TDD and FDD systems.

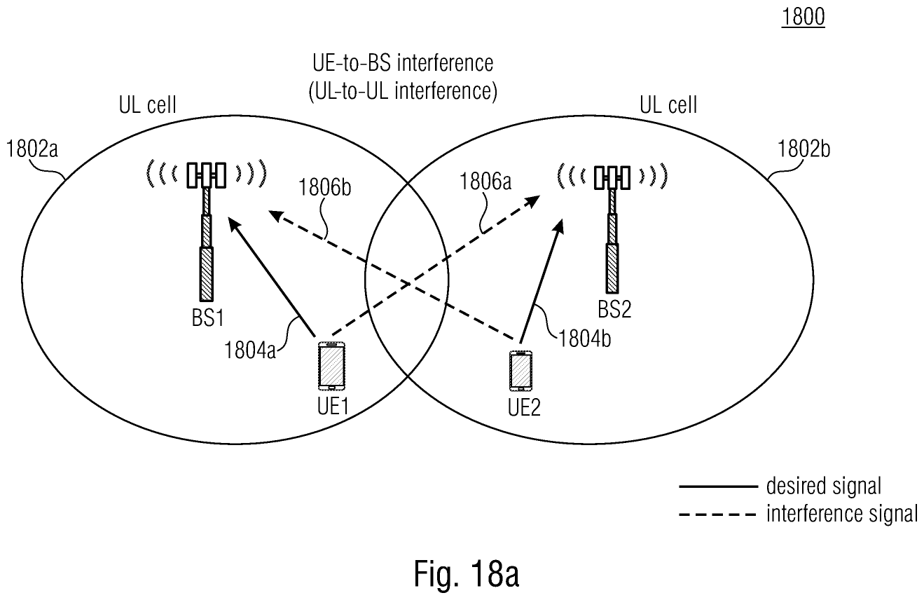

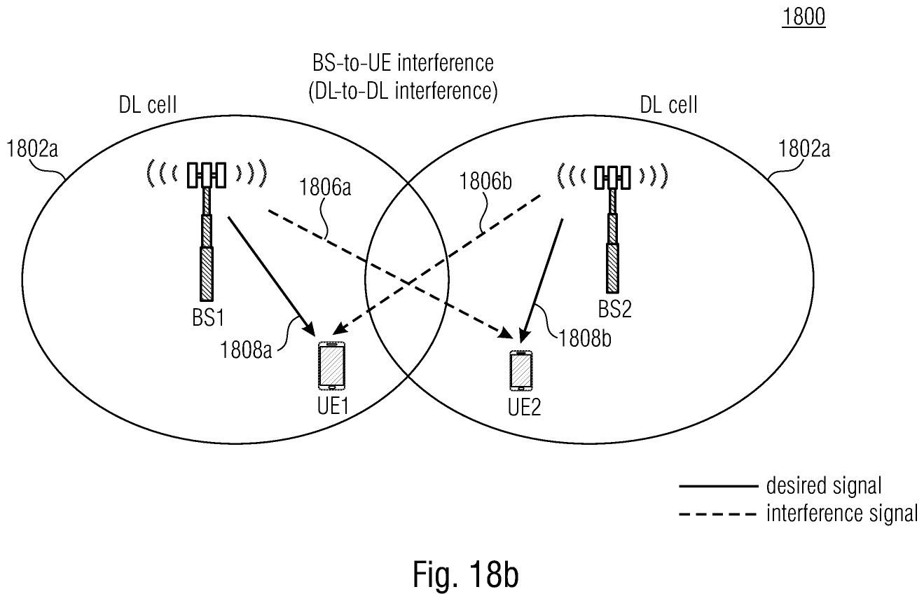

FIG. 18a/b depicts the cases of ICI in UL and DL slots in static TDD systems. Static TDD (S-TDD) needs the UL/DL subframe configurations of all cells using the same frequency band to be synchronized. ICI is a well-studied topic and various techniques to tackle ICI are a part of standardization since LTE/LTE-Advanced, such as ICI coordination (ICIC), enhanced ICIC (eICIC), and coordinated multipoint (CoMP).

FIG. 18a shows a schematic block diagram of a part of a wireless communication network 1800 that may form at least a part of embodiments described herein. As described in connection with the prior aspects, the wireless communication network 1800 may comprise one, two or more cells, e.g., cells 1802a, 1802b. In the illustrated scenario, both cells 1802a and 1802b may form an uplink, UL, cell. For example, UE 1 may transmit an uplink signal 1804a to its base station BS 1 and UE 2 may transmit an uplink signal 1804b to its base station BS 2. Those transmissions may form a desired signal but may also provide for unwanted interfering signals 1806a, 1806b, respectively. UE 1 being operated by BS 1 in cell 1802a may, thus, interfere BS 2 of a different cell and/or UE 2 operating in cell 1802b may interfere BS 1 of cell 1802a. The interfering signals 1806a and 1806b thus provide for an example for an inter-cell interference as a UE-to-BS interference occurring in UL slots, e.g., in an S-TDD system.

FIG. 18b shows a schematic block diagram of the wireless communication network 1800 during a downlink, DL, slot. There, a transmission of downlink signals 1808a of BS 1, of downlink signal 1808b of BS 2 respectively to the associated UEs UE 1 and UE 2 may cause interference 1806a and 1806b at the respective other UE. This may be referred to as BS-to-UE interference or as DL-to-DL interference.

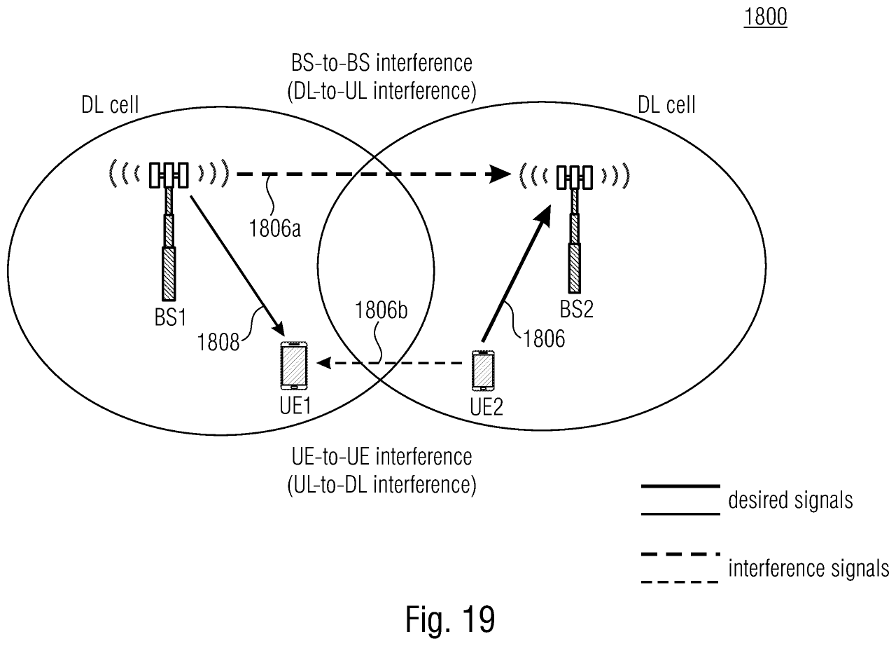

Cross-link interference occurs in dynamic TDD systems, where adjacent cells use different transmission directions, as can be seen in FIG. 19 showing examples of CLI [21]. Dynamic TDD systems improve spectrum utilization and enable flexible adaptation to varying traffic patterns. However, CLI remains of the major challenges. FIG. 19 shows a schematic diagram of a wireless communications network 1900 for representing a cross link interference (e.g., BS-to-BS interference/DL-to-UL interference and UE-to-UE interference/UL-to-DL interference.

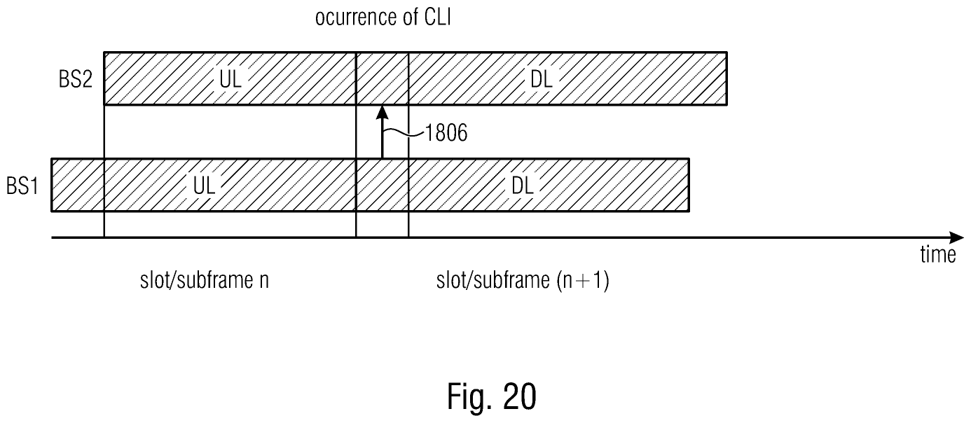

CLI can also occur in cases where adjacent cells are not synchronised and where a part of the frame uses the opposite direction, as depicted in FIG. 20 illustrating an example of occurrence of CLI in an asynchronous network, e.g., network 1800 or 1900. Although the transmission directions the same for the same subframe, CLI can occur if different transmission directions partially overlap.

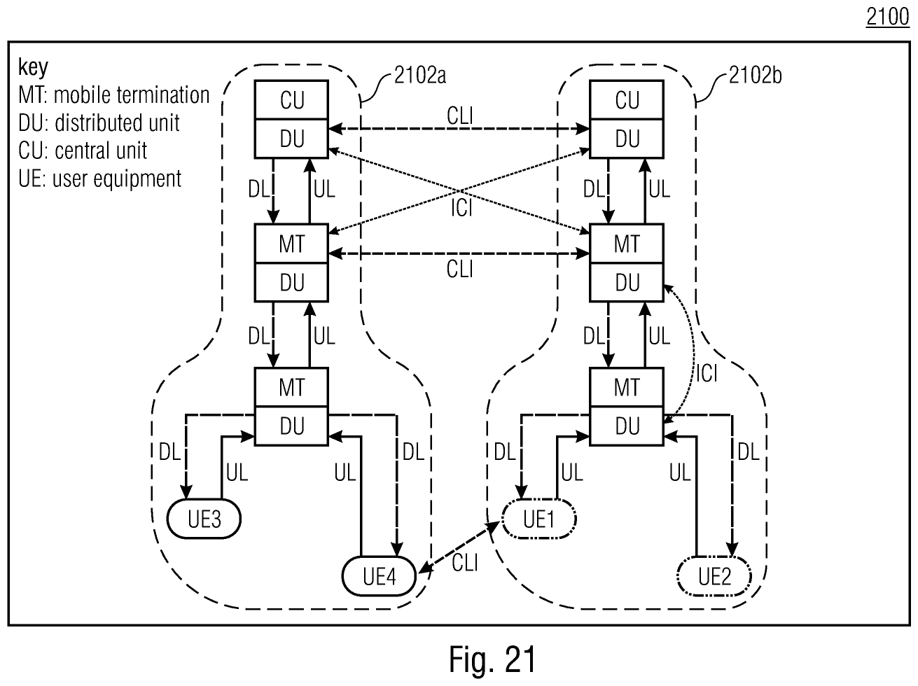

In integrated access and backhaul, IAB, networks, where traffic is carried over multiple hops, both ICI and CLI pose challenges. FIG. 21 depicts an IAB network 2100 comprising two (or more) adjacent, independent trees 2102a and 2100b. It should be noted that IAB network facilitates split gNB architecture with a central unit (CU) and distributed units (DUs).

A DU typically houses PHY, MAC and RLC layer, while the layers PDCP and above are located in the CU. This also means that the radio resource control (RRC) functions are located in the CU. An IAB node, on the other hand, consists of a mobile termination (MT) part, as well as a DU part. The MT connects to the CU or to another DU, whereas the DU consists of a base station part which can assign radio resources to MTs or UEs.

Returning to Fehler! Verweisquelle konnte nicht gefunden werden. FIG. 21, in each of the trees 2102a and 2102b, there are three hops between a UE and a gNB CU. The cases of ICI are experienced in DL at each hop by the receiving UEs and MTs when adjacent DUs are transmitting. Similarly, on the UL, the receiving DUs will experience ICI, caused by the adjacent transmissions by the UEs and MTs. It should be noted that the UL ICI issues in IAB networks are more severe than in non-IAB networks, as the power levels by the IAB-MT are significantly higher than those of UEs. CLI in IAB networks also occurs due to the neighbouring cells using the opposite direction transmission/reception, as is described in more detail in the section “challenges”. In summary, in a multi-hop IAB network, the communication between a UE and CU/core network can be affected by ICI and CLI that can occur on any of the hops. Hence, CLI and ICI aspects are of particular importance due to the introduction of a) IAB nodes and b) flexible TDD structure.

With regards to (a), the inventors have identified that cases of CLI in IAB networks are not sufficiently covered by the current CLI framework. On the other hand, with regards to (b), the current CLI framework addresses the issues created by flexible TDD structures. However, the framework relies on a backhaul-based coordination between the gNBs, which introduces delays. Furthermore, when flexible TDD is combined with the deployment of IAB nodes, the inventors have identified limitations in the current ICI and CLI frameworks. Furthermore, the current CLI (or ICI framework for that matter) does not address the case when adjacent nodes belong to different operators. Although in such cases, the power levels are smaller, the adjacent channel interference need to be considered. The current invention disclosure is concerned with these problems and corresponding solutions.

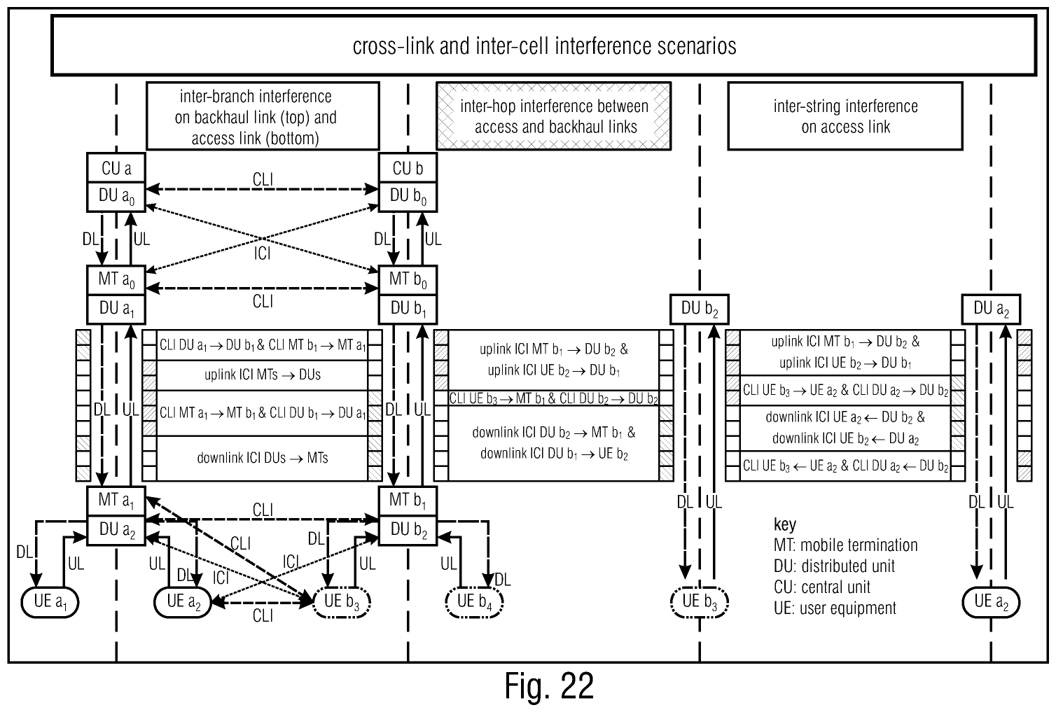

FIG. 22 is an extension of FIG. 21 which illustrates ICI and CLI in more detail. This is done for three example scenarios: “Inter-branch (or inter-tree) interference on backhaul and access link”; “Inter-hop interference between access and backhaul links”; and “Inter-string interference on access link”. The scenarios illustrate how interference could affect inter-branch, inter-hop and inter-string communication in either both the backhaul and access links (the first two cases) or in the access link only (the third case). FIG. 22 uses a frame-like structure (shown as a vertical stack of ten coloured squares) to illustrate how uplink and downlink collisions could occur between different network entities due to scheduling conflicts. For example, and with reference to the first scenario, the TDD frame patterns show correct scheduling between the downlink and uplink of DU a1 and MT a1 whereas in contrast however, the same scenario reveals collisions in the uplink and downlink frame patterns of MT a1 and DU b2. Similar effects are shown for the third scenario—UE b3 and DU a2. Details of the interference mechanism and the affected entities are presented in the text boxes between the frame patterns.

In other words, FIG. 22 shows an illustration of CLI and inter-cell interference in a multi-hop IAB network.

Challenges

In connection with the IAB nodes and CLI, there is an ongoing discussion in 3GPP RAN1 R1-2101878 [22] on the enhancements of the CLI framework, addressing some of the CLI cases that occur in IAB networks. Current CLI framework does not address all the use cases that exist in IAB networks.

Based on the discussion thus far in [22] and other relevant references, the inventors have identified the following specific challenges of particular interest to consider in the invention:

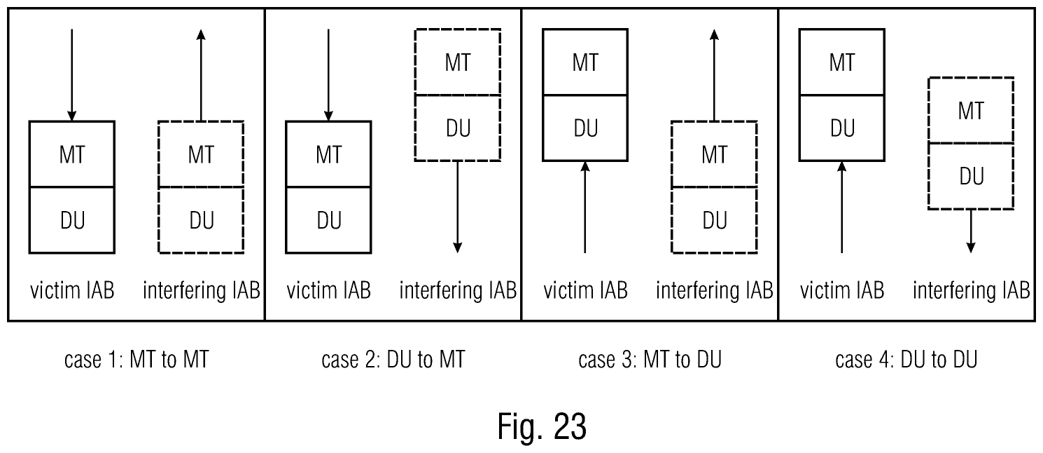

For representing different cases of CLI in an IAB network, reference is made to FIG. 23 showing a case 1 as an MT-to-MT CLI, a case 2 as an DU-to-MT interference, a case 3 as an MT-to-DU interference and a case 4 as a DU-to-DU interference as 3GPP-identified CLI interference cases in IAB networks.

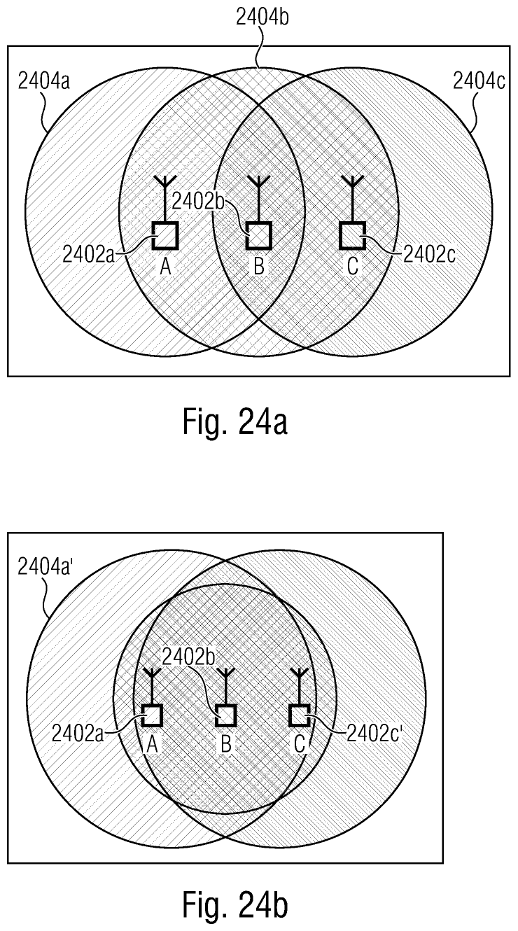

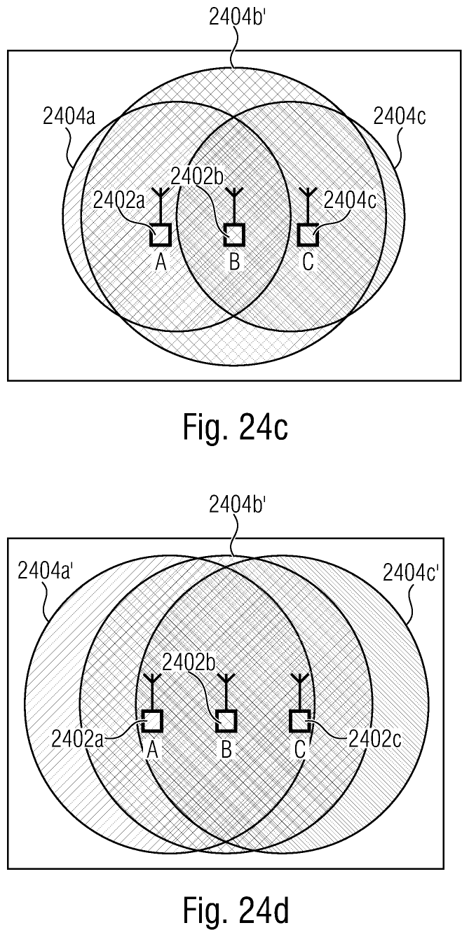

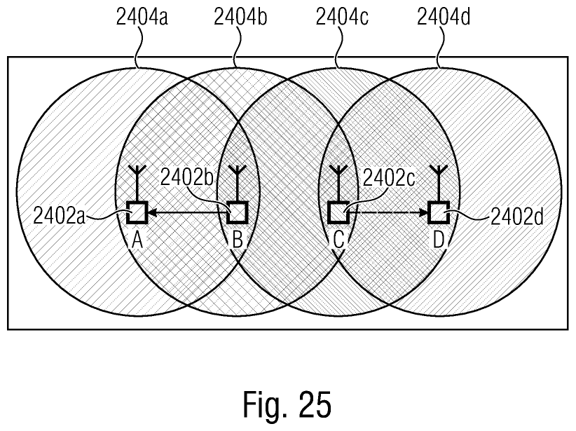

Challenges:
1. MT-MT interference (Case 1). Although current CLI framework (UE-UE case) can be used to mitigate CLI interference between different MTs, MTs have higher power and the interference effect has a potential to seriously degrade the downlink reception of the victim MT.
2. MT-DU interference (Case 3). Here, interfering MT is transmitting and victim DU is receiving. This case is analogous to a conventional case of UL UE interference on the base station. However, the power levels of IAB-MT are higher and thereby, the resulting interference.
3. DU-DU (Case 4) CLI framework currently does not address this case in the context of IAB network. Furthermore, while frame coordination could be performed between the neighbouring nodes using proprietary protocols, interference coordination between the nodes has to operate in multi-vendor deployments.
4. Classification of measurements/mitigation techniques based on the type of IAB-MT. Wide Area IAB-MT are characterised by requirements derived from Macro Cell and/or Micro Cell scenarios. Local Area IAB-MT are characterised by requirements derived from Pico Cell and/or Micro Cell scenarios.
5. Quantifying the measurement accuracy of CLI. In [23], it was pointed out that the CLI measurement accuracy of SRS RSRP could be degraded due to factors like network synchronisation error, unknown propagation delays between the IAB nodes, smaller CP duration in FR2, different timing alignment across nodes, large distance between child and parent node etc.
6. L2 vs L3 measurements/reporting—Current CLI measurements are L3 CLI measurements—they are longer-time scale measurements and are configured by and reported to the CU/gNB [24].
7. Differentiating between access and backhaul, as some interference cases affect access links more
8. Self-interference measurement, logging, reporting and mitigation. Self-interference occurs when a device operates simultaneously in Tx and Rx mode in the same or different carriers, sub-carriers, resource blocks or bandwidths parts running in different UL or DL slots, This is caused by reflections (from objects in the propagation environments and in-device/base station leakage). It is associated with , full-duplex operation and/or device malfunction.
9. The so-called hidden terminal and exposed terminal problems (described below in connection with FIG. 24a-d and FIG. 25)

As outlined earlier, in inter-MNO environment, currently no mechanism can be assumed for the exchange of reference signal configurations and coordination of transmissions that can address some of the above-described cases.

Furthermore, some of the above challenges are not only related to IAB network, but also to UE the CLI framework, for example, Challenges 5 and 6 in the list above.

The performance of a wireless communication system (WCS) can be affected by the so-called hidden terminal (or node) problem and by the so-called exposed terminal (or node) problem. Since these problems are well-known—especially in the context of wireless local area networks (WLAN)—and as state-of-the-art and standardized solutions exist, the hidden terminal and exposed terminal problems are presented here together with the SOTA solution.

As discussed already above, the inventors have identified certain problems which are not address by the current SOTA solutions described in this section. Potential solutions are thus presented in section “Solutions”.

The Hidden Terminal Problem

Although cellular networks do not typically operate in listen before talk, LBT, mode (except in the special case of NR-U), in dynamic TDD due to CLI and considering that not every gNB/IAB node is aware of scheduling decisions of other nodes, the associated challenges can be viewed similarly to the problems of hidden or exposed terminals.

In a WCS that provides communication between a number of terminals or nodes, using Carrier sense multiple access with collision detection (CSMA/CD), the hidden terminal problem occurs when a first node is visible to a second node but is not visible to at least a third node that communicates with the second node. This can occur in a WCS that does not provide the means for controlling transmissions from the different nodes.

To illustrate the problem, FIG. 24a shows three terminals 2402a (A), 2402b (B) and 2402c (C) and their coverage areas 2404a, 2404b, 2404c respectively (shown by overlapping circles with different shadings).

Here node B is in the coverage area of both nodes A and C. On the other hand, nodes A and C are out of range of one another and therefore are said to be hidden (from one another). Now suppose that nodes A and B have established connection and are transferring communication information between themselves and that during this communication, node C, which is not aware of the ongoing communication, attempts to establish a connection to node B. As the new transmissions from node C to node B could collide with the established transmissions between nodes A and B, the need to control or otherwise coordinate transmissions from multiple nodes is identified.

In other words, FIG. 24a shows a pictorial representation of the hidden terminal problem in which three terminals or nodes and their coverage areas are shown. These coverage areas reveal that even though both nodes A and C are visible to node B, they are hidden from one another.

Solution of the Hidden Terminal Problem

The solutions that address the hidden terminal problem are now discussed, as some of them can be considered how to be applied to address the challenges of CLI.

1. Increasing Transmitting Power

In order for a hidden node to become visible—and therefore for it no longer to be hidden—its coverage area needs to be extended. This can be achieved by increasing the transmission power of a “hidden” node which enables the non-hidden nodes to detect, or hear, the (previously) hidden node—see FIG. 24b. In the scenario shown in FIG. 24b, the transmission power and hence the coverage area of both nodes A and C are increased to coverage areas 2404a′, 2404c′ respectively whilst that of nodes B is left unchanged. The increased coverage of nodes A and C makes them visible to one other and they are therefore no longer hidden.

It should be noted that the hidden terminal problem is not however solved by increasing the transmission power and hence the coverage area of a non-hidden node (node B) only, see FIG. 24c where the transmission power and hence the coverage area of only node B is increased to coverage area 2404b′ whilst that of nodes A and C is left unchanged meaning that they remain hidden from one another.

If the transmission power of all nodes is increased—as shown in FIG. 24d—then the hidden terminal problem is also solved. However, as explained earlier in connection with FIG. 24b, when the coverage range of the non-hidden node (node B) is increased, so too is the chance of creating new hidden nodes (for example nodes D and E which are not shown in the figure). Since the new nodes D and E are in the extended coverage area of node B and could hence establish communication with node B, but are not in the coverage area of nodes A and C, then nodes A, C, D and E could be hidden from one another.

In practice, nodes A and C could be user equipment devices whereas node B could be a basestation or an access point. Increasing the transmission power at the latter is more likely to create problems for other users because it puts them in range of the access point and thus add new nodes to the network that now become hidden from other users.

2. Antenna Patterns

The radiation pattern of an antenna describes the way in which it spatially emits energy and, by reciprocity, the way in which it spatially collects energy. An antenna with a so-called directional pattern directs or collects energy in a given direction with preference to other directions. On the other hand, an antenna that radiates uniformly—albeit at least in one plane—is described to have an omni-directional pattern.

In the context of the hidden terminal problem, an antenna's directivity affects its visibility to other nodes. Therefore, devices which are equipped with directional antennas are more likely to create hidden nodes than those devices fitted with omni-directional antennas. In view of this, it would seem appropriate to favour omni-directional patterns over directional patterns. However, while coverage is improved—at least in the sense that this is provided more uniformly—the link distance that can be supported is easily reduced. A mechanism is therefore needed to solve the hidden terminal problem when created as the result of a directional pattern. Such a mechanism is provided by the present invention.

3. Obstacles

To some users, an otherwise omni-directional antenna pattern might be observed as being directional due to the presence of an obstacle, for example a structure such as a building, an office partition, a vehicle or a person. Therefore, and with similarity to the directional antenna pattern described earlier, obstacles can conceal the presence of a terminal from other terminals, thus creating a hidden terminal.

A potential solution to the problem of the hidden terminal created as the result of obstruction, is to move or remove the obstacle. For practical reasons however, this is not always possible. Alternatively, an increase of transmission power might also be effective if the losses introduced by the obstruction can be overcome. For building materials, such as stone, brick, concrete, steel and metalized glass, this might not be possible. An increase of transmission power can however create new hidden names as described in Section 1 explaining the effects of increasing the transmission power.

4. Moving the Node

A device that is otherwise hidden to certain devices could become visible (or unhidden) by moving the device to a new location so that it is in range and therefore visible to the other devices. Similarly, a device that is equipped with an antenna whose pattern is directional, could become visible to previously hidden devices by reorientating the device accordingly. Furthermore, a device that is equipped with an antenna whose pattern is reconfigurable, could adapt its antenna characteristics so that it is visible to other devices.

5. Protocol Enhancement

Software-based techniques can be used to implement polling or token passing strategies whereby a master (for example, an access point) dynamically polls client devices. These clients may only send data when invited by the master, thus eliminating the hidden node problem at the cost of increased latency and less maximum throughput.

A further protocol example is that of handshaking. In Wi-Fi standard IEEE 802.11, the medium access control (MAC) protocol is used together with request-to-send/clear-to-send (RTS/CTS) messaging. Here, client devices that wish to send data to the access point first transmit an RTS packet to the access point (AP) and, when the AP is ready to communicate with the client that sent the RTS packet, it then sends a CTS packet, thus allowing communication between the two devices. As the overhead for short packets can be quite large, handshaking is often not used, especially when the minimum size is configurable. In order for RTS/CTS to work efficiently, all stations have to be time-synchronized and the length of the data packets exchanged, have to match those indicated in the RTS/CTS.

The Exposed Terminal Problem

The exposed terminal or exposed node problem occurs in a WCS when one node is prevented from sending packets to other nodes because of (the risk of) co-channel interference with a neighbouring transmitter.

The exposed node problem is illustrated in FIG. 25 which comprises four devices 2402a-d with similar coverage areas 2404a-d that overlap with their closest neighbour(s). A first communication link is established between devices A and B in which the latter is transmitting while the former is receiving. At some time during the first communication, an attempt to establish a second communication between devices C and D is made. However, device C detects the transmission from device B and therefore does not activate its own transmission due to the risk of creating co-channel interference with the first communication even though receiving device D is out-of-range of transmitting device B (and, a link was to be made, receiving device A would be out-of-range of transmitting device C).

In other words, FIG. 25 shows a pictorial representation of the exposed terminal problem in which four devices form part of a wireless communication network. Due to the communication between one pair of devices—for example devices A and B—a second communication between devices C and D might not be prevented due to the risk of co-channel interference between devices B and C even though device B and D are out-of-range of one another.

Solution of the Exposed Terminal Problem

The IEEE 802.11 RTS/CTS mechanism discussed earlier helps to solve the problem of the exposed terminal but only if the nodes are synchronized and packet sizes and data rates are the same for both the transmitting nodes. When a node hears an RTS from a neighbouring node, but not the corresponding CTS, that node can deduce that it is an exposed node and is permitted to transmit to other neighbouring nodes. On the other hand, if the nodes are not synchronised (or if the packet sizes are different or the data rates are different) the problem may occur that the sender will not hear the CTS or the acknowledge (ACK) during the transmission of data from the second transmitting device. In cellular networks, power control is used to avoid the problem of the exposed terminal.

Standardization in 3GPP

Background of CLI Framework

In the current CLI framework in Release 16 [25], 2 metrics of CLI measurement exist:
RSRP (SRS selective) and
RSSI (integrated interference power)

RSRP relies on the same SCS between the aggressor and the victim. RSSI measurements can be done with any combinations of SCS of own BS and interfering link.

To mitigate CLI, gNBs can exchange and coordinate their intended TDD DL-UL configurations over Xn and F1 interfaces; and the victim UEs can be configured to perform CLI measurements. There are two types of CLI measurements:
SRS-RSRP measurement in which the UE measures SRS-RSRP over SRS resources of aggressor UE(s). The interferers' SRS configuration parameters include parameters, such as the number of symbols, comb structure, cyclic shifts of root Zadoff-Chu sequence etc.
CLI-RSSI measurement in which the UE measures the total received power observed over RSSI resources. RSSI measurements represent the linear average of the total received power (in [W]) observed only in certain OFDM symbols of measurement time resource(s), in the measurement bandwidth, over N number of resource blocks from all sources, including co-channel serving and non-serving cells, adjacent channel interference and thermal noise.

Layer 3 filtering applies to CLI measurement results, and both event triggered and periodic reporting are supported. According to [26}, Sec. 17.2:
CLI measurements are only applicable for RRC_CONNECTED intra-frequency [27], Sections 5.1.19 and 5.1.20:
   when SRS-RSRP measurement resource is fully confined within BW of DL active BWP
   the requirements apply when the subcarrier spacing for SRS-RSRP measurement resource configuration is the same as the subcarrier spacing of the active DL BWP of serving cell.
when CLI-RSSI measurement resource is configured within active BWP
   the subcarrier spacing for CLI-RSSI measurement resource configuration can be same or different from the subcarrier spacing of active BWP. UE shall perform CLI-RSSI measurement with the SCS of the active BWP.

### Details on Embodiments

It is to be noted that, within this document, interference mitigation and interference management are used interchangeably.

As outlined in above, the current CLI framework for BS-BS interference is relying on a backhaul-based coordination between the gNBs to tackle CLI for gNBs and UEs alike. In addition to the delay on the backhaul between e.g. DUs and CUs to coordinate transmission/reception patterns, in an IAB network, there may be several hops between the reporting MT/DU and CU, which further increases the delay. Hence, there is a complexity and cost associated with the coordination-based mechanisms between adjacent cells. The complexity becomes even greater when adjacent cells belong to different MNOs. Hence, this invention proposes a 2-step interference management/mitigation framework, which enables UEs/IAB-MTs with specific capabilities to tackle interference on two levels:

Long-term interference which will be called strategic interference handling and short-term interference mitigation which will be called tactical interference handling. The naming relates to the time scales indicating that a strategic interference handling will allow the exemplary two interfering systems to coordinate the used radio resources such that a maximum number of independent scheduling decisions can be facilitated while at the same time remaining resource contention/collisions can be resolved by a reasonable amount of tactical (short-term) interference handling methods. The overall purpose of such two layered interference handling method is the intention to support distributed decision making as much as possible and resolving remaining interference issues locally if possible at lowest level between the interference source and the interference victim. This becomes in particular important for the CLI channel at the terminal/device side since device distribution and associated inter-device CLI is a-priori unknown and even if known after an initial observation may change over time due to device mobility and the independent scheduling decisions of different base stations.

Long-term interference mitigation is usually handled at layer 3 (L3) of the protocol stack according to mechanisms specified e.g. in 3GPP, where statistical averaging of measurement reports are performed. Long-term interference mitigation is, therefore, expected to operate on longer time-scales, in the order of seconds, minutes or longer. On the other hand, short-term interference mitigation is usually handled at layer 1 and 2 (L1/L2) of the protocol stack, and is expected to operate on time scales between a few to hundreds of milliseconds, or even microseconds, to sometimes even seconds.
Long-term interference mitigation (strategic) may be based on
   Reporting by the UE or IAB-MT to the gNB, which acts on the reported interference
   Observation/measurements of CLI by the UEs/devices/nodes including resulting statistics e.g. Interference temperature, periodicity of CLI events, spectral, temporal, or spatial signatures of interference sources.
Short-term interference mitigation (tactical) may include or be based on
   Enhanced LBT mechanisms
   Adaptation of receive spatial filters (antenna pattern adaption) or spectral filters (RF-filters)
   Spatial pre-emption

An example can be given with scheduling users onto the slots that overlap in direction (by different MNOs). If the users can tackle the interferences between themselves (i.e. tactically), they do. Otherwise, they report to their base station. In brief this means, as long as the capability of the device/node and/or the channel conditions allow for a local interference suppression method by the device/node itself it will do so, provided sufficient knowledge about the interference signal, which includes interference channel, interference source or structure of the interference. If local self-contained interference suppression is infeasible or doesn't result in the needed interference suppression level, the interference source should be requested to mitigate interference by changing/adapting its transmission strategy. In order to facilitate such supporting action the device/node can either directly communicate with the interfering source and/or inform its own serving base station/communication partner about the interference source or other descriptive identifiers/parameters enabling identification of the identity of the interferer. Furthermore, the victim device/node can contact/communicate with the serving BS/communication partner of the interferer in order to request/trigger a change/adaptation of transmit strategy of the interferer. Also, if patterns causing interference can be recognised, shifting TDD structure can be also performed either by the victim's or interferer's BS.

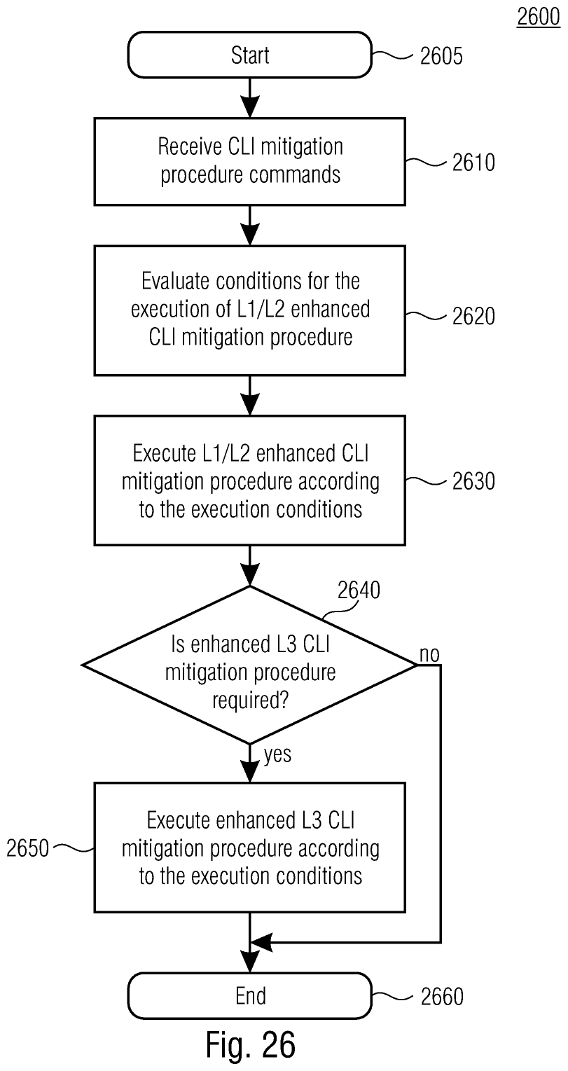

FIG. 26 shows a schematic flow chart of a method 2600 according to an embodiment. FIG. 26 provides a high-level overview of the enhanced procedure for CLI interference management procedure 2600 according to an embodiment, focusing on the UE/IAB-MT case. In the first step 2610 after a start 2605, the UE receives enhanced CLI mitigation commands. The commands include CLI measurement configuration and the execution conditions for the enhanced CLI mitigation procedure(s). The UE then evaluates the conditions for the execution of L1/L2 enhanced CLI mitigation procedure(s) in 2620. Alternatively, the UE can receive a notification signal, based on e.g. regular UE measurement reporting, that the conditions for triggering L1/L2 enhanced CLI management procedure(s) are met.

If, following the execution of L1/L2 CLI mitigation procedure(s) in 2630, conditions that warrant additional, enhanced L3 CLI mitigation procedure(s) still exists which is determined in 2640, the UE proceeds with their execution in 2650. Otherwise, the procedure is completed, 2660.

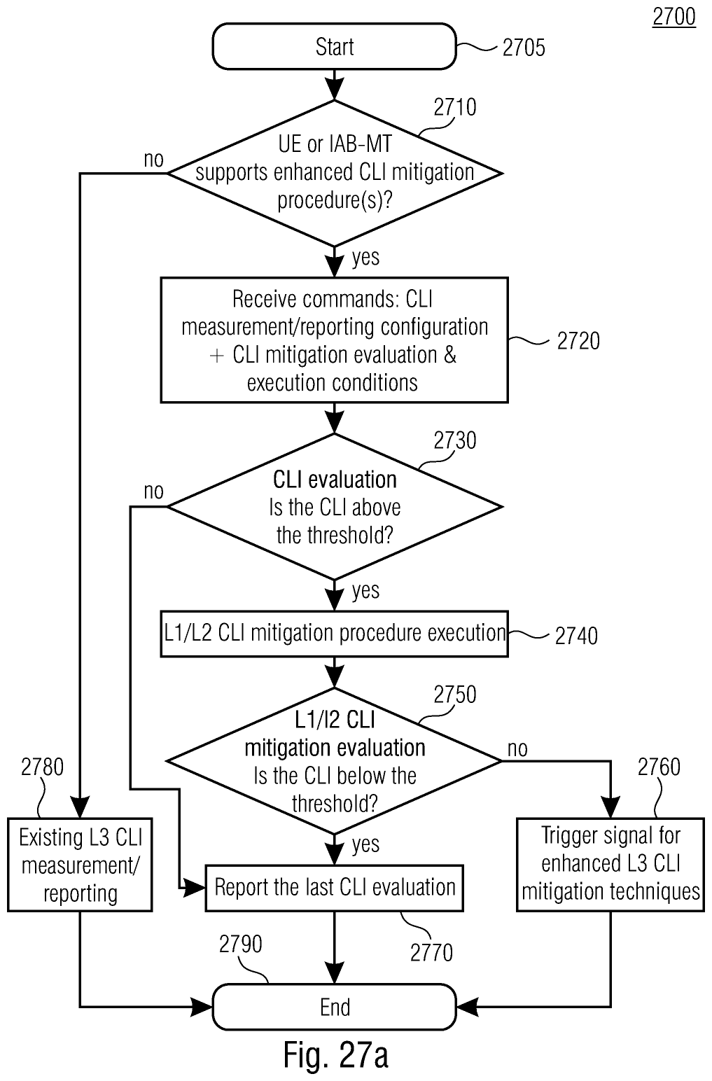

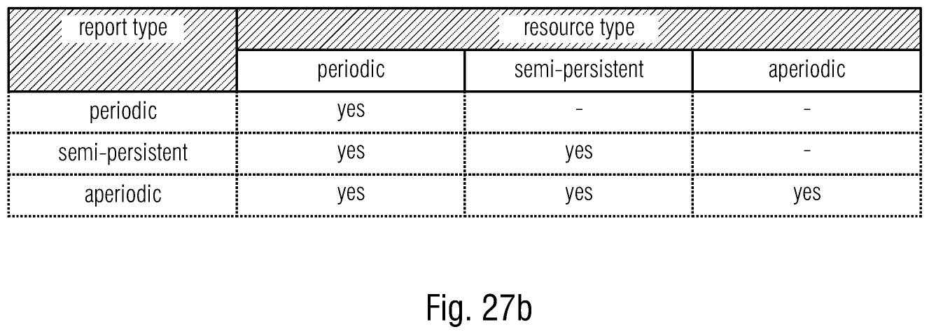

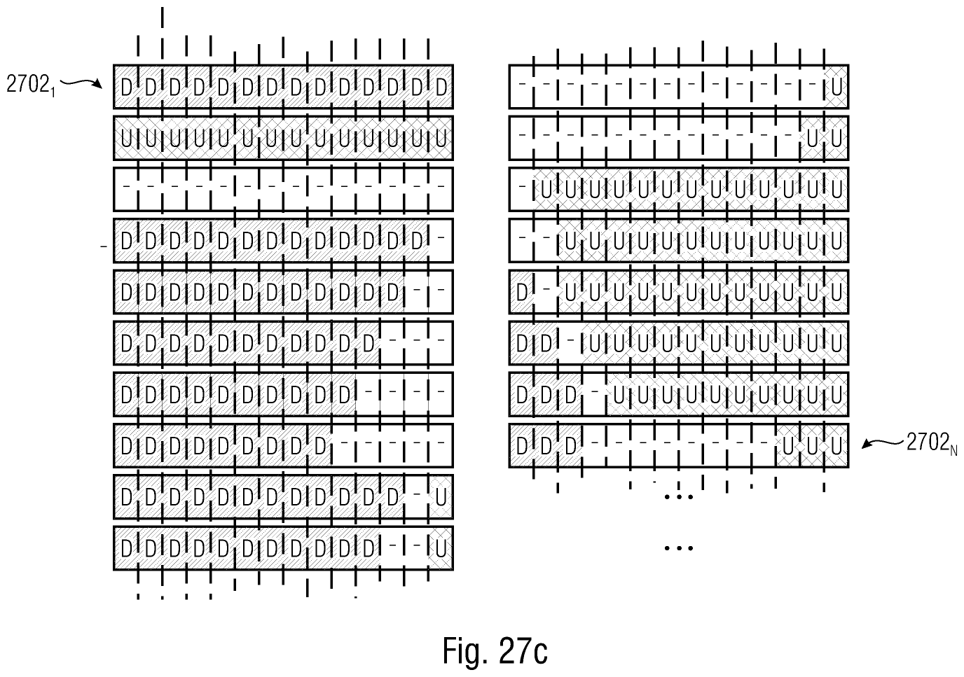

FIG. 27a shows a schematic flow chart of a method 2700 according to an embodiment and depicts a more detailed two-step CLI-mitigation approach, with the focus on the procedural aspects of a L1/L2 CLI mitigation mechanism. The approach envisages enhancing the current measurement configuration & reporting mechanism by defining and separating L1/L2 (short-term) and L3 CLI mitigation (long-term) measurement techniques.

At present, on the UE or IAB-MT side, CLI measurements rely on the existing measurement framework. The details of CLI measurement resource configuration are given in CLI measurement object MeasObjectCLI information element, configured by RRC [28], p. 449-450. These measurement resources are configured by gNB and typically represent resources that can be potentially configured as UL resources in the neighbouring cells. Normally, inter-node signalling of dynamic TDD configurations are used for configuration of these resources. This framework, however, in case of, for example, SRS CLI measurement cannot be presumed to cater for adjacent channel interference, i.e. for the inter-MNO case, as the SRS configuration of the interfering UEs need to be known by the base station in order to be provided to the affected UE. CLI measurement based on RSSI, on the other hand, measures all the co- and adjacent-channel interference, which means that it could be used when interference originate from the same or different operator.

The measurement reporting can be configured as periodic, semi-persistent or aperiodic, depending also on the measurement resource type (periodic/semi-persistent or aperiodic) as indicated in FIG. 27b [29]. To understand potential improvements to the interference measurement evaluation, it is important to understand the main features of CSI-RS, which is at the heart of NR downlink measurement. Namely, CSI-RS supports single- and multi-port transmission and can be configured with up to 32 antenna ports. While CSI-RS is configured on per-device basis, the same set of CSI-RS resources can be configured/shared by multiple devices, whereby sharing i.e. separation achieved by code, frequency (different subcarriers within a symbol) or time-domain (different symbols in a slot).

FIG. 27b shows a schematic table indicating possible intervals for reporting detected interference in accordance with embodiments, e.g. a report to be transmitted in 2770 and/or 2780. For example, being scheduled with a periodic resource allocation, a periodic, a semi-persistent and/or an aperiodic reporting may be supported whilst a semi-persistent scheduling may allow at least for a semi-persistent and/or aperiodic reporting. For example, an aperiodic resource allocation may allow for an aperiodic reporting .

CSI-RS resource may start at any OFDM symbol of the slot and it usually occupies 1/2/4 OFDM symbols depending upon configured number of ports. In frequency domain, CSI-RS is configured for a given downlink bandwidth part and is then assumed to be confined within that bandwidth part and use the numerology of the bandwidth part. The CSI-RS can be configured to cover the full bandwidth of the bandwidth part or just a fraction of the bandwidth. In the latter case, the CSI-RS bandwidth and frequency-domain starting position are provided as part of the CSI-RS configuration. Within the configured CSI-RS bandwidth, a CSI-RS may be configured for transmission in every resource block, referred to as CSI-RS density equal to one. A CSI-RS may also be configured for transmission only in every second resource block, referred to as CSI-RS density equal to ½. For more details, see [29, 13].

CSI-RS can be periodic, aperiodic (event-triggered) and semi-persistent, which is configured by RRC signalling. The UE is informed of aperiodic transmission instance by means of DCI while the activation/deactivation of semi-persistent resource transmission done using MAC Control Element.

Furthermore, CSI-RS can be configured as zero-power (ZP) & non-zero-power (NZP) resources [29]. These resources are configured via the existing downlink measurement framework, which uses higher layer signalling and one or more CSI Resource Settings. They can include channel and interference measurement resources configured as follows:
Non-Zero Power (NZP) CSI-RS resource for channel measurement [30], Sec. 5.2.2.3.1.
NZP CSI-RS resource for interference measurement [30], Sec. 5.2.2.3.1.
CSI-Interference Measurement resource for interference measurement [30], Sec. 5.2.2.4.

NZP CSI-RS are used for channel measurements and based on that residual interference can be estimated by subtracting the expected received signal from what is actually received on the CSI-RS resource [29]. CSI-IM, on the other hand, enables direct measurement of interference, measuring either resources where interfering gNBs are transmitting CSI-RS or where interfering gNBs are transmitting data. Furthermore, within a BWP, the UE can be configured with one or more Zero-Power (ZP) CSI-RS resources, which are as not available for PDSCH for the serving cell [30], Sec. 5.1.4. This enables the UE to estimate inter-cell interference.

Here, however, additional configurations can be foreseen. Namely, current measurement configuration and reporting mechanism should be enhanced with short and longer-term interference measurements configuration and reporting that will correspond to L1/L2 and enhanced L3 mitigation techniques. To improve CLI measurement results on the considered resources, and the impact of subsequent actions, particularly in the case of, for example, CLI-RSSI, the UE could have the capability to enhance the evaluation of CLI by combining and extrapolating from the existing downlink and CLI measurements. In enhancing the interference estimation, e.g. CLI, the measurement configuration could, for example, group the measurements on specific frequency and antenna resources, using the above-discussed measurements. By combining, e.g. summing and subtracting channel measurements on CSI-RS, which includes residual interference, CSI-IM interference measurements, measurements on CSI-RS ZP resources and CLI measurements, a better interference estimation could be achieved. Clearly, only the corresponding measurements, on the same resource blocks and/or subcarriers and slots/symbols should be combined. Similar method, combined with other measured and derived parameters, such as estimated angle-of-arrival could be applied to determine the type of interference, e.g. ICI or CLI.

Below is also an example of how existing CLI measurements could be categorised:
A coarse CLI measurement, based on regular slot observation (L3)
   Categorise slots by e.g. RSSI (interference temperature as an average)
Fine CLI measurement
   Time-slots of your own system, it can be refined on the symbol level
   Bandwidth parts, BWP,
Further refinement of CLI measurement (provided similar frame structure) using RSRP (SRS or SSBs)
   Time-slots of your own system, it can be refined on the symbol level
   BWP
   Resource Blocks and/or subcarriers

Returning to FIG. 27a, after a start 2705 in the first step 2720, if the victim receiver (e.g. UE or IAB-MT) has the needed capability, see decision 2710, additional CLI measurements configuration, reporting as well as execution conditions for the invocation of CLI mitigation techniques are provided by the base station/CU.

Both transmission (and therefore measurement) and reporting can be periodic, semi-persistent or aperiodic. The evaluation procedure is started either based on earlier provided configuration or a trigger signal by e.g. a DU or a CU. The evaluation procedure also has the timer associated with it. At the expiry of the evaluation timer, the condition is evaluated and if the UE/IAB-MT detects in 2730 that CLI measurements go above a pre-defined threshold, a short-term interference mitigation technique may be invoked in 2740.

The CLI threshold can be defined as interference power-level or power-level range, but can also include aspects such as angle of arrival or differential angle of arrival with respect to the main lobe. L1/L2 interference mitigation techniques may include spatial Rx spatial filter adaptation and/or sensing. Here, different sensing techniques could be invoked. Each L1/L2 CLI mitigation technique has an associated execution timer, upon which expiry the CLI measurements are performed. If L1/L2 sensing mechanisms do not reduce CLI interference below the needed, predefined threshold over a predefined period, which is evaluated in 2750, enhanced L3 CLI mitigation techniques are invoked to arrive at 2760. Alternatively, if L1/L2 sensing mechanisms do reduce CLI interference below the needed, predefined threshold over a predefined period, the last CLI evaluation may be reported in 2770.

However, if the UE or IAB-MT does not support such enhanced CLI mitigation (“No” in 2710), existing L3 CLI measurement/reporting may be triggered, 2780.

Method 2700 may end at 2790 which also allows repetition of method 2700.

In the following, several embodiments of the present invention are defined and explained in more detail. The embodiments relate to measure and/or handle interference, in particular CLI and ICI.

The embodiments may be implemented in devices such as UEs, IoT devices and(or base stations as described above by implementing additional capabilities in view of measurement, logging and/or reporting. For implementing the described solutions, the devices or apparatus described herein may be used or adapted, e.g., a device 26, 30 40, 45, 50, 11, 20, 31 and/or an MLRD.

1.1 Scheduling

CLI and/or ICI may be avoided or mitigated by adapting a schedule of one or more scheduled entities. A schedule may be at least a part of a communications configuration that is determined to organise communication of devices within a wireless communication system and/or a cell thereof.

Such a wireless communication system may be operated by one or more base stations that organise themselves, possibly other base stations and/or other devices such as UEs and/or IoT devices. A base station may be controlled, however, by a supervising entity or the like.

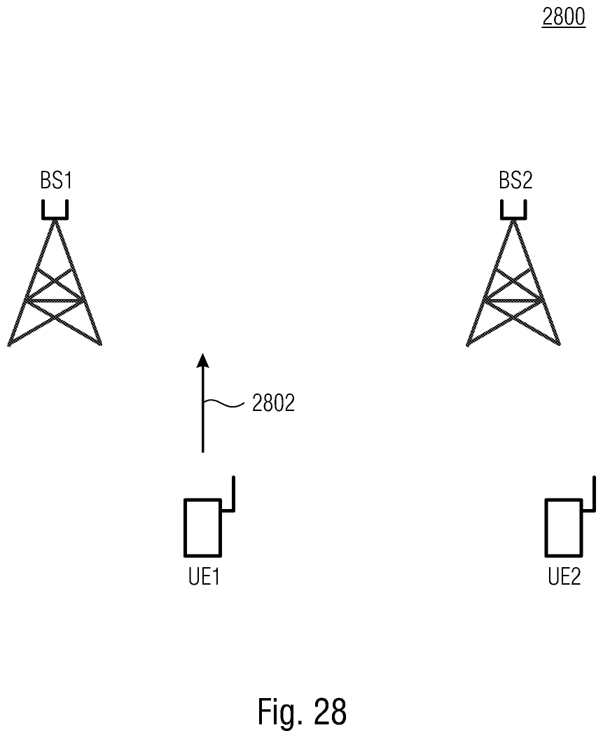

According to an embodiment a wireless communication system, e.g., system 1800 and/or 2800 shown in FIG. 28 comprises a base station BS1, BS2 adapted for scheduling, using a communications configuration, communication of a plurality of devices UE1, UE2 but possibly also BS1 and BS2, the plurality of devices including a reporting device UE1. The reporting device UE1 is configured for performing communication in the wireless communication system in accordance with the communications configuration, e.g., in accordance with the schedule.

The reporting device UE1 is configured for using information indicating a set of reference signals, i.e., at least a subset of two reference signals, more than two or even all, used in the wireless communication system. The reporting device UE1 is adapted for determining an amount of interference interfering with the communication in the wireless communication system for each of the set of reference signals by measuring to obtain a measurement result indicating the amount of interference perceived by the reporting device UE1 through the reference signals of the set of reference signals. The amount of interference may relate to a level or a different quantity of interference, e.g., a power level detected in one or more slots and/or on one or more resources, a number of slots and/or resources interfered or the like.

The reporting device UE1 is configured for reporting, to the wireless communication system a measurement report being based on the measurement result. For example, a signal 2802 may be transmitted to BS1 serving UE1. Alternatively, the signal 2802 containing the report may be transmitted to a different device using a suitable communication channel.

Optionally, the reporting device UE1 may also log the results of measurements and/or information derived thereof to obtain a log, which may be reported based on a decision of the reporting device UE1, upon request or based on the communications configuration. Operation of the device is not limited to reporting and/or logging but may also incorporate observation and/or measurement of at least a part of the network.

The wireless communication system is configured for using the measurement report and information about other devices communicating in the wireless communication system and information related to reference signals used by the other devices for adapting the communications configuration of at least one device of the plurality of devices for mitigating interference. The information related to the reference signals may comprise one or more of an identifier, time/frequency domain configuration, a comb structure, sequences used, including cyclic shifts etc., e.g., for sounding reference signals, SRS. The wireless communication system may adapt a configuration or schedule, for example, of an interfered victim and/or an interfering aggressor.

A reporting device operating in accordance with this solution may operate, for example, in accordance with an MLRD described herein and may extend the MLRD functionality in accordance with the solution.

According to an embodiment the wireless communication system is configured for identifying an interferer causing interference to the reporting device; and for adapting the communications configuration of the reporting device and/or of the interferer to reduce an amount of interference. Identifying may incorporate to determine any information such as an ID or the like allowing to identify, at the time the interference was detected, the interferer. Thus, instead of an identifier related to the device itself also other information may be used, e.g., reference signals (e.g., containing an identifier and/or a pattern in the time/frequency grid), an ID of filters or the like may be used to identify the interferer. For example, the aggressor and the victim belong to a same gNB and/or one of the victim and the aggressor is the gNB.

According to an embodiment the wireless communication system is configured for further identifying the interferer to cause the interference potentially to other devices in the vicinity of the reporting device; and for adapting the communications configuration of the reporting device and/or of the interferer to reduce an amount of interference. However, the adaption of the communications configuration is not limited to those two devices but may also incorporate other devices, e.g., in the vicinity of the victim and/or devices that have to be re-scheduled based on the re-scheduling of the victim and/or the aggressor. For example, the adaption of the communications configuration may be done to achieve an overall mitigation of interference in the cell and/or network which may include, in some examples, an increase of interference for one or more nodes, e.g., nodes that can handle additional interference for the sake of interference reduction at other nodes.

According to an embodiment, the reporting device is configured for obtaining the measurement result based on measuring uplink resources scheduled to the reporting device for obtaining information related interferer causing interference to the reporting device and based on measuring uplink resources scheduled to the other devices for obtaining information related to the interferer to cause the interference potentially to the other devices.

According to an embodiment, the reporting device is configured for measuring interference by observing transmit signals of other devices, e.g. in their current uplink slots and for performing the measurement while the reporting device is in a receive mode, e.g., during a current downlink, DL, and/or uplink, UL, slot. We can use uplink slots to measure, but it remains unclear if these UL resources belong to the system of the device or to the system of the “other” devices wherein other refers to devices of another system/base station. In the context of a currently used UL/DL configuration (e.g., TDD) a current UL slot may become a DL slot in a future configuration. In this embodiment, the interference may be measured observing transmit signals by other devices in e.g. their current UL slots and performing the measurement while the measuring device is in receive mode e.g. during a current DL and/or UL slot. When considering, for example, full duplex, to which the embodiments are not limited but allow fur such an implementation, the meaning of UL and DL slots becomes more blurred, therefore, the embodiment may also relate to measuring transmit signals from the device itself (Self-interference), another bases station in DL (inter-cell-interference) or from other UEs (cross-link-interference) in D2D or in UL.

According to an embodiment, the wireless communication system comprises a plurality of base stations. The reporting device is configured for reporting the measurement report to the base station UE1 being a first base station and being a scheduling base station for the reporting device, i.e., a serving base station. The wireless communication system may be configured for identifying an interferer causing interference to the reporting device, the interferer being scheduled by a different second base station, e.g., UE2 served by BS2 and interfering UE1 as causing interference 1806b as shown in FIG. 18a/b. The first base station may adapt a communications configuration for the reporting device to mitigate the interference, e.g., to adapt scheduling of the victim. Alternatively or in addition the first base station may provide information to the second base station, such that the second base station may adapt a communications configuration of the interferer to mitigate the interference based on the information.

It is to be noted that the reporting device may detect interference at its own location. Such information may, at the network side and/or at the reporting device be used to identify that further devices, e.g., in a neighbourhood or in a vicinity of the reporting device might also be at last a potential victim of the interferer, which may be used to also change the communications configuration of the potential victims, e.g. based on a collection of reports including ones from the other devices and/or by avoiding such reports from other devices which may avoid network traffic.

According to an embodiment, the reporting device is adapted to transmit, to the base station a suggestion for a future communications configuration, e.g., based on a listen before talk procedure or enhanced listen before talk procedure described herein.

According to an embodiment, the wireless communication system is adapted for using information about interferes and the interference they cause in the wireless communication system based on reports received from reporting devices to determine the communications configuration to obtain an overall mitigated interference for scheduled devices based on an optimization criterion. Such an optimisation criterion may be, e.g., a local minimum for each node, that each node perceives interference each below a threshold that may be device individual, group-individual (e.g., groups of different types of devices—e.g., IoT, UE, . . . and/or of different distances to the reporting device, e.g., assuming that a greater distance to the reporting victim needs a lower reduction of interference or the like) or valid for all devices.

According to an embodiment, the wireless communication is configured for determining, from the measurement result or the measurement report, a type of the interference and for including a type information indicating the type into the measurement report. A type may be, for example, a categorisation with regard to a type such as CLI/ICI, a pattern in the frequency and/or time domain. The reports may be provided, e.g., based on or using resources as indicated in FIG. 27b. The device may be configured for evaluating the type of interference at least in parts based on the configured measurements and/or an angle-of-arrival estimation.

According to an embodiment of this solution and/or other solutions, the device may adapted for reporting the measurement report using at least one uplink resource and/or at least one flexible resource.

According to an embodiment, the reporting device is adapted for measuring continuously, repeatedly or based upon request and for deciding whether to report the measurement report or not based on a decision criterion applied to the measurement result. E.g., the reporting device may report only in cases that it has detected interference being above a certain threshold and/or if it requested by a requesting node.

According to an embodiment, the reporting device is adapted to evaluate the measurement results and for generating the measurement report to comprise an evaluation result. The evaluation result may be transmitted with signal 2802, for example, instead or in addition to the measurement results. The evaluation may incorporate, for example, a location of a source of the interference, details on the interference such as a temporal and/or spatial pattern or the like. For example, the reporting device could estimate interference power, based on the earlier described combined measurements, together with the estimation of AoA of interference source, by using different AoA estimation techniques.

According to an embodiment, the reporting device is adapted to generate the measurement report by condensing, compressing or summarizing a set of measurement results which may allow to reduce the amount of data being transmitted.

A device for operating in a wireless communication system in accordance with the described solution, e.g., the reporting device is configured for performing communication in the wireless communication system in accordance with a communications configuration obtained from a base station of the wireless communication system and scheduling communication of the device. The device is configured for using information indicating a set of reference signals used in the wireless communication system; and for determining an amount of interference interfering with the communication in the wireless communication system for each of the set of reference signals by measuring to obtain a measurement result indicating the amount of interference perceived by the device through the reference signals of the set of reference signals. The device is configured for generating a measurement report based on the measurement result and reporting the measurement report to the wireless communication system.

According to an embodiment, the observed interference is possibly relevant to links of the reporting device and possibly other devices and links in vicinity of the reporting device. That is, the device may be, for example, configured for logging measurement results.

According to an embodiment, the device is configured for estimating, from the measurement result, a type of the interference and for including a type information indicating the type into the measurement report.

A base station, e.g., BS1 and/or BS2 configured for operating in a wireless communication system in accordance with the described solution is adapted for scheduling, using a communications configuration, communication of a plurality of devices, the plurality of devices including a reporting device. The base station is configured for receiving a report, e.g., with signal 2802 generated by the reporting device, the measurement report indicating an amount of interference perceived by the reporting device through a reference signal of a set of reference signals used in the wireless communication system. The base station is configured for using the measurement report and information about other devices communicating in the wireless communication system and information about reference signals used by the other devices for adapting the communications configuration of at least one device of the plurality of devices for mitigating interference.

In other words, the solution relates to avoidance through SCHEDULING in different time slots or BWP or spatial domains.

Reports to be transmitted in embodiments described herein for this or a different solution may be transmitted by use of uplink symbols and/or slots of a TDD frame implemented in the wireless communication system and/or using flexible symbols and/or slots. As an example, FIG. 27c shows schematic representations of different possible configurations 2702₁ to 2702_{N} of an example TDD slot having different configurations in view of a distribution and amount of uplink symbols U and downlink symbols D as well as flexible symbols “-”. For example, uplink symbols may be used for transmitting measurement reports. Embodiments are not limited to a specific configuration of a TDD slot nor are they limited to a TDD configuration but may also use, as an alternative or in addition, other multiplexing techniques such as frequency division duplex, FDD, code division duplex and/or spatial multiplexing. In other words, such a configuration may be a part of system design, so that gNB knows exactly within the slot/frame, when, for example, a UE transmits ‘OK to receive in x+n symbol/m-slot’, and hence when it will be scheduled to receive. There are also flexible symbols/slots in TDD pattern that could be utilised for a smart report. Embodiments relate to utilising flexible symbols/slots in TDD pattern for a smart report.

1.2 Adaptation of Victim'S Spatial Receive Filter

Whilst solution 1.1 related to adapting a communications configuration such as a schedule, to mitigate interference, at least for the victim, the victim may adapt its spatial receive filter. That is, a direction of a sensitivity of an antenna unit of the victim may be changed, e.g., in order to reduce the sensitivity or the direction from which the interference of an aggressor impinges. In one example, a null of an antenna receive pattern may be pointed towards the aggressor, whilst possibly accepting a reduced sensitivity along a direction towards an intended transmitter, e.g., a base station. Even if a null is not appropriate, at least a reduced sensitivity may be pointed towards the aggressor when compared to a situation in which the victim is interfered, e.g., above a predefined threshold level.

A device configured for communicating in a wireless communication system in accordance with such a solution comprises an antenna unit. The antenna unit may be formed in accordance with antenna arrangement described herein, i.e., having one or more antenna panels, wherein each antenna panel may comprise one or more antennas. By use of the antenna unit together with a receive filter and/or a transmission filter, a directivity for receiving a signal, for transmitting a signal respectively may influenced, and a method which is also known as beam forming may be executed by the device.

The device is configured for selecting and using, for communication in the wireless communication system, a first of a set of different spatial receive filters as a selected filter with the antenna unit to implement a directional selectivity for a reception of signals with the antenna unit; wherein each of the spatial receive filters is associated with a main direction of directional sensitivity; wherein the device is configured for receiving signals from a communication partner using the first spatial receive filter.

The device may be configured for performing a measurement procedure during a time different from the communication, the measurement procedure comprising selecting the selected filter in accordance with a direction of an interfering link towards the device, the interfering link interfering with the device. For example, the receive beam pattern may be pointed towards the interfering link.

The device is configured for using information indicating a set of reference signals, e.g., some or all used in the wireless communication system; and for determining an amount of interference interfering with the communication for each of the set of reference signals by measuring to obtain a measurement result indicating the amount of interference perceived by the device through the reference signals of the set of reference signals.

The device may be adapted to select a second spatial filter for the communication based on the measurement results to mitigate interference perceived with the first spatial receive filter. For example, a different directivity is implemented that results in less interference. That is, the device may deviate from a filter that is determined or obtained when using a standard procedure, e.g., a beam correspondence procedure, to reduce the perceived interference. This decision and/or adaption may be reported to one or more other nodes, e.g., an intended transmitter from which signals are intended to be received which may allow the other device, the transmitter, to optionally select a different transmit beam pattern, e.g., to exploit changed multipath components.

According to an embodiment, the device is configured for selecting the selected filter in accordance with a direction of the interfering link towards the device based on information indicating a control resource set, CORESET, of the interfering link.

According to an embodiment, the device is configured for monitoring at least one of:
a physical broadcast channel, PBCH;
a demodulation reference signal in the PBCH, PBCH DM-RS;
a primary synchronization signal, PSS;
a secondary synchronization signal, SSS

to obtain a measurement result and for obtaining the information indicating the CORESET from the measurement result.

According to an embodiment, the device is configured for reporting information indicating at least one of
a spatial receive filter used for the measurement procedure;
a control resource set, CORESET, of the interfering link;
the first spatial receive filter;
the second spatial receive filter
an amount of interference perceived with the first spatial receive filter; and
an amount of interference perceived with the second spatial receive filter.

A device operating in accordance with this solution may operate, for example, in accordance with an MLRD described herein and may extend the MLRD functionality in accordance with the solution.

1.3 Adaptation of Aggressor'S Spatial Transmit Filter

According to this solution, sensing as a part of this procedure can be used to adapt the Tx filter.

Instead or as an alternative to adopt the spatial filter of the victim, i.e., the receive filter, a spatial transmit filter of the aggressor, i.e., the interferer may be changed or adapted. Both of the solutions, i.e., changing the victims filter and/or the aggressor's filter may be performed individually or together with one another and, further, together with or independent from a change of the communications configuration. That is, the solutions do not exclude one another, but may be performed together in any configuration, which is also true for the solutions being described below.

A device in accordance with this solution may be a first device and is configured for communicating in a wireless communication system, e.g., one of the base stations and/or UEs in network 1800 or 2800, the device comprising an antenna unit and being adapted for establishing a link with a base station.

The device is configured for selecting a first spatial transmit filter for transmitting a signal with the antenna unit based on a beam correspondence procedure with the base station. That is, the device may select a regular spatial transmit beam.

The device is configured for using information indicating a time of transmission of a signal from a different second device. For example, the device may listen to broadcast channels or other sources of information to obtain information of other devices within a same or a different cell and/or network. The device measures interference caused by the second device to the first device during the time of transmission and via an interfering channel. That is, based on knowledge when the potential victim transmits, the potential aggressor listens with the selected receive filter to a signal sent with the potential victim.

The device is configured for deriving information indicating an amount of interference caused by the first device at the second device using a reciprocal channel assumption with respect to the interfering channel. That is, the device determines how the potential victim interferes with the potential aggressor. From this and based on the reciprocal channel assumption, the device as the potential aggressor determines how it interferes with the potential victim.

The device is configured for selecting a different second spatial transmit filter based on the information indicating the amount of interference so as to mitigate the interference of the first device at the second device. That is, based on the obtained knowledge, the device tries to reduce the effect of its signal on the victim within boundaries, e.g., to ensure a reliable communication with the intended receiver of the potential aggressor.

According to an embodiment, the device is configured for measuring for the interference caused by the second device to the first device during the time of transmission and via an interfering channel using a matched spatial receive filter to obtain a main direction of the directional selectivity towards the second device; and evaluating an interference power based on a maximum interference measured thereby.

The device may be configured for calculating a suitable spatial receive filter for mitigating the interference caused by the second device and may derive the information indicating the amount of interference caused by the first device by providing an estimate of interference that will be caused when using a similar or equivalent spatial transmit filter, e.g., based on beam correspondence, for transmission. The device is configured for selecting the different second spatial transmit filter to mitigate interference

In other words, the solution relates to change of aggressor's spatial transmit filter.

In CLI interference situations, the interference either between UEs or between base stations are depicted in FIG. 18 and/or 19.

While base stations are usually assumed to be deployed in a fixed geo-location with a fixed or repeated directional coverage and range (exception are e.g. mobile IAB nodes), UEs usually will be distributed within the coverage of their serving base stations and therefore two users serviced by different base stations may be far apart or in close proximity. Thus near-far CLI situations combined with potentially different relative distance between a base station and its associated users gives rise to hidden terminal or exposed terminal situations and the associated communication problems when simultaneously accessing the same or adjacent channels.

Although cellular networks do not typically or necessarily operate in LBT mode, in dynamic TDD due to CLI and considering that not every gNB/IAB node is aware of scheduling decisions of other gNBs/IAB nodes, they can be viewed similarly to the problems of hidden or exposed terminals.

Various approaches in literature were proposed to solve the above-described problem. Many of them do not address the issue and result in introducing additional problems; e.g. sheer increase of transmit power reduces the hidden terminal problem for two distinct wireless links while increasing the interference range and therefore creating new and more hidden nodes if further wireless links are in the vicinity.

In this invention, by exploiting side information (interference measurements, monitoring, and potential source identification), a number of solution components that tackle the hidden node and exposed node problem have been identified. In the following the principles and associated procedures are introduced and described.

1.4 Enhanced Listen Before Talk with Probabilistic Transmission Grant Announcement—eLBT

This solution relies on the principle that a victim (receiver) signals the transmitter when to transmit, assuming the interferer/aggressor is silent).

The solution provided herein, which can be combined with one or more of the other, also described aspects, is based on the finding that by listening to uplink and/or downlink and/or flexible slots should be used to determine that such a future slot is suitable for the device.

A device in accordance with this solution is configured for communicating in a wireless communication system, e.g., 1800 and/or 2800 and for receiving a signal from a communication partner, e.g., a base station and/or a different device such as a UE.

The device is configured for observing a set, i.e., at least one, at least two or more or even all of slots, which may be all downlink slots, all uplink slots or flexible slots or a combination thereof as illustrated in FIG. 27c [29], of the wireless communication system, e.g., during which the communication partner transmits or receives signals. For example, the device may be a UE, e.g., operating at least in parts in accordance with an MLRD configuration, and may, for mitigating CLI, observe the UL communication of a different UE. The device may, for example, in flexible slots or in some UL slots where it is not scheduled to transmit, be configured to also observe transmissions by other transmissions UEs or gNBs.

According to an embodiment the device is configured for requesting a schedule of downlink and/or uplink signals from the communication partner in the at least one selected future radio resource together with an indication which radio resource to be used.

According to an embodiment the indication comprises at least one of a prioritized, deprioritized, whitelisted, blacklisted and barred indication of future radio resources.

The device is configured for measuring, for each of the slots, interference occurring in the slot, to obtain measurement results. The device is configured for reporting, to the wireless communication system, e.g., a base station, a UE or the like, the measurement results or information derived thereof. Such a derived information may be a measurement report. For example, signal 2802 or a different signal may be used for transmission.

The transmitted information may allow the base station or a different scheduling entity to determine slots suitable for the device. Alternatively, the device may already indicate one or more specific slots that it considers suitable. This may include a basis for selection at the scheduler which may select one or more or all suggested slots.

Alternatively or in addition, the device may be configured for determining, based on the measurement results and based on an interference criterion, at least one selected future slot.

The device is configured for transmitting information indicating the at least one future slot to the wireless communication system; and/or for requesting a schedule of downlink and/or uplink signals from the communication partner in the at least one selected future slots.

According to an embodiment, the device is configured for measuring the interference as a cross-link-interference perceived from at least one link of a different device.

According to an embodiment, the device is configured for measuring the interference based on receiving a reference signal such as a sounding reference signal, SRS; and/or based on an evaluation of a signal power received as a cross-link-interference from at least one link of a different device. That is, CLI can be also determined by measuring RSSI on the configured resources, these resources can be resources where SRS is transmitted, but do not necessarily represent SRS RSRP.

According to an embodiment, the set of slots is based on a time in which other devices communicating with the communication partner operate in a transmit mode whilst the device operates in a receive mode.

According to an embodiment, the device is to determine, from the measurement results, statistics indicating suitable slots in the temporal past; and to derive, using the statistics, the selected future slots as slots that are expected to allow a successful decoding of a signal transmitted to or by the device.

According to an embodiment, the device is configured for determine a candidate for the future slot as the selected future slots based on a decision whether the candidate fulfils a predetermined criterion with regard to a transmission quality. Such a criterion may, for example, be related to an amount of interference, a bit error rate, a possibility of a needed retransmission, a needed transmission power for transmission or combinations thereof.

According to an embodiment, the device is configured for determine the selected future slots as being expected to have a level or amount of interference of at most a first interference threshold and/or a level of interference of at least a second interference threshold.

According to an embodiment, the device is configured for determine the selected future slots based on at least one probability of:
a packet collision in the selected future slot,
the device being out of coverage during the selected future slot
packet loss higher than a threshold in the selected future slot
Signal to interference ratio, SIR, exceeding a predetermined threshold the selected future slot
Packet erasure events over multiple retransmissions occurring when using the selected future slot

According to an embodiment, the device is configured for receiving, from the wireless communication system and responsive to transmitting the information or the request an indication indicating that the device is scheduled to receive information in the slot; wherein the device is configured for transmitting, to the wireless communication system a confirmation signal, e.g., a clear to send, CTS indicating a confirmation for the indicated slot; and/or wherein the device is configured for transmitting, to the wireless communication system a dismissal or rejection signal indicating a rejection for the indicated slot. A rejection may also be indicated as optional as transmitting the dismissal signal, which may be interpreted as a denial. Alternatively or in addition, the device may be configured for transmitting, to the wireless communication system a packet retransmission request signal indicating an expected misdetection or channel degradation for the indicated radio resource. That is, when having knowledge about an expected future interference or an expectation that reception of the future signal by use of the future radio resource might be error-prone, a re-transmission may already be requested prior to the transmission. For example, the device may be configured for transmitting information indicating a plurality of selected future radio resources to the wireless communication system; and/or for requesting a retransmission of downlink data packets from the communication partner in a plurality of selected future radio resources. The indication may indicate a subset of the plurality of future radio resources as a selection thereof.

According to an embodiment, the device is configured for transmitting information indicating the a plurality of selected future slots to the wireless communication system; and/or for requesting a schedule of downlink signals from the communication partner in a plurality of selected future slots. The indication indicates a subset of the plurality of future slots as a selection thereof.

According to an embodiment, the device is configured for transmitting, prior to the selected future slot, a pre-emption signal to the wireless communication system to indicate an expected signal in the selected future slot.

The pre-emption signal may be used for indicating, to other devices an expected reception of a signal and/or a future transmission. Other devices may, thus, be requested to avoid interference, e.g., by avoiding transmission, to improve reception and/or transmission of the device. The device may be configured for transmitting the pre-emption signal to devices of the same wireless communication system to indicate an expected signal in the selected future radio resource and/or to devices of another wireless communication system configured for transmission in the selected future radio resource.

According to an embodiment, the measured slots comprise at least one uplink slot and/or at least one downlink slot; and/or the future slot is an uplink slot or a downlink slot.

In other words, listen-before-talk (LBT) is a widely-established concept used in various communication protocols e.g. WiFi (IEEE 802.11 series) and NR-U, which works sufficiently well with a low number of users and/or overlapping base station footprints. Nevertheless, LBT is prone to hidden node and exposed node problems, which are proposed to be addressed by the following procedure:

Assuming the UE-UE CLI situation in a flexible TDD scenario where adjacent base stations are using different TDD frame formats resulting in unidirectional or bidirectional CLI between UEs or groups of UEs belonging to different base stations. While multiuser scheduling in DL and UL is arranged for each group by their serving bases stations, multiuser interference in UL and DL can be sufficiently resolved by existing channel feedback and scheduling mechanisms and associated protocols.

While inter-cell-interference (ICI) in DL and UL can be coordinated by the serving base stations among each other exploiting interference measurements by the UEs or at the base station side at least with base stations belonging to the same MNO, further side information and/or further information exchange is needed when such concepts are to be extended across multiple MNOs operating in e.g. adjacent parts of the spectrum.

In the UE (a)-UE(b) CLI situation usually at least one of the UEs is becoming a victim when receiving data from its associated base station in DL while the other UE is already transmitting to each associated base station in UL. Since UL and DL scheduling are usually performed by each UEs base station independently, such victim-aggressor pairing situations are dependent on the scheduling AND the proximity of two UEs.

In our given scenario a receiving UE is observing e.g. all DL slots from its base station and occurrences of CLI in particular slots listening to SRS or other reference signals from UEs belonging to the group of UEs active in transmit mode while the UE is still in receive mode.

The CLI can be measured based on RS using the configured SRS (RSRP) or CLI-RSSI. Furthermore, a UE can create e.g. statistics about the observed interference level in temporal, spectral and/or spatial domain in order to get meaningful insight into proximity of interference sources, their spatial distribution, effective near-far behaviour due to varying allocated transmit bandwidth, etc.

Furthermore, these statistics can be used by the UE to identify suitable time slots for future use by its base station in the DL, where suitable means that the expected/estimated CLI will be below a certain threshold allowing the UE to successfully detect DL signals/data from its own BS. The level or amount of interference may be determined on one of different levels/hierarchies. For example, a symbol level may be used, making this also short-term interference mitigation mechanism, based on immediate sensing.

Detail about mixed TDD slots (featuring UL and DL symbols) and frames will be provided.

Such signalling of potentially secure radio resources in e.g. time or frequency is denoted Extended LBT with probabilistic transmission grant announcement or request.

As a practical example this may be implemented in the following way:

UE is observing interference occurrences over a selected window of time and concludes/determines suitable time slots/BWP for future transmission by the gNB to the UE
There can be several levels of “suitability”, e.g. very secure/suitable e.g. in slots only subject to ICI, moderately secure/suitable e.g. for CLI slots with sparse or low level interference observed or low level of suitability for maybe best effort transmissions.
Such levels of security/suitability in terms of expected transmission/channel quality e.g. expected/predicted CQI (channel quality indicator) can also be expressed as low interference indicator (LII) or high interference indicator (HII) associated with a threshold relevant for the intended transmission, potentially including MCS level, QoS or probabilistic metrics like probabilities on
   packet collision,
   out of coverage
   packet loss higher than a threshold
   SIR exceeding threshold
   Packet erasure events over multiple retransmissions
   etc.

UE signals these slots as suitable/good enough for future DL transmission to the gNB OR requests gNB to use these slots for next transmissions
This can be understood like a “Ready to Receive” (RTR) command, where the receiver is triggering the transmitter for action.

gNB includes this information in scheduling decisions and will schedule UE on particular slots. If UE identifies sudden interference to occur in scheduled slots harming the DL transmission beyond a tolerable level, then
UE will signal to gNB that formerly secure/suitable status of slot is no longer valid and
gNB will schedule retransmissions and further new packet transmissions on alternative slots, where validity is still expected.

An alternative implementation, more similar to the classical RTS/CTS protocol would be the following:

UE is observing interference occurrences over a selected window of time and concludes/determines suitable time slots/BWP for future transmission by the gNB to the UE
There can be several levels of “suitability”, e.g. very secure/suitable e.g. in slots only subject to ICI, moderately secure/suitable e.g. for CLI slots with sparse or low level interference observed or low level of suitability for maybe best effort transmissions.
Such levels of security/suitability in terms of expected transmission/channel quality e.g. expected/predicted CQI (channel quality indicator) can also be expressed as low interference indicator (LII) or high interference indicator (HII) associated with a threshold relevant for the intended transmission potentially including MCS level, QoS or probabilistic metrics like probabilities on
   packet collision,
   out of coverage
   packet loss higher than a threshold
   SIR exceeding threshold
   Packet erasure events over multiple retransmissions
   etc.

gNB signals to UE its intention to use the reported slots (marked as suitable/good enough for future DL transmission) for upcoming transmissions e.g. in next frame this is a kind of RTS (Request To Send) signalling from the gNB to the UE
the DL scheduling attempt announcement may include a description of slots and/or BWP

UE will respond with a form of CTS (clear to send) message, that it still expects the channel to be suitable in near future.

gNB will schedule packets for UE on confirmed slots upon CTS message received. If UE identifies sudden interference to occur in scheduled slots harming the DL transmission beyond a tolerable level, then
UE will signal to gNB that formerly secure/suitable status of slot is no longer valid and
gNB will schedule retransmissions and further new packet transmissions on alternative slots, where validity is still expected.

Optionally, the UE could send out a pre-emption beacon/signal/message while or after sending the CTS to its gNB in order to trigger potential aggressor(s) NOT to send in a future slot.
One flavour of the solution could be an implicit addressing/indication of future resources according to a code book/look-up table describing the relationship between a pre-emption beacon/signal/message and the slots/BWP aggressed for pre-emption.

It should be noted that the above mechanisms while envisaged to work on a time-scale that spans a few or dozens of slots, could also be applied on a symbol level, making this also short-term interference mitigation mechanism, based on immediate sensing.

1.5 Remote LBT or Collaborative LBT

Another solution related to a concept based on listen before talk in accordance with embodiments is explained in the following.

A wireless communication system in accordance with such a solution, e.g., network 1800 or 2800 or another network described herein comprises at least one base station and a plurality of devices being scheduled with communication by the at least one base station. That is the plurality of devices are operated in at least one cell of the wireless communication system.

Each of the scheduled devices is configured for observing a device-individual set of downlink resources, i.e., at least one, some or all of the wireless communication system, wherein a downlink resource comprises, for example, an uplink slot, a downlink slot, a flexible slot and/or a set of at least symbol being used for uplink or downlink. As a resource, embodiments may incorporate one or more of at least one frequency bandwidth part (BWP), at least one resource block, at least one subcarrier and/or at least one time-domain slots/symbols. As a resource, instead of or in addition to slots embodiments also relate time domain and/or frequency components and/or combinations thereof e.g. resource block (RB).

A slot may be understood as a time period of relevant meaning within the frame structure of a radio frame used by the communication system AND that it can represent e.g. a sequence of signal samples (smallest length); and/or as a length of a symbol (e.g. OFDM symbol) and/or as the length of a guard interval (e.g. OFDM GI) and/or as a sequence of symbols (e.g. OFDM symbols with or w/o cyclic extension) which can be a “SLOT” (as called in 3GPP language) or a “SUB-SLOT” or a “partial SLOT” or whole “FRAMES” and/or partial or whole “SUBFRAMES”. That is, the term slot is not limiting to a specific amount of time but all possible temporal interference options are covered as well.

That is, when referring to a radio resource in time, the embodiment may also be implemented by using, as an alternative or in addition, a radio resource in the frequency domain, e.g., bandwidth parts (BWP), Resource blocks (sequence of set of subcarriers over a sequence of OFDM symbols, Subcarriers etc. Embodiments are not limited to half duplex but may also operate in full duplex. That is, a frequency radio resource may be defined in a similar way as a time radio resource such as a slot.

Although radio resources in the intended future operation such as a future time slot are mentioned in some embodiments, those embodiments operate also as a targeted or indicated radio resource in the future are as a frequency resource and/or a combination thereof, therefore including full or partial RB (resource blocks).

Further, the devices are configured for measuring, for each of the downlink resources, interference occurring in the downlink resource, to obtain measurement results; and for reporting, to the wireless communication system, the measurement results or information derived thereof. Such information derived from the measurements may include, for example, a measurement report indicated above. Reporting of the devices may allow to determine suitable resources for one or more devices in uplink and/downlink at an entity such as a base station that has access to the collective of measurements, e.g., to optimise communication and/or interference for a set of devices.

The set of radio resources may include a first downlink resource configuration, e.g. currently used configuration and/or a second downlink resource configuration, e.g. future used configuration. In a future configuration the downlink resource may be used as uplink resource and/or as flexible resource. That is, the term downlink resource may limit the embodiment only to an extend that by use of this resource a signal is transmitted so as to be received with the device and, thus, even as uplink resource.

The wireless communication system is configured for determining a communications configuration for the plurality of devices that mitigates interference caused by transmitting signals to the devices during future resources based on evaluation of the reported resources, e.g., by extrapolation.

According to an embodiment in accordance with this solution, the wireless communication system is configured for identifying, for future resources and for a reference communications configuration, potential interferes and potential victims potentially interfered by the interferers; and at least one of:
scheduling at least one interferer and/or at least one victim to a different radio resource when compared to the reference communications configuration; and
changing a transmission behaviour of a potential interferer

to determine the communications configuration.

According to an embodiment in accordance with this solution, the wireless communication system is adapted to repeatedly measure the resources and determine the communications configuration, e.g., based on a mobility of network nodes in the wireless communication system.

In other words, similar to the mechanism described above the observation can not only be done by a device individually but as a collaborative task performed by a group of UEs and sharing their measurements and/or observations among them and/or with their BS and/or with the group of potential CLI victims or aggressors. For example, the wireless communication system is adapted to repeatedly measure the radio resources of a first UL/DL configuration and/or a different second UL/DL configuration and to determine a measure for interference such as CLI, for the first and the second UL/DL configuration, and for selecting one of the first and the second UL/DL configurations as a future UL/DL configuration based on the interference. That is, based on measurements of measuring devices, impacts of interference on different UL/DL configurations may be determined and based thereon, a suitable configuration may be selected or determined, e.g., avoiding specific interference for one or more devices, obtaining a low amount of interference for all devices or the like.

The mechanism could be aligned to the listen before selecting radio resource pool resources in sidelink (SL) communication, where UEs observe spectrum occupancy around them and share their observations via the BS to become common knowledge of all UE in a given geo-location area.

According to embodiments, there measurements may done in sidelink, SL, and they may, for example, be available there, e.g., a Channel Busy Ratio (CBR) and a Channel occupancy Ratio (CR) that are also referred to as SL CBR and SL CR CBR being defined as the ratio of occupied subchannels within the previous 100 slots. The channel is occupied if RSSI goes above some threshold. The CR estimates the channel occupancy generated by a TX UE.

Remote LBT allows to coordinate transmitters and receivers among the group of potential aggressors and potential victims by exploiting collaborative observations and sharing these with the scheduling entities and/or the group of potential aggressors.

The information about users or a group of users which may cause an intolerable interference burden to UEs in the group of potential victims can be used to:
Reschedule them on to other radio resources (response at aggressor side)
Change their transmit behaviour with respect to Tx power or directivity (response at aggressor side)
Protect potential victims by avoiding vulnerable radio resources (response at victim side via BS)

Such temporary avoidance of certain transmit opportunities for particular UEs have to be updated regularly due to changes cause by user mobility and therefore change of proximity relations between UE/devices.

In that sense the Remote LBT or Collaborative LBT is not suitable to make decisions immediately before a transmission burst is initiated but rather on a longer time scale over multiple slots or radio frames.

1.6 Spatial Proximity Pre-Emption for CLI Reduction

This solution is based on the finding that although being scheduled with one or more resources, other devices may interfere with the scheduled device or may be interfered by the device, e.g., as being not aware of the schedule. The solution suggests to indicate the schedule to allow devices to avoid interference or being interfered.

A wireless communication system in accordance with this solution, e.g., network 1800 or 2800 or a different network described herein is configured for providing a wireless communication at least from a base station to a device.

The device is configured for observing a radio environment of the device to obtain an observation result, e.g. by performing measurements described herein. The device is configured to determine, based on the observation result, at least one radio resource such as a slot or symbol in uplink or downlink as being vulnerable to a cross link interference and/or ICI.

The device is configured for reporting, to the base station a report indicating the at least one radio resource. Such a report may be a signal, e.g., signal 2802 and/or a fully-fledged L3 report, which may include additional interpretations such as statistical averaging.

The device receives information indicating a communications configuration to receive a signal in a scheduled future radio resource;

The wireless communication system is configured for transmitting a pre-emption signal system to indicate an expected signal in the scheduled future radio resource.

Examples in accordance with the solutions also relate to such an pre-emption signal being sent from
a base station serving the victim(s)
a base station serving the aggressor(s)
The victim(s).

According to embodiments, the pre-emption signal may be sent by an aggressor base station, e.g., an interfering base station, e.g., for ICI and/or by aggressor UEs directly; and/or by a base station serving aggressor UEs and/or any other entity, which can initiate (send) a NO-transmit command to the aggressor UEs

According to an embodiment in accordance with this solution, the base station is configured for determining the communications configuration based on the report.

According to an embodiment in accordance with this solution, the wireless communication system is configured to transmit the pre-emption signal with the device to receive the signal in the scheduled future downlink slot; and/or with the base station to transmit the signal in the scheduled future downlink slot.

According to an embodiment in accordance with this solution, the pre-emption signal is adapted to identify/address at least one radio resource to be temporarily protected by other devices nearby by avoiding transmitting using the at least one radio resource.

According to an embodiment in accordance with this solution, the wireless communication system is adapted for observing the radio environment also with the base station to obtain a bi-directional observation.

According to an embodiment in accordance with this solution, the device is configured for observing the radio environment during an initial stage. For example, a UE is configured using RRC in terms of measurements, resources and reporting. The UE can be also configured but not activated initially, so they can be activated at a later stage. This includes measurements and reporting.

According to an embodiment in accordance with this solution the base station is configured for observing the slots, i.e., radio resource, and parts of the spectrum associated with a link with the device; and for reporting information indicating a link quality or an interference information associated with the link to the device to obtain a bi-directional link information at the device together with the observation result. The spectrum component may be of importance to reduce or specify the allocated part of the spectrum (a number of resource blocks or a bandwidth part (BWP) or a sub-band).

In other words, in this solution component it is assumed that a UE (receiving device) is during an initial stage observing its radio environment and therefore able to anticipate certain radio resources, e.g. time slots vulnerable to CLI and/or ICI.

Furthermore, the receiving device/UE is informed by its base station about scheduled future transmissions e.g. by means of (semi-) persistent scheduling and uses means to transmit a pre-emption beacon or message into its proximity in order to signal to members of the potential interferer group (CLI aggressor group) that proximity pre-emption is requested.

These means include transmitting a signal by the potential victim UE itself or by its BS or by the BS of the other UE. Such signalling could identify/address certain radio resources to be temporarily protected by other device nearby not transmitting. The mechanism could be aligned to the pre-emption protocols in URLLC with grant-free transmission in contentious mode. This protocol allows individual or group-wise cancellation of previously given transmission grants by the base station of the aggressor UEs.

A further extension of such mechanism is a bi-directional link observation and repeat windows of opportunity to listen, while the nearby transmitter is silent.

Such extension could be understood either as a “considerate nearby transmitter” when avoiding (not responding to scheduling requests by its BS) or otherwise as a “receiver (victim) oriented transmitter (aggressor) tasking”).

Embodiments of the present invention may be adapted, for this or a different solution, for a dynamic indication for restriction and/or availability of beams between nodes of the wireless communication system in the configured radio resources; wherein radio resources can be allocated/addressed in time (e.g., a slot) and frequency (subcarrier, bandwidth parts, ands) and/or combinations of the two dimensions.

2. Implementation Methods

Three method inventions have been identified: implementation in FR2; interference source identification; and enable IM based on SRS with different SCS.

2.1 Implementation in FR2

This solution relates measuring interference and may be implemented by one or more nodes in a network described herein, e.g., network 1800 or 1900 individually or collaboratively.

A method for measuring interference in accordance with the solution comprises:

operating a device in a wireless communication system, the device being adapted to operate in a downlink mode, the device comprising an antenna unit, the device adapted for selecting and using one of a set of different spatial receive filters as a selected filter with the antenna unit to implement a directional selectivity for receiving signals with the antenna unit during the downlink mode, e.g., based on a relative location of the gNB with respect to the device;

applying the selected filter;

measuring prior, during and/or after the downlink mode the interference with the antenna unit and the selected filter; and

determining an impact of the measured interference on a reception of a signal during a downlink mode. Such a step may be implemented at the UE, the gNB or other entities.

The time of measurement may be prior, during and/or after the downlink mode and may be performed with the antenna unit and the selected filter. The impact of the measured interference on the reception of the signal may be determined during a previous, current or future downlink mode.

According to an embodiment, the measuring the interference comprises receiving a reference signal such as a sounding reference signal or any other configured resource: and determining, from reception of the reference signal/configured resource a Reference Signal Received Power; and/or receiving a signal from a data signal and/or a control signal and determining from the reception of the signal a Received Signal Strength Indication.

Alternatively or in addition, measuring the interference may comprise receiving a reference signal such as a Synchronization Signal Block, SSB or Channel State Information Reference signals (CSI-RS); and determining, from reception of the reference signal a Reference Signal Received Power; and/or receiving a signal power from data and/or control signals; and determining, from reception of the Received Signal Power a Received Signal Strength Indication.

In other words, the solution relates to use an MLRD to observe interference by:
Applying a particular spatial beam (receive filter)
for FR2 UE should measure with the same spatial receive filter as used to receive DL signal from gNB
Observe RSRP and/or RSSI

2.2 Interference Source Identification

A method for addressing interference in accordance with this solution comprises

operating a receiver-device in a wireless communication system, the device comprising an antenna unit for receiving signals in the wireless communication system;

receiving a reference signal transmitted by an interfering device in the wireless communication system;

informing the wireless communication system that the receiver-device suffers from interference caused by the interfering device; and

identifying the interfering device using measures related to the reference signal/configured resource.

For example, the aggressor or interfering device is adapted to change the transmission strategy to change the experienced interference. This can relate to a power control, a different time-slots or the like.

According to an embodiment of this solution, identifying the interfering device comprises:

determining a Reference Signal Received Power of a reception of the reference signal at the receiver-device;

evaluating one or more of a bandwidth part associated with the reference signal; a resource block used for transmitting the reference signal and a time slot used for transmitting the reference signal to obtain an evaluation result; and

providing a report to a base station, comprising information indicating the evaluation result; and

evaluating a past scheduling in the wireless communication systems to identify the interfering device.

According to an embodiment of this solution, the evaluation result is obtained by measuring a resource configured as a zero power, ZP, or a non-zero power, NZP resource, or by a combination of these channel and interference measurements. NZP channel measurements may, for example, include a residual interference, a CSI-IM and/or interference measurements in the neighbouring cells on the configured resources. ZP measurements may include, for example, measurements in the serving cell.

According to an embodiment of this solution, identifying the interference device comprises a combination of information obtained from the reference signal of the interfering device together with its timeslot and the settings of the spatial filter used in the receiving device.
According to an embodiment, identifying the interference device comprises a combination of information obtained from the reference signal of the interfering device wherein the reference signal may be at least one of:
   Identifiable Sounding Reference Signal (SRS) sequence (number/ID),
   A specific phase shift/phase applied on a SRS or SRS sequence,
   A synchronisation signal block, SSB,
   A channel State Information Reference Signal, CSI-RS,
   A SSID from a WiFi access point,
   A bluetooth beacon, or
   Any other identifiable and known reference signal, a receiver could correlate with and derive a measurement specifically related to the interference transmitter.

2.3 Enable IM Based on SRS with Different SCS

This solution further defines solution 2.2.

According to an embodiment, one or more of a bandwidth part associated with the reference signal; a resource block used for transmitting the reference signal and/or a time slot used for transmitting the reference signal is evaluated by use of an interferer-subcarrier spacing underlying the evaluation, the interferer-subcarrier spacing being different from a subcarrier spacing scheduled to the receiver-device. That is, for evaluation a different subcarrier spacing is used or considered, e.g., for decoding.

According to an embodiment, the method comprises: informing the receiver-device about the interferer-subcarrier spacing; and/or measuring different subcarrier spacing during the evaluation to obtain different evaluation results and determining the interferer-subcarrier spacing

In other words, in the case where the SCS of the aggressor and the victim links are different:
RSRP measurement should be done with SCS of aggressor
Can be combined with RSSI and SIC (depending on ratio between interference and signal)
UE should have knowledge about SCS of the aggressor link

A receiver device in accordance with embodiments is configured for operating in a wireless communication system, and for implementing a method of one of solutions 2.1, 2.2 and 2.3.

Devices described herein, in particular devices for measuring and optionally for reporting and/or logging may be adapted to read or measure all this information within an own cell and/or possibly from the cells that are not their own.

3.1 Full Duplex Mechanisms

Further embodiments relate to a recognition in connection with full duplex operation in a wireless communication system, e.g., system 1800 or 2800 adapted accordingly. When operating in full duplex, a device such as a UE may suffer from self-interference as it may suffer from CLI and/ICI. For mitigating self-interference a frequency gap may be established between a radio resource used for transmission and a resource used for reception. This gap may be dependent from one or more parameters comprising, e.g., a distance to the communication partner, e.g., a base station. For example, having a short distance to the base station allows receiving a signal from the gNB with a high signal power/quality whilst needing a low amount of transmission power to send a signal to the gNB, therefore causing a low amount of self-interference which allows for a small gap. However, having a large distance, e.g., at a cell edge, leads to a low signal power of signals received from the base station and a comparatively high power for transmitting a signal to the base station therefore a high level of possible self-interference which may be addressed with a large gap. That is, the reception power, the transmission power and the gap may be distance dependent, dependent from similar effects respectively as, e.g. in multipath environments good or bad channels may also be obtained for large distances, short distances respectively.

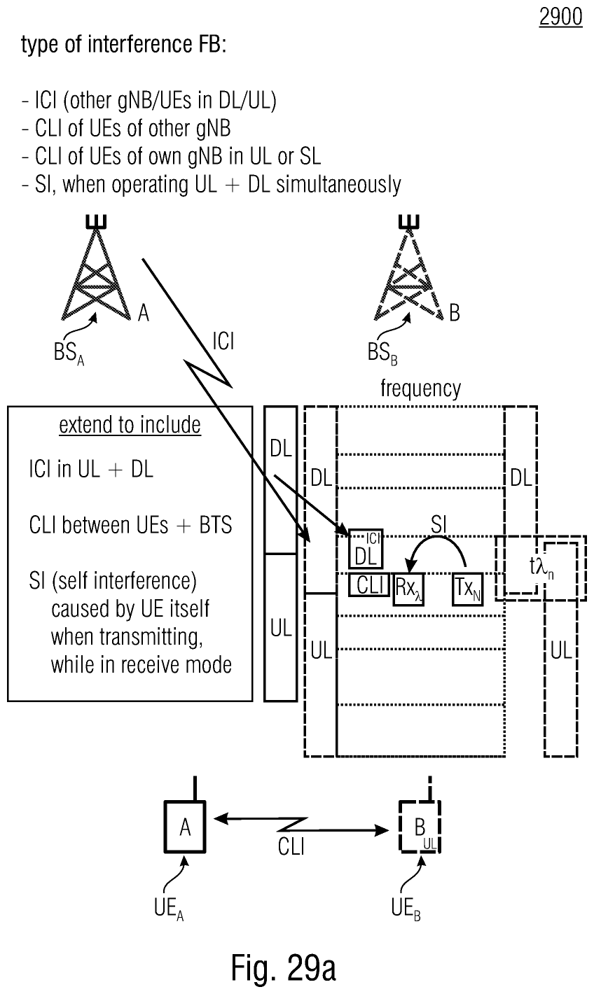

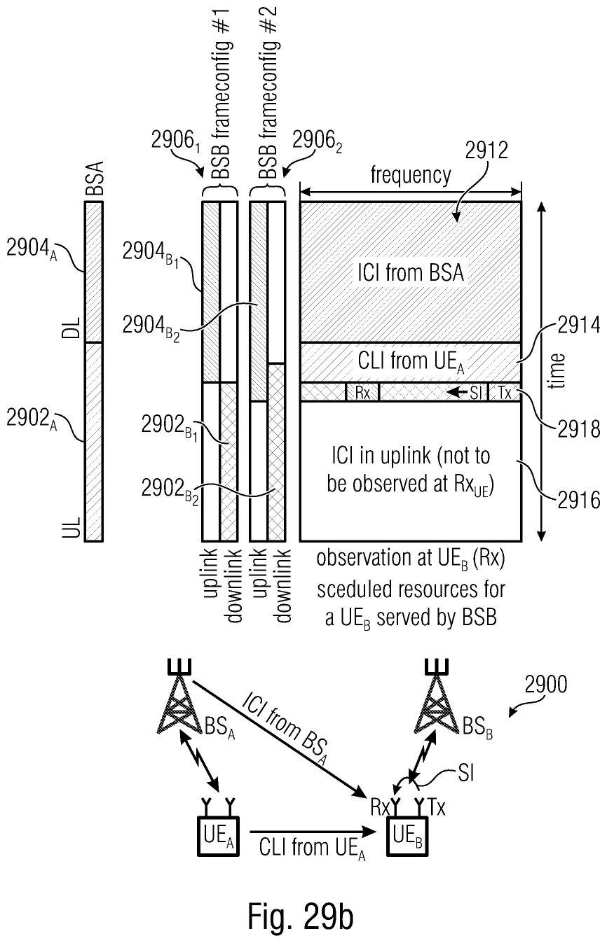

FIG. 29a shows a scenario 2900 of an example wireless communication network or at least a part thereof, e.g., network 1800 or 2800. In the scenario, two base stations BS_{A} and BS_{B} with a coverage overlap and two example UEs are present, wherein UE_{A} is served by BS_{A} and UE_{B} is served by BS_{B}.

BS_{A} operates, for example, in a fixed/static UL/DL frame configuration depicted with uplink, UL 2902_{A} and downlink, DL 2904_{A}. shown in FIG. 29b.

BS_{B} can operate in a 1^{st} frame configuration 2906₁, wherein UL and DL resources are not allocated simultaneously (traditional TDD) and in a 2^{nd} frame configuration 2906₂ (of two or more possible configurations), wherein UL and DL resources are partially exclusive in time and partially shared (partial full duplex configuration).

In the right part of the FIG. 29b a time-frequency grid is displayed which UE_{B} can be tasked to observe/measure wrt to interference experienced on different time-frequency resources.

When BS_{A} and BS_{B} both are operating in DL (upmost area 2912), UE_{B} may observe/measure inter-cell-interference (ICI) from BS_{A}.

In time slots where BS_{B} is still operating in DL while BS_{A} is already in UL, UE_{B} will observe/measure cross-link-interference (CLI) from UEs belonging to BS_{A}, in this example represented by UE_{A}. This CLI can be observed over a period of e.g., 2 time slots when BS_{B} is in a 1^{st} frame config and over a period of 3 time slots when BS_{B} is in a 2^{nd} frame config, see area 2914.

In the downmost area 2916, when BSA and BSB are both in UL mode, the UEB can will not be affected by interference by BS_{A} (silent as UL receiver) or UE_{A}, since it is not expecting signals from BS_{B}. During these time slots BS_{A} and BS_{B} may observe/measure ICI in UL from the UEs from the other's UEs, respectively.

Furthermore, there exist two time slots in the 2^{nd} frame config where UE_{B} can transmit while BS_{B} is transmitting as well (Full-duplex operation), causing self-interference (SI) to itself and cross-link-interference (CLI) to other UEs nearby which are about to receive data from BS_{B}, see area 2918.

In these particular time slots UE_{B} can be tasked to measure SI and/or CLI from other UEs belonging to BS_{B} on various levels of detail, in particular with respect to the observed/measured frequency resources in these (full duplex) time slots.

The observing/measurement device, e.g., in accordance with embodiments described herein (UE in DL or BS in UL) may report the interference measurement results including a possible frequency and time slot dependency and the associated type of interference, wherein the type of interference may include at least one of the following:
DL Inter-cell-interference (ICI) from BS_{A} or another identifiable BS or a sum of BSs
UL Inter-cell-interference (ICI) from UEs belonging to the other BS
CLI of the UEs from the other BS (UE_{A} and BS_{A} in this example)—Ues from other BS operate in UL or SL (sidelink)
CLI of UEs from own BS when operating in UL or SL (sidelink)
Self-interference (SI) when operating transmitter and receiver simultaneously at the UE e.g. when receiving packets in DL and transmitting packets in UL or SL

That is, FIG. 29b depicts a scenario where the receiving device (UE_{B}) is measuring different types of interference, while either receiving signals from its base station (BS_{B}) during a 1^{st} frame configuration or for a tentative 2^{nd} frame configuration which may be used in the future.

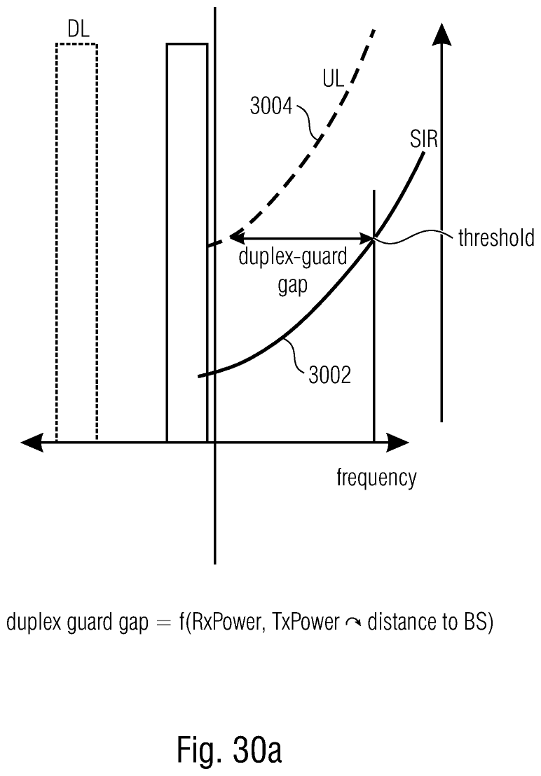

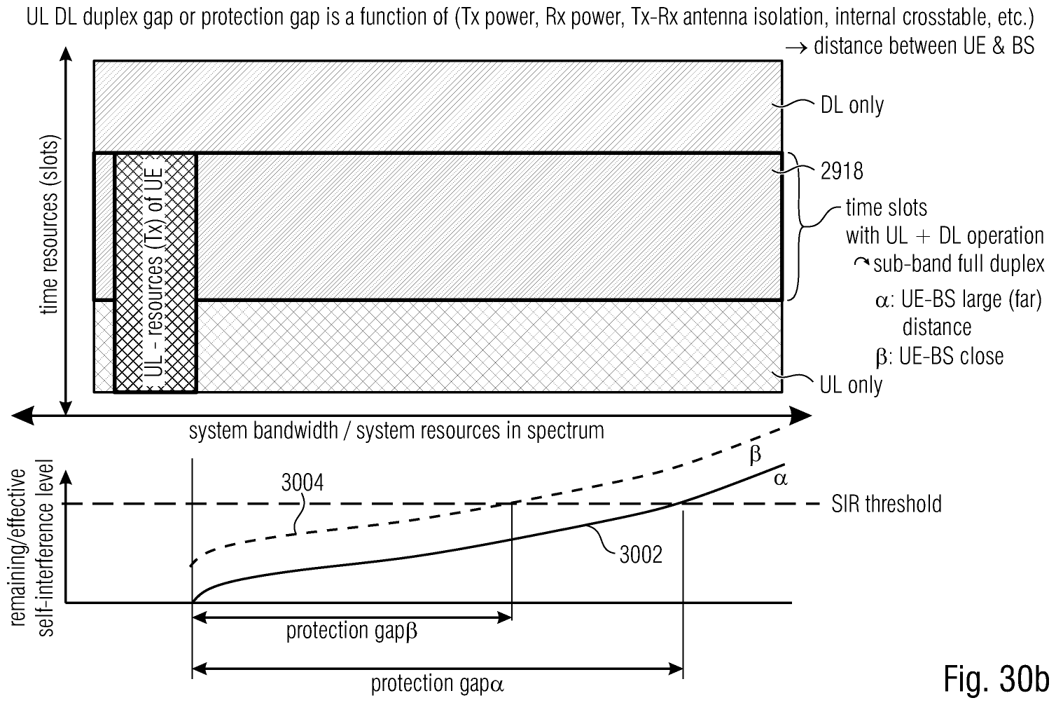

FIG. 30a/b illustrates that in time slots 2918 operated in full duplex mode not all transmit and receive resources have to be in full overlap. Theory about and practical implementations of self-interference-cancellation schemes in a device show that transmitting and receiving at the same (identical) time-frequency-resource is feasible under certain favorable conditions, but in many less favorable scenarios considered infeasible or needing to much technical effort, while reception on frequency resources sufficiently apart from the UL resources used by the transmitted seems feasible with limited effort, therefore allowing to reuse the same overall spectrum for simultaneous UL and DL operation by appropriate scheduling of such full duplex resources across the frequency band and the associated UEs operating in receive and transmit mode.

Furthermore, it has to be noted that in such scenario a device receiving signals in DL may have its reception performance impaired/degraded by either self-interference, when transmitting at the same time and/or cross-link-interference (CLI) from other UEs scheduled in UL while the particular UE is receiving packets in DL.

Depending on the implemented antenna isolation between the TX and the RX antenna in a device, the transmitter power used in UL and implemented Interference mitigation schemes the effective Signal-to-Interference-Ratio (SIR) will significantly depend on the frequency gap between the bandwidth part of the transmitted signal and the bandwidth part of the received signal(s).

Plot 3000 in the bottom of FIG. 30b depicts the relationship between SIR under self-interference conditions and the frequency gap between the transmit and receive BWP. The solid line 3002 represents a scenario alpha/a, where the UE is far away from the BS, therefore receiving a low receive signal power and needing a high transmit power in UL to bridge the pathloss, resulting in a unfavorable low SIR for the receive band. The curve shows that with sufficient gap between the UL and DL BWP the SIR will be above a threshold, representing a sufficiently high channel quality for successful data transmission (communication) in DL.

The dashed line 3004 represents a scenario where the UE is closer to the BS and the received signal level is higher and at the same time the UL transmit power is lower because the pathloss to bridge is smaller. The resulting SIR curve is shifted vertically compared to the far-distance case (solid) and the threshold is passed already at with a smaller frequency gap (gap beta/β).

The gap in frequency can be associated with a fixed or configurable threshold, representing a minimum frequency distance to be maintained in order to provide a channel quality above the threshold.

Such gap should be determined by the measurement device and reported to the BS, where such information can be used to schedule UL and DL resources appropriately for the UEs (devices) capable of operating in full-duplex mode.

For example, the UE is measuring, evaluating AND reporting:
an effective SIR,
a worst case SIR,
a best case SIR,
an average/weighted SIR,
a SIR above a threshold,
aSIR below a threshold,
aSIP within a range,

Furthermore, a UE can measure, evaluate and report frequency depending/selective SIR like above and
a frequency protection gap
UL-DL separation gap
Full-duplex gap
A self-interference protection gap,
A CLI/SL interference protection gap

Furthermore, the type of interference observed and represented in the SIR value may be:
CLI from particular or a group of UEs
caused by self-interference with a frequency gap of at least or exactly of a particular value or range.

A device configured in a wireless communication network, e.g., in a full-diplex mode, the device configured for:

measuring self-interference related parameters related to wireless communication of the device, e.g., including signal power from the wireless network or from outside the wireless communication network; and

reporting the self-interference related parameters; and/or determining a self-interference mitigation parameter for mitigating the self-interference and for reporting the self-interference mitigation parameter.

The self-interference parameter comprises at least one of:
an effective SIR,
a worst case SIR,
a best case SIR,
an average/weighted SIR,
a SIR above a threshold,
a SIR below a threshold,
a SIP within a range,

The device may be configured for evaluating and reporting frequency depending/selective SIR like above and
a frequency protection gap
UL-DL separation gap
Full-duplex gap
A self-interference protection gap,
A CLI/SL interference protection gap

The device may be configured for measuring one or more of CLI from particular or a group of UEs caused by self-interference with a frequency gap of at least or exactly of a particular value or range.

Similarly, cross-link-interference (CLI) from other UEs operating in UL mode during a full-duplex slot can be characterized in a similar way, wherein the CLI-protection gap is a function of TX power (near-far between UE and BS) and proximity between UEs creating CLI for each other. A BS scheduler can evaluate CLI and SI reports and associated frequency duplex-gap or protection gap for scheduling decisions, which may include appropriate user grouping in order to reduce the CLI of users scheduled in full-duplex slots, some of the UEs receiving signals from the BS while other UEs transmit to the BS.

User grouping can be done in sub-bands where sufficient protection gap is maintained between BWPs used for UL and DL by users in proximity to each other or for a UE transmitting and receiving at the same time.

For example, the reported information about SI and CLI in full-duplex slots can be used to schedule UL and DL resources such, that: groups of UEs operating in UL (transmit) mode are sufficiently separated in frequency domain from another group of UEs operating in DL (receive) mode. Each group can be allocated to BWP allowing observing/measuring UEs to observe CLI from particular BWP allowing a reduced effort in signaling frequency dependent CLI feedback.

When a BS provides knowledge about such BWP (sub-band) allocation, devices (UEs) can measured, evaluated and report in a more efficient manner, when providing feedback about CLI, SI and quantized frequency protection gaps. For example, a UE is provided with information about the configuration of particular BWP (sub-band) allocated for particular UL and or DL resources. Furthermore, the device (UE) can be configured to use the above provided information for a quantized measurement, evaluation and reporting of CLI, SI, protection gaps etc.

In the following, additional embodiments and aspects of the invention will be described which can be used individually or in combination with any of the features and functionalities and details described herein.

Aspect 1. A wireless communication system comprising:
a base station adapted for scheduling, using a communication configuration, communication of a plurality of devices, the plurality of devices including a reporting device;
wherein the reporting device is configured for performing communication in the wireless communication system in accordance with the communications configuration;
wherein the reporting device is configured for using information indicating a set of reference signals used in the wireless communication system; and for determining an amount of interference interfering with the communication in the wireless communication system for each of the set of reference signals by measuring, e.g., RSRP, RSSI or any other adopted signal metric, to obtain a measurement result indicating the amount of interference perceived by the reporting device through the reference signals of the set of reference signals;
wherein the reporting device is configured for reporting, to the wireless communication system a measurement report being based on the measurement result; and
wherein the wireless communication system is configured for using the measurement report and information about other devices communicating in the wireless communication system and information about reference signals used by the other devices for adapting the communications configuration of at least one device of the plurality of devices for mitigating interference.

Aspect 2. The wireless communication system of aspect 1, being configured for identifying an interferer causing interference to the reporting device; and for adapting the communications configuration of the reporting device and/or of the interferer to reduce an amount of interference.

Aspect 3. The wireless communication system of aspect 2, being configured for further identifying the interferer causing the interference potentially to other devices in the vicinity of the reporting device; and for adapting the communications configuration of the reporting device and/or of the interferer to reduce an amount of interference.

Aspect 4. The wireless communication system of aspect 3, wherein the reporting device is configured for obtaining the measurement result based on measuring uplink radio resources scheduled to the reporting device for obtaining information related to the interferer causing interference to the reporting device and based on measuring uplink radio resources scheduled to the other devices for obtaining information related to the interferer causing the interference potentially to the other devices.

Aspect 5. The wireless communication system of one of previous aspects, wherein the reporting device is configured for measuring interference by observing transmit signals of other devices, e.g. in their current uplink radio resources and for performing the measurement while the reporting device is in a receive mode, e.g., during a current downlink, DL, and/or uplink, UL, radio resource.

Aspect 6. The wireless communication system of one of previous aspects, wherein the wireless communication system comprises a plurality of base stations;
wherein the reporting device is configured for reporting the measurement report to the base station being a first base station and a scheduling base station for the reporting device;
the wireless communication system being configured for identifying an interferer causing interference to the reporting device, the interferer being scheduled by a different second base station;
wherein the first base station is to adapt a communications configuration for the reporting device to mitigate the interference; and/or
wherein the first base station is configured for providing information to the second base station, wherein the second base station is configured for adapting a communications configuration of the interferer to mitigate the interference based on the information.

Aspect 7. The wireless communication system of aspect 6, wherein the reporting device is adapted to transmit, to the base station a suggestion for a future communications configuration, e.g., based on a listen before talk procedure or enhanced listen before talk procedure described herein.

Aspect 8. The wireless communication system of one of previous aspects, wherein the wireless communication system is adapted for using information about interferes and the interference they cause in the wireless communication system based on reports received from reporting devices to determine the communications configuration to obtain an overall mitigated interference for scheduled devices based on an optimization criterion.

Aspect 9. The wireless communication system of one of previous aspects, wherein the wireless communication system is configured for determining, from the measurement result or the measurement report, a type of the interference and for including a type information indicating the type into the measurement report.

Aspect 10. The wireless communication system of one of previous aspects, wherein the reporting device is adapted for measuring continuously, repeatedly or based upon request and for deciding whether to report the measurement report or not based on a decision criterion applied to the measurement result.

Aspect 11. The wireless communication system of one of previous aspects, wherein the reporting device is adapted to evaluate the measurement results and for generating the measurement report to comprise an evaluation result.

Aspect 12. The wireless communication system of one of previous aspects, wherein the reporting device is adapted to generate the measurement report by condensing, compressing or summarizing a set of measurement results.

Aspect 13. A device for operating in a wireless communication system, the device configured for:
performing communication in the wireless communication system in accordance with a communications configuration obtained from a base station of the wireless communication system and scheduling communication of the device;
using information indicating a set of reference signals used in the wireless communication system; and for determining an amount of interference interfering with the communication in the wireless communication system for each of the set of reference signals by measuring to obtain a measurement result indicating the amount of interference perceived by the device through the reference signals of the set of reference signals; and
generating a measurement report based on the measurement result and reporting the measurement report to the wireless communication system.

Aspect 14. The device of aspect 13, wherein the device is configured for logging measurement results.

Aspect 15. The device of aspect 13 or 14, wherein the device is configured for determining (estimating), from the measurement result and combination of measurement results, a type of the interference and for including a type information indicating the type into the measurement report.

Aspect 16. The device of aspect 15, wherein the device is configured for evaluating the type of interference based on the configured measurements and/or an angle-of-arrival estimation.

Aspect 17. The device of one of aspects 13 to 16, wherein the device is adapted for reporting the measurement report using at least one uplink resource and/or at least one flexible resource.

Aspect 18. A base station configured for operating in a wireless communication system, the base station adapted for scheduling, using a communications configuration, communication of a plurality of devices, the plurality of devices including a reporting device;
wherein the base station is configured for receiving a report generated by the reporting device, the measurement report indicating an amount of interference perceived by the reporting device through a reference signal of a set of reference signals used in the wireless communication system; and
wherein the base station is configured for using the measurement report and information about other devices communicating in the wireless communication system and information about reference signals used by the other devices for adapting the communications configuration of at least one device of the plurality of devices for mitigating interference.

Aspect 19. A device configured for communicating in a wireless communication system, the device comprising an antenna unit;
wherein the device is configured for selecting and using, for communication in the wireless communication system, a first of a set of different spatial receive filters as a selected filter with the antenna unit to implement a directional selectivity for a reception of signals with the antenna unit; wherein each of the spatial receive filters is associated with a main direction of directional sensitivity; wherein the device is configured for receiving signals from a communication partner using the first spatial receive filter;
wherein the device is configured for performing a measurement procedure during a time different from the communication, the measurement procedure comprising selecting the selected filter in accordance with a direction of an interfering link towards the device, the interfering link interfering with the device;
wherein the device is configured for using information indicating a set of reference signals used in the wireless communication system; and for determining an amount of interference interfering with the communication for each of the set of reference signals by measuring to obtain a measurement result indicating the amount of interference perceived by the device through the reference signals of the set of reference signals;
wherein the device is adapted to select a second spatial filter for the communication based on the measurement results to mitigate interference perceived with the first spatial receive filter.

Aspect 20. The device of aspect 19, wherein the device is configured for selecting the selected filter in accordance with a direction of the interfering link towards the device based on information indicating a control resource set, CORESET, of the interfering link.

Aspect 21. The device of aspect 20, wherein the device is configured for monitoring at least one of:
a physical broadcast channel, PBCH;
a demodulation reference signal in the PBCH, PBCH DM-RS;
a primary synchronization signal, PSS;
a secondary synchronization signal, SSS
   to obtain a measurement result and for obtaining the information indicating the CORESET from the measurement result.

Aspect 22. The device of one of one of aspects 19 to 21, being configured for reporting information indicating at least one of
a spatial receive filter used for the measurement procedure;
a control resource set, CORESET, of the interfering link;
the first spatial receive filter;
the second spatial receive filter
an amount of interference perceived with the first spatial receive filter; and
an amount of interference perceived with the second spatial receive filter.

Aspect 23. A first device configured for communicating in a wireless communication system, the device comprising an antenna unit and being adapted for establishing a link with a base station; wherein the device is configured for:
selecting a first spatial transmit filter for transmitting a signal with the antenna unit based on a beam correspondence procedure with the base station;
using information indicating a time of transmission of a signal from a different second device; for measuring interference caused by the second device to the first device during the time of transmission and via an interfering channel;
deriving information indicating an amount of interference caused by the first device at the second device using a reciprocal channel assumption with respect to the interfering channel;
selecting a different second spatial transmit filter based on the information indicating the amount of interference so as to mitigate the interference of the first device at the second device.

Aspect 24. The device of aspect 23, wherein the device is configured for measuring for the interference caused by the second device to the first device during the time of transmission and via an interfering channel using a matched spatial receive filter to obtain a main direction of the directional selectivity towards the second device; and evaluating an interference power received with the matched filter based on a maximum interference measured thereby;
wherein the device is configured for calculating a suitable spatial receive filter for mitigating the interference caused by the second device;
for deriving the information indicating the amount of interference caused by the first device by providing an estimate of interference that will be caused when using a similar or equivalent spatial transmit filter, e.g., based on beam correspondence, for transmission;
wherein the device is configured for selecting the different second spatial transmit filter to mitigate interference

Aspect 25. A device configured for communicating in a wireless communication system and for receiving a signal from a communication partner;
wherein the device is configured for observing a set of radio resources of the wireless communication system, e.g., during which the communication partner transmits or receives signals;
wherein the device is configured for measuring, for each of the radio resources, interference occurring in the radio resource, to obtain measurement results; and
for reporting, to the wireless communication system, the measurement results or information derived thereof; and/or
for determining, based on the measurement results and based on an interference criterion, at least one selected future radio resource; and
for transmitting information indicating the at least one future radio resource to the wireless communication system; and/or for requesting a schedule of downlink and/or uplink signals from the communication partner in the at least one selected future radio resources.

Aspect 26. The device of aspect 25, wherein the device is configured for requesting a schedule of downlink and/or uplink signals from the communication partner in the at least one selected future radio resource together with an indication which radio resource to be used.

Aspect 27. The device of aspect 26, wherein the indication comprises at least one of a prioritized, deprioritized, whitelisted, blacklisted and barred indication of future radio resources.

Aspect 28. The device of aspect 26 or 27, wherein the device is configured for measuring the interference as a cross-link-interference perceived from at least one link of a different device.

Aspect 29. The device of one of aspects 25 to 28, wherein the device is configured for measuring the interference as a inter-cell-interference perceived from at least one link of a different base station.

Aspect 30. The device of one of aspects 25 to 29, wherein the device is configured for measuring the interference as a self-interference of itself.

Aspect 31. The device of one of aspects 25 to 30, wherein the device is configured for measuring the interference based on receiving a reference signal such as a sounding reference signal, SRS; and/or based on an evaluation of a signal power received via a cross-link-interference channel from at least one link of a different device.

Aspect 32. The device of one of aspects 25 to 31, wherein the device is configured for measuring the interference based on receiving a reference signal such as a synchronization signal block, SSB or downlink channel state information reference signal, CSI-RS; and/or based on an evaluation of a signal power received via a inter-cell-interference channel from at least one link of a different base station.

Aspect 33. The device of one of aspects 25 to 32, wherein the device is configured for measuring the self-interference based on knowledge of the signal to be transmitted.

Aspect 34. The device of one of one aspects 25 to 33, wherein the set of radio resources is based on a time in which other devices operate in a transmit mode whilst the device operates in a receive mode.

Aspect 35. The device of one of aspects 25 to 34, wherein the set of radio resources is based on a time in which other base stations communicating with their communication partners (devices) operate in a transmit mode whilst the device operates in a receive mode.

Aspect 36. The device of one of aspects 25 to 35, wherein the device is to determine, from the measurement results, statistics indicating suitable radio resources in the temporal past; and to derive, using the statistics, the selected future radio resources as radio resources that are expected to allow a successful decoding of a signal transmitted to or by the device.

Aspect 37. The device of one of aspects 25 to 36, wherein the device is configured for determine a candidate for the future radio resource as the selected future radio resources based on a decision whether the candidate fulfils a predetermined criterion with regard to a transmission quality.

Aspect 38. The device of one of aspects 25 to 37, wherein the device is configured for determine the selected future radio resources as being expected to have a level of interference of at most a first interference threshold and/or a level of interference of at least a second interference threshold.

Aspect 39. The device of one of aspects 25 to 38, wherein the device is configured for determine the selected future radio resources based on at least one probability of:

a packet collision in the selected future radio resource,

the device being out of coverage during the selected future radio resource

packet loss higher than a threshold in the selected future radio resource

Signal to interference ratio, SIR, exceeding a predetermined first threshold in the selected future radio resource

Signal to interference ratio, SIR, not exceeding a predetermined first or second threshold in the selected future radio resource

Packet erasure events over multiple retransmissions occurring when using the selected future radio resource

Aspect 40. The device of one of aspects 25 to 39, wherein the device is configured for receiving, from the wireless communication system and responsive to transmitting the information or the request an indication indicating that the device is scheduled to receive information in the radio resource; wherein the device is configured for transmitting, to the wireless communication system a confirmation signal indicating a confirmation for the indicated radio resource and/or wherein the device is configured for transmitting, to the wireless communication system a rejection signal indicating a rejection for the indicated radio resource; and/or
wherein the device is configured for transmitting, to the wireless communication system a packet retransmission request signal indicating an expected misdetection or channel degradation for the indicated radio resource.

Aspect 41. The device of aspect 40, wherein the device is configured for transmitting information indicating a plurality of selected future radio resources to the wireless communication system; and/or for requesting a schedule of downlink signals from the communication partner in a plurality of selected future radio resources;
wherein the indication indicates a subset of the plurality of future radio resources as a selection thereof.

Aspect 42. The device of aspect 40 or 41, wherein the device is configured for transmitting information indicating a plurality of selected future radio resources to the wireless communication system; and/or for requesting a retransmission of downlink data packets from the communication partner in a plurality of selected future radio resources;
wherein the indication indicates a subset of the plurality of future radio resources as a selection thereof.

Aspect 43. The device of one of aspects 25 to 42, wherein the device is configured for transmitting, prior to the selected future radio resource, a pre-emption signal; wherein the device is configured for transmitting the pre-emption signal
to devices of the same wireless communication system to indicate an expected signal in the selected future radio resource and/or
to devices of another wireless communication system configured for transmission in the selected future radio resource.

Aspect 44. The device of one of aspects 25 to 43, wherein the measured radio resources comprise at least one uplink radio resource and/or at least one downlink radio resource; and/or
wherein the future radio resource is an uplink radio resource or a downlink radio resource or a flexible radio resource, e.g., a slot.

Aspect 45. A wireless communication system comprising:
at least one base station;
a plurality of devices being scheduled with communication by the at least one base station;
wherein each of the devices is configured for:
   observing a device-individual set of radio resources of the wireless communication system;
   measuring, for each of the radio resources, interference occurring in the radio resource, to obtain measurement results; and
   reporting, to the wireless communication system, the measurement results or information derived thereof;
wherein the wireless communication system is configured for determining a communications configuration for the plurality of devices that mitigates interference caused by transmitting signals to the devices during future radio resources based on evaluation of the reported radio resources, e.g., by extrapolation.

Aspect 46. The wireless communication system of aspect 45, wherein the wireless communication system is configured for
identifying, for future downlink radio resources and for a reference communications configuration, potential interferes and potential victims, e.g., the device itself and/or other devices, potentially experience interference by the interferers; and at least one of:
scheduling at least one interferer and/or at least one victim to a different radio resource when compared to the reference communications configuration; and
changing a transmission behaviour of a potential interferer;
to determine the communications configuration.

Aspect 47. The wireless communication system of aspect 45 or 46, wherein the wireless communication system is adapted to repeatedly measure the radio resources of a first UL/DL configuration and/or a different second UL/DL configuration and to determine a measure for interference such as CLI, for the first and the second UL/DL configuration, and for selecting one of the first and the second UL/DL configurations as a future UL/DL configuration based on the interference.

Aspect 48. A wireless communication system configured for providing a wireless communication at least from a base station to a device;
wherein the device is configured for:
observing a radio environment of the device to obtain an observation result; and to determine, based on the observation result, at least one radio resource as being vulnerable to a cross link interference and/or an inter cell interference;
reporting, to the base station a report indicating the at least one radio resource;
receiving information indicating a communications configuration to receive a signal in a scheduled future radio resource;
wherein the wireless communication system is configured for transmitting a pre-emption signal to indicate an expected signal in the scheduled future radio resource.

Aspect 49. The wireless communication system of aspect 48, wherein the base station is configured for determining the communications configuration based on the report.

Aspect 50. The wireless communication system of aspect 49, being configured to transmit the pre-emption signal with the device to receive the signal in the scheduled future downlink radio resource; and/or with the base station to transmit the signal in the scheduled future downlink radio resource.

Aspect 51. The wireless communication system of one aspects 48 to 50, wherein the pre-emption signal is adapted to identify/address at least one radio resource to be temporarily protected by other devices nearby by avoiding transmitting using the at least one radio resource.

Aspect 52. The wireless communication system of one of aspects 48 to 51, being adapted for observing the radio environment also with the base station to obtain a bi-directional observation.

Aspect 53. The wireless communication system of one of aspects 48 to 52, wherein the device is configured for observing the radio environment during an initial stage. [

Aspect 54. The wireless communication system of one of aspects 48 to 53, wherein the base station is configured for observing the radio resources and parts of the spectrum associated with a link with the device; and for reporting information indicating a link quality or an interference information associated with the link to the device to obtain a bi-directional link information at the device together with the observation result.

Aspect 55. The wireless communication system according to one of pervious aspects, wherein the wireless communication system comprises an integrated access and backhaul, IAB, network, wherein the base station is a gNB of the IAB network.

Aspect 56. The wireless communication system according to one of pervious aspects, wherein the wireless communication system is adapted for a dynamic indication for restriction and/or availability of beams between nodes of the wireless communication system in the configured radio resources; wherein radio resources can be allocated/addressed in time (e.g., a slot) and frequency (subcarrier, bandwidth parts, ands) and/or combinations of the two dimensions.

Aspect 57. A method for measuring interference, the method comprising:
operating a device in a wireless communication system, the device being adapted to operate in a downlink mode, the device comprising an antenna unit, the device adapted for selecting and using one of a set of different spatial receive filters as a selected filter with the antenna unit to implement a directional selectivity for receiving signals with the antenna unit during the downlink mode;
applying the selected filter;
measuring prior, during or after the downlink mode the interference with the antenna unit and the selected filter; and
determining an impact of the measured interference on a reception of a signal during a previous, current or future downlink mode.

Aspect 58. The method of aspect 57, wherein measuring the interference comprises:
receiving a reference signal such as a sounding reference signal: and determining, from reception of the reference signal a Reference Signal Received Power; and/or
receiving a signal from a data signal and/or a control signal and determining from the reception of the signal a Received Signal Strength Indication.

Aspect 59. The method of aspect 57 or 58, wherein measuring the interference comprises:
receiving a reference signal such as a Synchronization Signal Block, SSB or Channel State Information Reference signals (CSI-RS); and determining, from reception of the reference signal a Reference Signal Received Power; and/or
receiving a signal power from data and/or control signals; and determining, from reception of the Received Signal Power a Received Signal Strength Indication.

Aspect 60. A method for addressing interference, the method comprising:
operating a receiver-device in a wireless communication system, the device comprising an antenna unit for receiving signals in the wireless communication system;
receiving a reference signal transmitted by an interfering device in the wireless communication system;
informing the wireless communication system that the receiver-device suffers from interference caused by the interfering device; and
identifying the interfering device using measures related to the reference signal.

Aspect 61. The method of aspect 60, wherein identifying the interfering device comprises:
determining a Reference Signal Received Power of a reception of the reference signal at the receiver-device;
evaluating one or more of a bandwidth part associated with the reference signal; a resource block used for transmitting the reference signal and a time slot used for transmitting the reference signal to obtain an evaluation result; and
providing a report to a base station, comprising information indicating the evaluation result;
evaluating a past scheduling in the wireless communication systems to identify the interfering device.

Aspect 62. The method of aspect 60 or 61, wherein the evaluation result is obtained by a zero power, ZP, or a non-zero power, NZP, interference measurement.

Aspect 63. The method of one of aspects 60 to 62 wherein identifying the interference device comprises a combination of information obtained from the reference signal of the interfering device together with its time slot and the settings of the spatial filter used in the receiving device.

Aspect 64. The method of one of aspects 60 to 63 wherein identifying the interference device comprises a combination of information obtained from the reference signal of the interfering device wherein the reference signal may be at least one of:
Identifiable Sounding Reference Signal (SRS) sequence (number/ID),
A specific phase shift/phase applied on a SRS or SRS sequence,
A synchronisation signal block, SSB,
A channel State Information Reference Signal, CSI-RS,
A SSID from a WiFi access point,
A bluetooth beacon, or
Any other identifiable and known reference signal, a receiver could correlate with and derive a measurement specifically related to the interference transmitter.

Aspect 65. The method of one of aspects 61 to 64, wherein a bandwidth part associated with the reference signal; a resource block used for transmitting the reference signal and/or a time slot used for transmitting the reference signal is evaluated by use of an interferer-subcarrier spacing underlying the evaluation, the interferer-subcarrier spacing being different from a subcarrier spacing scheduled to the receiver-device.

Aspect 66. The method of aspect 65, comprising: informing the receiver-device about the interferer-subcarrier spacing; and/or
measuring different subcarrier spacing during the evaluation to obtain different evaluation results and determining the interferer-subcarrier spacing based on

Aspect 67. A receiver device configured for operating in a wireless communication system, the receiver device configured for implementing a method of one of aspects 57 to 66.

Aspect 68. A computer readable digital storage medium having stored thereon a computer program having a program code for performing, when running on a computer, a method according to one of aspects 57 to 66.

Aspect 69. A device configured in a wireless communication network, e.g., in a full-duplex mode, the device configured for:
measuring self-interference related parameters related to wireless communication of the device, e.g., including signal power from the wireless network or from outside the wireless communication network; and
reporting the self-interference related parameters; and/or determining a self-interference mitigation parameter for mitigating the self-interference and for reporting the self-interference mitigation parameter.

Aspect 70. The device of aspect 69, wherein the self-interference parameter comprises at least one of:
an effective SIR,
a worst case SIR,
a best case SIR,
an average/weighted SIR,
a SIR above a threshold,
a SIR below a threshold,
a SIP within a range,

Aspect 71. The device of aspect 69 or 70, wherein the device is configured for evaluating and reporting frequency depending/selective SIR like above and
a frequency protection gap
UL-DL separation gap
Full-duplex gap
A self-interference protection gap,
A CLI/SL interference protection gap

Aspect 72. The device of one of aspects 69 to 71, wherein the device is configured for measuring one or more of CLI from particular or a group of UEs caused by self-interference with a frequency gap of at least or exactly of a particular value or range.

Aspect 73. The device of one of aspects 69 to 72, wherein the device is configured for receiving, from the wireless communication system information about a configuration of particular bandwidth part allocated for particular UL and or DL resources; wherein the device (UE) is configured to use the above provided information for a quantized measurement, evaluation and reporting of CLI, SI, protection gaps etc.

Aspect 74. A wireless communication system comprising a device of one of aspects 69 to 73 being adapted for scheduling uplink and/or downlink resources based on the report received from the device.

Aspect 75. The wireless communication system of aspect 74, being adapted for scheduling the uplink resource and/or the downlink resources for a plurality of groups of devices, one group thereof comprising the device.

Aspect 76. The wireless communication system of aspect 75, wherein each group can be allocated to a bandwidth part BWP allowing observing/measuring UEs to observe CLI from particular BWP allowing a reduced effort in signaling frequency dependent CLI feedback.

Aspect 77. A method for operating a wireless communication system, the method comprising:
operating a base station for scheduling, using a communications configuration, communication of a plurality of devices, the plurality of devices including a reporting device;
operating the reporting device for performing communication in the wireless communication system in accordance with the communications configuration;
such that the reporting device uses information indicating a set of reference signals used in the wireless communication system; and determines an amount of interference interfering with the communication in the wireless communication system for each of the set of reference signals by measuring to obtain a measurement result indicating the amount of interference perceived by the reporting device through the reference signals of the set of reference signals;
such that the reporting device reports, to the wireless communication system a measurement report being based on the measurement result; and
such that the wireless communication system uses the measurement report and information about other devices communicating in the wireless communication system and information about reference signals used by the other devices for adapting the communications configuration of at least one device of the plurality of devices for mitigating interference.

Aspect 78. A method for operating a device in a wireless communication system, the method comprising:
performing communication in the wireless communication system in accordance with a communications configuration obtained from a base station of the wireless communication system and scheduling communication of the device;
using information indicating a set of reference signals used in the wireless communication system; and determining an amount of interference interfering with the communication in the wireless communication system for each of the set of reference signals by measuring to obtain a measurement result indicating the amount of interference perceived by the device through the reference signals of the set of reference signals; and
generating a measurement report based on the measurement result and reporting the measurement report to the wireless communication system.

Aspect 79. A method for operating a base station in a wireless communication system, the base station adapted for scheduling, using a communications configuration, communication of a plurality of devices, the plurality of devices including a reporting device, the method comprising;
receiving a report generated by the reporting device, the measurement report indicating an amount of interference perceived by the reporting device through a reference signal of a set of reference signals used in the wireless communication system; and
using the measurement report and information about other devices communicating in the wireless communication system and information about reference signals used by the other devices for adapting the communications configuration of at least one device of the plurality of devices for mitigating interference.

Aspect 80. A method for operating a device in a wireless communication system, the device comprising an antenna unit, the method comprising:
selecting and using, for communication in the wireless communication system, a first of a set of different spatial receive filters as a selected filter with the antenna unit to implement a directional selectivity for a reception of signals with the antenna unit; wherein each of the spatial receive filters is associated with a main direction of directional sensitivity; such that the device receives signals from a communication partner using the first spatial receive filter;
performing a measurement procedure during a time different from the communication, the measurement procedure comprising selecting the selected filter in accordance with a direction of an interfering link towards the device, the interfering link interfering with the device;
using information indicating a set of reference signals used in the wireless communication system;
determining an amount of interference interfering with the communication for each of the set of reference signals by measuring to obtain a measurement result indicating the amount of interference perceived by the device through the reference signals of the set of reference signals; and
selecting a second spatial filter for the communication based on the measurement results to mitigate interference perceived with the first spatial receive filter.

Aspect 81. A method for operating a first device in a wireless communication system, the device comprising an antenna unit and being adapted for establishing a link with a base station; wherein the method comprises:
selecting a first spatial transmit filter for transmitting a signal with the antenna unit based on a beam correspondence procedure with the base station;
using information indicating a time of transmission of a signal from a different second device; for measuring interference caused by the second device to the first device during the time of transmission and via an interfering channel;
deriving information indicating an amount of interference caused by the first device at the second device using a reciprocal channel assumption with respect to the interfering channel;
selecting a different second spatial transmit filter based on the information indicating the amount of interference so as to mitigate the interference of the first device at the second device.

Aspect 82. A method for operating a device in a wireless communication system for receiving a signal from a communication partner, the method comprising;
observing a set of radio resources of the wireless communication system, e.g., during which the communication partner transmits or receives signals;
measuring, for each of the radio resources, interference occurring in the radio resource, to obtain measurement results; and
reporting, to the wireless communication system, the measurement results or information derived thereof; and/or
determining, based on the measurement results and based on an interference criterion, at least one selected future radio resource; and
transmitting information indicating the at least one future radio resource to the wireless communication system; and/or for requesting a schedule of downlink and/or uplink signals from the communication partner in the at least one selected future radio resources.

Aspect 83. A method for operating a wireless communication system comprising at least one base station; and a plurality of devices being scheduled with communication by the at least one base station, the method comprising:
observing, with each of the devices, a device-individual set of radio resources of the wireless communication system;
measuring, for each of the radio resources, interference occurring in the resource, to obtain measurement results; and
reporting, to the wireless communication system, the measurement results or information derived thereof;
determining, with the wireless communication system, a communications configuration for the plurality of devices that mitigates interference caused by transmitting signals to the devices during future radio resources based on evaluation of the reported radio resources, e.g., by extrapolation.

Aspect 84. A method for operating a wireless communication system for providing a wireless communication at least from a base station to a device, the method comprising;
operating the device for:
observing a radio environment of the device to obtain an observation result; and to determine, based on the observation result, at least one radio resource as being vulnerable to a cross link interference;
reporting, to the base station a report indicating the at least one radio resource; and
receiving information indicating a communication configuration to receive a signal in a scheduled future radio resource;
transmitting within the wireless communication system a pre-emption signal to indicate an expected signal in the scheduled future radio resource.

Aspect 85. A method for operating a device in a wireless communication network, e.g., in a full-duplex mode, the method comprising:
measuring self-interference related parameters related to wireless communication of the device, e.g., including signal power from the wireless network or from outside the wireless communication network; and
reporting the self-interference related parameters; and/or determining a self-interference mitigation parameter for mitigating the self-interference and for reporting the self-interference mitigation parameter.

Aspect 86. A computer readable digital storage medium having stored thereon a computer program having a program code for performing, when running on a computer, a method according to one of aspects 77 to 85.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

ABBREVIATION TABLE

| | | Further |
|---|---|---|
| Abbreviation | Definition | description |
| 2G | second generation | |
| 3G | third generation | |
| 3GPP | third generation partnership project | |
| 4G | fourth generation | |
| 5G | fifth generation | |
| 5GC | 5G core network | |
| ACLR | adjacent channel leakage ratio | |
| AoA | angle of arrival | |
| AoD | angle of departure | |
| AP | access point | |
| ARQ | automatic repeat request | |
| BER | bit-error rate | |
| BLER | block-error rate | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| CP1 | control plane 1 | |
| CP2 | control plane 2 | |
| CSI-RS | channel state information reference signal | |
| CU | central unit | |
| D2D | device-to-device | |
| DAPS | dual active protocol stack | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DU | distributed unit | |
| ECGI | E-UTRAN cell global identifier | |
| E-CID | enhanced cell ID | |
| eNB | evolved node b | |
| EN-DC | E-UTRAN-New Radio dual connectivity | |
| EUTRA | Enhanced UTRA | |
| E-UTRAN | Enhanced UTRA network | |
| gNB | next generation node-b | |
| GNSS | global navigation satellite system | |
| GPS | global positioning system | |
| HARQ | hybrid ARQ | |
| IAB | integrated access and backhaul | |
| ID | identity/identification | |
| IIOT | industrial Internet of things | |
| KPI | key-performance indicator | |
| LTE | Long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MR-DC | multi-RAT dual connectivity | |
| NCGI | new radio cell global identifier | |
| NG | next generation | |
| ng-eNB | next generation eNB | node providing |
| | | E-UTRA user |
| NG-RAN | either a gNB or an ng-eNB | |
| NR | new radio | |
| NR-U | NR unlicensed | NR operating |
| | | in unlicensed |
| OAM | operation and maintenance | |
| OEM | OEM original equipment manufacturer | |
| OTT | OTT over-the-top | |
| PCI | physical cell identifier | Also known |
| | | as PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network information | |
| RIM-RS | RIM reference signal | |
| RLC | radio link control | |
| RLF | radio link failure | |
| RLM | radio link monitoring | |
| RP | reception point | |
| R-PLMN | registered public land mobile network | |
| RRC | radio resource control | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| SA | standalone | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SS | synchronization signal | |
| SSB | synchronization signal block | |
| SSID | service set identifier | |
| SS-PBCH | sounding signal/physical broadcast | |
| TAC | tracking area code | |
| TB | transmission block | |
| TDD | time division duplex | |
| TSG | technical specification group | |
| UDN | ultra-dense networks | |
| UE | user equipment | |
| UL | uplink | |
| URLLC | ultra-reliable low latency communication | |
| UTRAN | universal trunked radio access network | |
| V2X | vehicle-to-everything | |
| VoIP | voice over Internet protocol | |
| WI | work item | |
| WLAN | wireless local area network | |

### REFERENCES

1. Rebato, M., Mezzavilla, M., Rangan, S., Boccardi, F., and Zorzi, M., “Understanding Noise and Interference Regimes in 5G Millimeter-Wave Cellular Networks,” European Wireless 2016, 22^{nd} European Wireless Conference, Oulu, Finland, 2016, pp. 1-5
2. “Enhancing LTE Cell-Edge Performance via PDCCH ICIC”, White Paper, Fujitsu Network Communications, Inc., USA, 2011
3. Atteya, N., Maximov, S., and El-saidny, M., “5G NR: A New Era for Enhanced Mobile Broadband”, White Paper, MediaTek, Inc., 2018
4. “Field Testing in 5G NR”, White Paper, Keysight Technologies, Inc., USA, 2018
5. Bertenyi, B., Nagata, S., Kooropaty, H., Zhou, X., Chen, W., Kim, Y., Dai, X., and Xu, X., “5G NR Radio Interface”, Journal of ICT, Vol. 6 1&2, 31-58. River Publishers, May 2018
6. 3GPP R1-1810108, “Beam measurement and report using L1-RSRQ or SINR”, Huawei and HiSilicon, 3GPP TSG RAN WG1 Meeting #94bis, Chengdu, China
7. 3GPP TR 38.802, “Study on New Radio Access Technology: Physical Layer Aspects”, V14.2.0 (2017-09)
8. Hubregt J. Wisser, “Array and Phased Array Antenna Basics”, Wiley, Chichester, 2005
9. R. C. Johnson (ed.), “Antenna Engineering Handbook”, 3^{rd} Ed., McGraw-Hill, New York, 1993
10. Merill I. Skolnik, “Introduction to Radar Systems”, 2^{nd} Ed., McGraw-Hill, Auckland, 1981
11. Randy Haupt, “Antenna Arrays: A computational Approach”, Wiley, 2010
12. J. Wang et al., “Beamforming Codebook Design and Performance Evaluation for 60 GHz Wideband WPANs”, 2009 IEEE 70th Vehicular Technology Conference Fall, Anchorage, Ak., 2009, pp. 1-6
13. Sassan Ahmadi, “5G NR”, Elsevier, 2019
14. 3GPP TR 37.816, “Study on RAN-centric data collection and utilization for LTE and NR (Release 16) NR, V16.0.0 (2019-07)”
15. 3GPP TR 37.320, “Radio measurement collection for Minimization of Drive Tests (MDT)”; Overall description; Stage 2 (Release 16), (2020-03)
16. 3GPP TS 38.215, NR, “Physical layer measurements”; V16.0.1 (2020-01)
17. 3GPP TS 38.213, NR, “Physical layer procedures for control”; V16.1.0 (2020-03)
18. 3GPP TS 28.552, 5G, “Management and orchestration; 5G performance measurements, (Release 16)”; V16.5.0 (2020-03)
19. 3GPP TS 38.314 NR; Layer 2 Measurements; V16.0.0 (2020-07)
20. 3GPP TS 38.331, NR; Radio Resource Control (RRC) protocol specification V16.0.0 (2020-03)
21. IEEE COMMUNICATIONS SURVEYS & TUTORIALS, FOURTH QUARTER 2020, Dynamic TDD Systems for 5G and Beyond: A Survey of Cross-Link Interference Mitigation
22. R1-2101878 AI 8.10.2, Summary #1 of [104-e-NR-eIAB-02]
23. R1-2100955 CEWiT, Tejas Networks, Reliance Jio, IITM, IITH: Discussion on simultaneous operation of IAB-node's child and parent links
24. R1-2101484 Qualcomm, On enhancements for simultaneous operation of IAB-node's child and parent links
25. TR 38.828, v16.1., Cross Link Interference (CLI) handling and Remote Interference Management (RIM) for NR; (Release 16)
26. 3GPP TS 38.300, NR; NR and NG-RAN Overall Description; Stage 2, V16.4.0 (2020-12)
27. 3GPP TS 38.215, NR, “Physical layer measurements”; V16.2.0 (2020-06)
28. 3GPP TS 38.331, NR; Radio Resource Control (RRC) protocol specification V16.3.1 (2021-01)
29. E. Dahlman, 5G NR: The Next Generation Wireless Access Technology, Academic Press
30. 3GPP TS 38 214, NR; “Physical layer procedures for data”, V16.4.0 (2020-12)

1. A wireless communication system comprising:
a base station adapted for scheduling, using a communication configuration, communication of a plurality of devices, the plurality of devices comprising a reporting device;
wherein the reporting device is configured for performing communication in the wireless communication system in accordance with the communications configuration;
wherein the reporting device is configured for using information indicating a set of reference signals used in the wireless communication system; and for determining an amount of interference interfering with the communication in the wireless communication system for each of the set of reference signals by measuring, e.g., RSRP, RSSI or any other adopted signal metric, to acquire a measurement result indicating the amount of interference perceived by the reporting device through the reference signals of the set of reference signals;
wherein the reporting device is configured for reporting, to the wireless communication system a measurement report being based on the measurement result; and
wherein the wireless communication system is configured for using the measurement report and information about other devices communicating in the wireless communication system and information about reference signals used by the other devices for adapting the communications configuration of at least one device of the plurality of devices for mitigating interference.

2. The wireless communication system of claim 1, wherein the wireless communication system comprises a plurality of base stations;
wherein the reporting device is configured for reporting the measurement report to the base station being a first base station and a scheduling base station for the reporting device;
the wireless communication system being configured for identifying an interferer causing interference to the reporting device, the interferer being scheduled by a different second base station;
wherein the first base station is to adapt a communications configuration for the reporting device to mitigate the interference; and/or
wherein the first base station is configured for providing information to the second base station, wherein the second base station is configured for adapting a communications configuration of the interferer to mitigate the interference based on the information.
wherein the reporting device is adapted to transmit, to the base station a suggestion for a future communications configuration, e.g., based on a listen before talk procedure or enhanced listen before talk procedure described herein.

3. The wireless communication system of claim 1, wherein the wireless communication system is adapted for using information about interferes and the interference they cause in the wireless communication system based on reports received from reporting devices to determine the communications configuration to acquire an overall mitigated interference for scheduled devices based on an optimization criterion.

4. The wireless communication system of claim 1, wherein the wireless communication system is configured for determining, from the measurement result or the measurement report, a type of the interference and for comprising a type information indicating the type into the measurement report.

5. The wireless communication system of claim 1, wherein the reporting device is adapted to evaluate the measurement results and for generating the measurement report to comprise an evaluation result.

6. The wireless communication system of claim 1, wherein the reporting device is adapted to generate the measurement report by condensing, compressing or summarizing a set of measurement results.

7. A device for operating in a wireless communication system, the device configured for:
performing communication in the wireless communication system in accordance with a communications configuration acquired from a base station of the wireless communication system and scheduling communication of the device;
using information indicating a set of reference signals used in the wireless communication system; and for determining an amount of interference interfering with the communication in the wireless communication system for each of the set of reference signals by measuring to acquire a measurement result indicating the amount of interference perceived by the device through the reference signals of the set of reference signals; and
generating a measurement report based on the measurement result and reporting the measurement report to the wireless communication system.

8. The device of claim 7, wherein the device is configured for logging measurement results.

9. The device of claim 7, wherein the device is configured for determining (estimating), from the measurement result and combination of measurement results, a type of the interference and for comprising a type information indicating the type into the measurement report.

10. The device of claim 9, wherein the device is configured for evaluating the type of interference based on the configured measurements and/or an angle-of-arrival estimation.

11. A base station configured for operating in a wireless communication system, the base station adapted for scheduling, using a communications configuration, communication of a plurality of devices, the plurality of devices comprising a reporting device;
wherein the base station is configured for receiving a report generated by the reporting device, the measurement report indicating an amount of interference perceived by the reporting device through a reference signal of a set of reference signals used in the wireless communication system; and
wherein the base station is configured for using the measurement report and information about other devices communicating in the wireless communication system and information about reference signals used by the other devices for adapting the communications configuration of at least one device of the plurality of devices for mitigating interference.

12. A method for operating a wireless communication system, the method comprising:
operating a base station for scheduling, using a communications configuration, communication of a plurality of devices, the plurality of devices comprising a reporting device;
operating the reporting device for performing communication in the wireless communication system in accordance with the communications configuration;
such that the reporting device uses information indicating a set of reference signals used in the wireless communication system; and determines an amount of interference interfering with the communication in the wireless communication system for each of the set of reference signals by measuring to acquire a measurement result indicating the amount of interference perceived by the reporting device through the reference signals of the set of reference signals;
such that the reporting device reports, to the wireless communication system a measurement report being based on the measurement result; and
such that the wireless communication system uses the measurement report and information about other devices communicating in the wireless communication system and information about reference signals used by the other devices for adapting the communications configuration of at least one device of the plurality of devices for mitigating interference.

13. A method for operating a device in a wireless communication system, the method comprising:
performing communication in the wireless communication system in accordance with a communications configuration acquired from a base station of the wireless communication system and scheduling communication of the device;
using information indicating a set of reference signals used in the wireless communication system; and determining an amount of interference interfering with the communication in the wireless communication system for each of the set of reference signals by measuring to acquire a measurement result indicating the amount of interference perceived by the device through the reference signals of the set of reference signals; and
generating a measurement report based on the measurement result and reporting the measurement report to the wireless communication system.

14. A method for operating a base station in a wireless communication system, the base station adapted for scheduling, using a communications configuration, communication of a plurality of devices, the plurality of devices comprising a reporting device, the method comprising;
receiving a report generated by the reporting device, the measurement report indicating an amount of interference perceived by the reporting device through a reference signal of a set of reference signals used in the wireless communication system; and
using the measurement report and information about other devices communicating in the wireless communication system and information about reference signals used by the other devices for adapting the communications configuration of at least one device of the plurality of devices for mitigating interference.
